(19) United States
(12) Patent Application Publication
(10) Pub. No.: US 2018/0148647 A1
(43) Pub. Date: May 31, 2018

(54) COMPOSITION AND LIQUID CRYSTAL DISPLAY USING SAME

(71) Applicant: DIC Corporation, Tokyo (JP)

(72) Inventors: Shirou Taniguchi, Kita-adachi-gun (JP); Makoto Negishi, Kita-adachi-gun (JP)

(73) Assignee: DIC Corporation, Tokyo (JP)

(21) Appl. No.: 15/575,996

(22) PCT Filed: Jun. 2, 2016
(86) PCT No.: PCT/JP2016/066385

§ 371 Date: Nov. 21, 2017

(30) Foreign Application Priority Data
Jun. 12, 2015 (JP) 2015-119316

(51) Int. Cl. C09K 19/34; C09K 19/02

(52) U.S. Cl. CPC C09K 19/3402; C09K 2019/3422; C09K 19/0216; C09K 19/0208

(57) ABSTRACT

An object of the present invention is to provide a composition which has a positive Δε, a liquid crystal phase over a wide temperature range, a low viscosity, an excellent solubility at low temperature, high specific resistance, high voltage holding ratio, and stability against heat or light, and further provide a liquid crystal display element such as an IPS type or a TN type, which has excellent display qualities by using the composition, and in which display defects such as burn-in or drop marks are hardly caused, at a high yield. The present invention provides a composition including one or more compounds represented by General Formula (i); and a compound represented by Formula (L-1-2.2), and a liquid crystal display element using the composition and an IPS element or a FFS element using the composition.

### TECHNICAL FIELD

The present invention relates to a composition which has a positive dielectric anisotropy (Δε) value and is useful as a liquid crystal display material, and a liquid crystal display element using the composition.

### BACKGROUND ART

A liquid crystal display element is used for not only a watch and a calculator, but also various measuring apparatuses, panel for automobiles, a word processor, an electronic notebook, a printer, a computer, a television, a clock, an advertisement display board, and the like. Representative examples of a liquid crystal display mode include a twisted nematic (TN) type, a super twisted nematic (STN) type, a vertical alignment type using a thin film transistor (TFT), and an in plane switching (IPS) type. A liquid crystal composition used in these liquid crystal display elements are required to have stability against external stimuli such as moisture, air, heat, or light, a liquid crystal phase over a temperature range as wide as possible around room temperature, low viscosity, and low driving voltage. Further, the liquid crystal composition is formed of several to tens of types of compounds so that respective display elements have an optimal value of dielectric anisotropy (Δε) and/or refractive index anisotropy (Δn).

In the vertical alignment (VA) type display, a liquid crystal composition having a negative Δε is used, and in the horizontal alignment type display such as the TN type, STN type, or IPS (in plane switching) type, a liquid crystal composition having a positive Δε is used. In addition, a driving mode in which a liquid crystal composition having a positive Δε is vertically aligned when no voltage is applied, and a horizontal electric field is applied thereto for displaying has been reported, and the necessity of the liquid crystal composition having a positive Δε has been further increased. Meanwhile, in all of the driving modes, low voltage driving, high-speed responsiveness, and a wide operational temperature range are required. Specifically, a high absolute value having a positive Δε, a low viscosity (η), and a high nematic phase-isotropic liquid phase transition temperature (Tni) are required. In addition, from the setting of Δn×d, which is a product of Δn and a cell gap (d), it is necessary to adjust the combination of Δn of the liquid crystal composition and the cell gap in an appropriate range. In addition, since high-speed responsiveness is important in a case where the liquid crystal display element is applied to a television, the liquid crystal composition having a low rotational viscosity (γ1) is required.

As a configuration of the liquid crystal composition aimed for high-speed responsiveness, for example, a liquid crystal composition is disclosed, which uses a compound represented by Formula (A-1) or (A-2), which is a liquid crystal compound having a positive Δε, and a liquid crystal compound (B) having a neutral Δε in combination (PTLs 1 to 4).

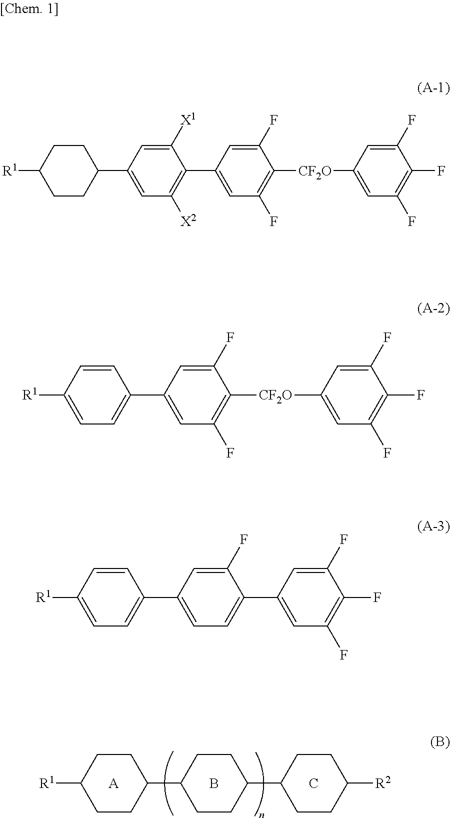

Meanwhile, as the use of the liquid crystal display element is widened, there has been a great change in the using method and manufacturing method of the liquid crystal display element. In order to cope with this change, it is required to optimize properties other than the basic physical property values which have been known in the related art. In other words, as the VA type or the IPS type becomes widely used, and the display element having a super large size of 50 or more becomes commonly used, the liquid crystal display element which uses the liquid crystal composition comes to be used. Along with the increase in size of a substrate, a one drop fill (ODF) method has become the mainstream from a vacuum injection method in the related art, as a method of injecting the liquid crystal composition to the substrate. However, a problem has occurred in which drop marks at the time of dropping the liquid crystal composition to the substrate degrades display quality. Further, in the process of manufacturing the liquid crystal display element by the ODF method, it is necessary to drop an optimal liquid crystal injection amount according to the size of the liquid crystal display element. When there is a large gap between the injection amount and the optimal value, a balance of the refractive index or the driving electric field of the liquid crystal display element, which is set in advance, is lost, and display defects such as occurrence of spots or contrast failure occur. In particular, in the small-sized liquid crystal display element which is often used for a smart phone which has been popular recently, since the optimal liquid crystal injection amount is small, it is difficult to control a gap from the optimal value within a constant range. Therefore, in order to maintain a high yield of the liquid crystal display element, for example, it is necessary that the liquid crystal display element is less affected by a drastic pressure change or shock occurring at the time of dropping the liquid crystal in a dropping device, and the liquid crystal can be dropped continuously and stably for a long period of time.

As such, in the liquid crystal composition used for an active matrix driving liquid crystal display element which is driven by the TFT element, a development of the composition is required, in consideration of a manufacturing method of the liquid crystal display element, in addition to properties such as a high specific resistance value or high voltage holding ratio, which has been important from the related art, and stability against external stimuli such as light or heat, while maintaining properties or performances such as high-speed responsiveness, which have been required as the liquid crystal display element.

### CITATION LIST

### Patent Literature

[PTL 1] JP-A-2008-037918

[PTL 2] JP-A-2008-038018

[PTL 3] JP-A-2010-275390

[PTL 4] JP-A-2011-052120

### SUMMARY OF INVENTION

### Technical Problem

An object of the present invention is to provide a composition which has a positive Δε, a liquid crystal phase over a wide temperature range, a low viscosity, an excellent solubility at low temperature, high specific resistance, high voltage holding ratio, and stability against heat or light, and further provide a liquid crystal display element such as an IPS type or a TN type, which has excellent display qualities and hardly causes display defects such as burn-in or drop marks, at a high yield by using the composition.

### Solution to Problem

The present inventors have reviewed various liquid crystal compounds and various chemical substances, and have found that the above mentioned problem can be solved by using specific liquid crystal compounds in combination, thereby completing the present invention.

There is provided a composition including one or more compounds represented by General Formula (i); and a compound represented by Formula (L-1-2.2); a liquid crystal display element using the composition; and a twisted nematic (TN) element, an electrically controlled birefringence (ECB) element, an in plane switching (IPS) element, or a fringe field switching (FFS) element each using the composition.

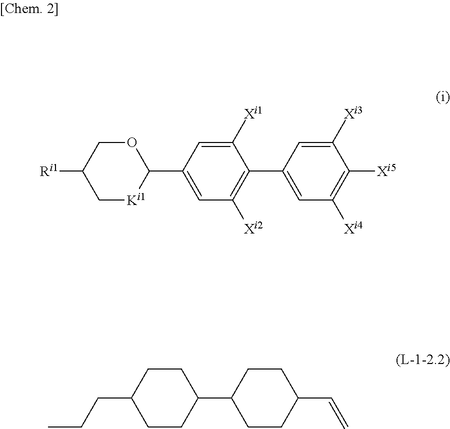

In the formula, Rⁱ¹ represents an alkyl group having 1 to 8 carbon atoms, one or more non-adjacent —CH₂—'s in the alkyl group each independently may be substituted with —CH═CH—, —C≡C—, —O—, —CO—, —COO—, or —OCO—, Kⁱ¹ represents —O— or —CH₂—, Xⁱ¹ to Xⁱ⁴ each independently represent a hydrogen atom, a fluorine atom, or a chlorine atom, and Xⁱ⁵ represents a fluorine atom, a trifluoromethyl group, a trifluoromethoxy group, or a chlorine atom.

### Advantageous Effects of Invention

Since the composition having a positive dielectric anisotropy of the present invention has a considerably low viscosity and excellent solubility at low temperature, and specific resistance or voltage holding ratio thereof is extremely less affected by heat or light, the product is highly practical, and the liquid crystal display element using the composition such as an IPS type or a FFS type has high-speed responsiveness. In addition, since the composition can exhibit stable performance in the process of manufacturing the liquid crystal display element, display defects caused during the process can be suppressed, and the element can be manufactured at high yield, which means that the composition is very useful.

### DESCRIPTION OF EMBODIMENTS

The composition of the present invention preferably exhibits a liquid crystal phase at room temperature (25° C.), and further preferably exhibits a nematic phase. In addition, the composition of the present invention includes an approximately dielectrically neutral compound (a value of Δε is −2 to 2) and a positive compound (a value of Δε is greater than 2). In addition, dielectric anisotropy of the compound is a value extrapolated from the measurement value of the dielectric anisotropy of the composition, which is prepared by adding the compound to an approximately dielectrically neutral composition at a temperature of 25° C. In addition, the following content is described using %, which means % by mass.

As the compound represented by Formula (i), one kind may be used, two kinds may be used, or three or more kinds can be used in combination.

In General Formula (i), Rⁱ¹ is preferably an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, is preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, is further preferably an alkyl group having 1 to 5 carbon atoms, or an alkenyl group having 2 to 5 carbon atoms, and is further preferably an alkyl group having 2 to 5 carbon atoms or an alkenyl group having 2 to 3 carbon atoms.

In a case of putting importance on the reliability, Rⁱ¹ is preferably an alkyl group, and in a case of putting importance on low viscosity, an alkenyl group is preferable.

In addition, Rⁱ¹ is preferably in a linear shape.

As an alkenyl group, it is preferably selected from the group represented by any one of Formula (R1) to Formula (R5) (the black dot in each formula represents a carbon atom in the ring structure).

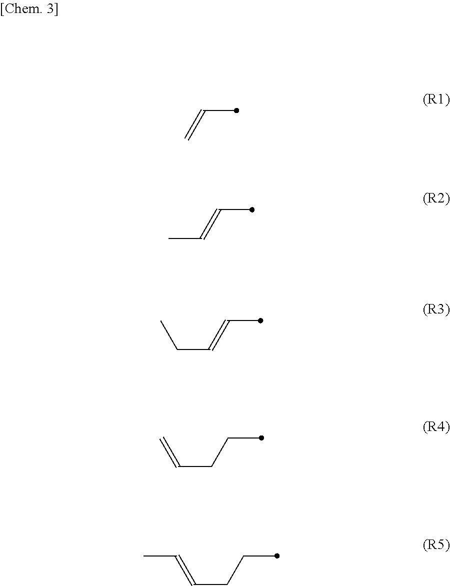

In a case of putting importance on improving the Δε, Kⁱ¹ is preferably —O—, and in a case of putting importance on reliability of a liquid crystal composition while improving Δε and η, Kⁱ¹ is preferably —CH₂—.

In Xⁱ¹ to Xⁱ⁴, at least two are preferably fluorine atoms, and at least three are preferably fluorine atoms. Xⁱ¹, Xⁱ², and Xⁱ³ are fluorine atoms, and Xⁱ² is preferably a hydrogen atom.

A lower limit of a preferable total content of the compounds represented by Formula (i) with respect to a total amount of the composition of the present invention is 1%, 2%, 4%, 5%, 8%, 10%, 13%, 15%, 18%, 20%, 23%, 25%, 28%, or 30%. An upper limit of the preferable content is 50%, 45%, 43%, 40%, 38%, 35%, 33%, 20%, 18%, 15%, 13%, 10%, 8%, or 5%.

A lower limit of a preferable content of these compounds represented by Formula (L-1-2.2) with respect to a total amount of the composition of the present invention is 10%, 15%, 18%, 20%, 23%, 25%, 27%, 30%, 33%, 35%, 38%, or 40%. An upper limit of the preferable content with respect to a total amount of the composition of the present invention is 60%, 55%, 50%, 45%, 43%, 40%, 38%, 35%, 32%, 30%, 27%, 25%, or 22%.

The composition of the present invention preferably contains one or more kinds of compounds represented by General Formula (J). These compounds correspond to dielectrically positive compounds (Δε is greater than 2).

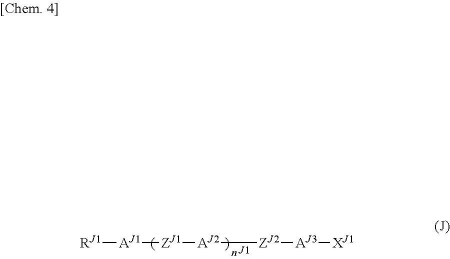

In the formula, R^{J1} represents an alkyl group having 1 to 8 carbon atoms; and one or more non-adjacent —CH₂—'s in the alkyl group each independently may be substituted with —CH═CH—, —C≡C—, —O—, —CO—, —COO—, or —OCO—, n^{J1} represents 0, 1, 2, 3, or 4, A^{J1}, A^{J2}, and A^{J3} each independently represent a group selected from the group consisting of: (a) a 1,4-cyclohexylene group (one —CH₂— or two or more non-adjacent —CH₂—'s existing in this group may be substituted with —O—); (b) a 1,4-phenylene group (one —CH═ or two or more non-adjacent —CH═'s existing in this group may be substituted with —N═); (c) a naphthalene-2,6-diyl group, a 1,2,3,4-tetrahydronaphthalene-2,6-diyl group, or a decahydronaphthalene-2,6-diyl group (one —CH═ or two or more non-adjacent —CH═'s existing in a naphthalene-2,6-diyl group or a 1,2,3,4-tetrahydronaphthalene-2,6-diyl group may be substituted with —N═); and the group (a), the group (b), and the group (c) each independently may be substituted with a cyano group, fluorine atom, a chlorine atom, a methyl group, a trifluoromethyl group, or a trifluoromethoxy group, Z^{J1} and Z^{J2} each independently represent a single bond, —CH₂CH₂—, —(CH₂)₄—, —OCH₂—, —CH₂O—, —OCF₂—, —CF₂O—, —COO—, —OCO—, or —C≡C—, in a case where n^{J1} is 2, 3, or 4, and a plurality of A^{J2}'s exist, the plurality of A^{J2}'s may be the same as or different from each other; and in a case where n^{J1} is 2, 3, or 4, and a plurality of Z^{J1}'s exist, the plurality of Z^{J1}'s may be the same as or different from each other, and X^{J1} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group, provided that a compound represented by General Formula (i) is excluded.

In General Formula (J), R^{J1} preferably represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, is further preferably an alkyl group having 1 to 5 carbon atoms or an alkenyl group having 2 to 5 carbon atoms, further preferably represents an alkyl group having 2 to 5 carbon atoms or an alkenyl group having 2 to 3 carbon atoms, and particularly preferably represents an alkenyl group (a propenyl group) having 3 carbon atoms.

In a case in a case of putting importance on the reliability, R^{J1} is preferably an alkyl group, and in a case of putting importance on the low viscosity, an alkenyl group is preferable.

In a case where a ring structure to which R^{J1} is bonded is a phenyl group (aromatic group), R^{J1} is preferably a linear alkyl group having 1 to 5 carbon atoms, a linear alkoxy group having 1 to 4 carbon atoms, and an alkenyl group having 4 to 5 carbon atoms, and in a case where a ring structure to which R^{J1} is bonded is a saturated ring structure such as cyclohexane, pyran, and dioxane, R^{J1} is preferably a linear alkyl group having 1 to 5 carbon atoms, a linear alkoxy group having 1 to 4 carbon atoms, and a linear alkenyl group having 2 to 5 carbon atoms. In order to stabilize the nematic phase, it is preferable that the total oxygen atom is 5 or less in a case where the carbon atom, exists, and it is preferably in a linear shape.

An alkenyl group is preferably selected from the groups represented by Formula (R1) to Formula (R5) (the black dot in each formula represents a carbon atom in the ring structure to which the alkenyl group is bonded).

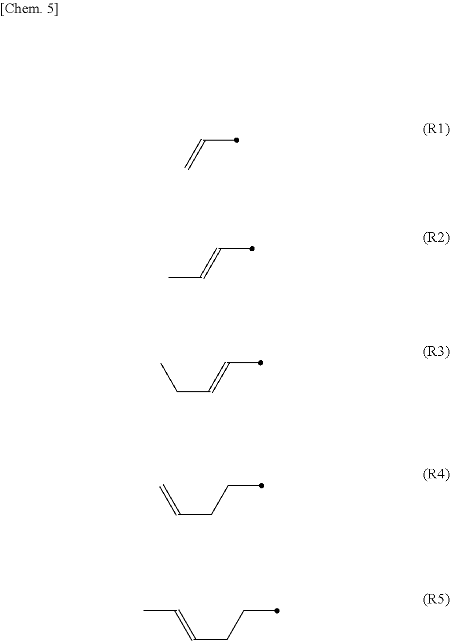

A^{J1}, A^{J2} and A^{J3} each independently are preferably aromatic in a case where Δn is required to be increased, are preferably aliphatic in order to improve the response speed, preferably represent a trans-1,4-cyclohexylene group, a 1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, may be substituted with a fluorine atom, and further preferably represent the following structures.

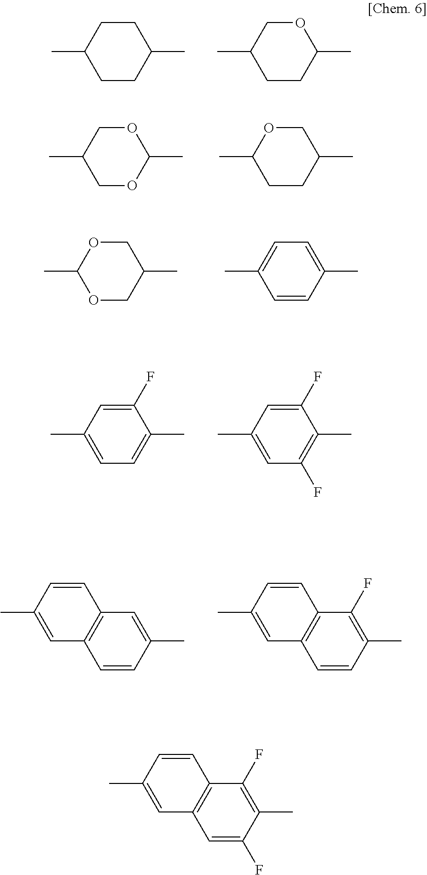

It is further preferable that A^{J1}, A^{J2} and A^{J3} each independently represent the following structures.

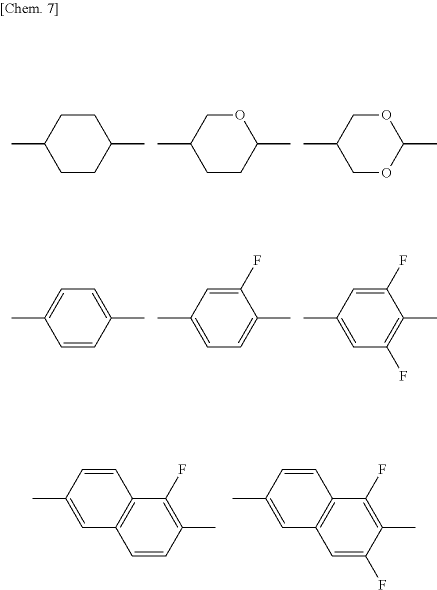

Z^{J1} and Z^{J2} each independently preferably represent —CH₂O—, —OCH₂—, —CF₂O—, —CH₂CH₂—, —CF₂CF₂— or a single bond, further preferably represent —OCH₂—, —CF₂O—, —CH₂CH₂— or a single bond, and particularly preferably represent —OCH₂—, —CF₂O— or a single bond.

X^{J1} preferably represents a fluorine atom or a trifluoromethoxy group, and a fluorine atom is further preferable.

n^{J1} is preferably 0, 1, 2, or is preferably 3, 0, 1 or 2, in a case of putting importance on improving Δε, 0 or 1 is preferable, and in a case where emphasis is placed on Tni, 1 or 2 is preferable.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 for one embodiment of the present invention. Further, in another embodiment of the present invention, the number of the types of the compounds to be used is 4, 5, 6, or 7 or more.

In the composition of the present invention, it is necessary that the content of the compound represented by General Formula (J) is appropriately adjusted according to the required performances such as solubility at low temperature, transition temperature, electrical reliability, birefringence, process adaptability, drop marks, burn-in, and dielectric anisotropy.

A lower limit of a preferable content of the compounds represented by General Formula (J) with respect to a total amount of the composition of the present invention is 1%, 10%, 20%, 30%, 40%, 50%, 55%, 60%, 65%, 70%, 75%, or 80%. An upper limit of the preferable content with respect to a total amount of the composition of the present invention is 95%, 85%, 75%, 65%, 55%, 45%, 35%, or 25% in one embodiment of the present invention, for example.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

In a case in a case of putting importance on the reliability, R^{J1} is preferably an alkyl group, and in a case of putting importance on the low viscosity, an alkenyl group is preferable.

As the compound represented by General Formula (J), a compound represented by General Formula (M) and a compound represented by General Formula (K) are preferable.

The composition of the present invention preferably contains one or more kinds of compounds represented by General Formula (M). These compounds correspond to the dielectrically positive compounds (Δε is greater than 2).

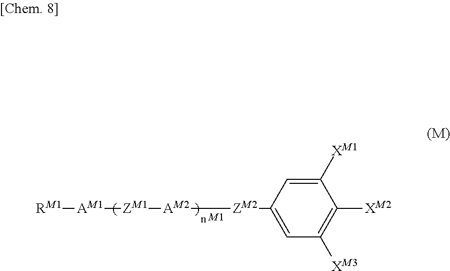

In the formula, R^{M1} represents an alkyl group having 1 to 8 carbon atoms, one or more non-adjacent —CH₂—'s in the alkyl group each independently may be substituted with —CH═CH—, —C≡C—, —O—, —CO—, —COO—, or —OCO—, n^{M1} represents 0, 1, 2, 3, or 4, A^{M1} and A^{M2} each independently represent a group selected from the group consisting of (a) a 1,4-cyclohexylene group (one —CH₂— or two or more non-adjacent —CH₂—'s existing in the group may be substituted with —O— or —S—) and (b) a 1,4-phenylene group (one —CH═ or two or more non-adjacent —CH═'s existing in this group may be substituted with —N═), the hydrogen atoms on the group (a) and group (b) each independently may be substituted with a cyano group, a fluorine atom, or a chlorine atom, Z^{M1} and Z^{M2} each independently represent a single bond, —CH₂CH₂—, —(CH₂)₄—, —OCH₂—, —CH₂O—, —OCF₂—, —CF₂O—, —COO—, —OCO—, or —C≡C—, in a case where n^{M1} is 2, 3, or 4 and a plurality of A^{M2}'s exist, the plurality of A^{M2}'s may be the same as or different from each other, in a case where n^{M1} is 2, 3, or 4 and a plurality of Z^{M1}'s exist, the plurality of Z^{M1}'s may be the same as or different from each other, X^{M1} and X^{M3} each independently a hydrogen atom, a chlorine atom, or a fluorine atom, X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group, here, the compound represented by General Formula (i) is excluded.

In General Formula (M), R^{M1} preferably represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, is further preferably an alkyl group having 1 to 5 carbon atoms or an alkenyl group having 2 to 5 carbon atoms, further preferably represents an alkyl group having 2 to 5 carbon atoms or an alkenyl group having 2 to 3 carbon atoms, and particularly preferably represents an alkenyl group (a propenyl group) having 3 carbon atoms.

In a case of putting importance on the reliability, R^{M1} is preferably an alkyl group, and in a case of putting importance on the low viscosity, R^{M1} is preferably an alkenyl group.

In a case where a ring structure to which R^{M1} is bonded is a phenyl group (aromatic group), R^{M1} is preferably a linear alkyl group having 1 to 5 carbon atoms, a linear alkoxy group having 1 to 4 carbon atoms, and an alkenyl group having 4 to 5 carbon atoms, and in a case where a ring structure to which R^{M1} is bonded is a saturated ring structure such as cyclohexane, pyran, and dioxane, R^{M1} is preferably a linear alkyl group having 1 to 5 carbon atoms, a linear alkoxy group having 1 to 4 carbon atoms, and a linear alkenyl group having 2 to 5 carbon atoms. In order to stabilize the nematic phase, it is preferable that the total oxygen atom is 5 or less in a case where the carbon atom exists, and it is preferably in a linear shape.

As an alkenyl group, it is preferably selected from the group represented by any one of Formula (R1) to Formula (R5) (the black dot in each formula represents a carbon atom in the ring structure to which the alkenyl group is bonded).

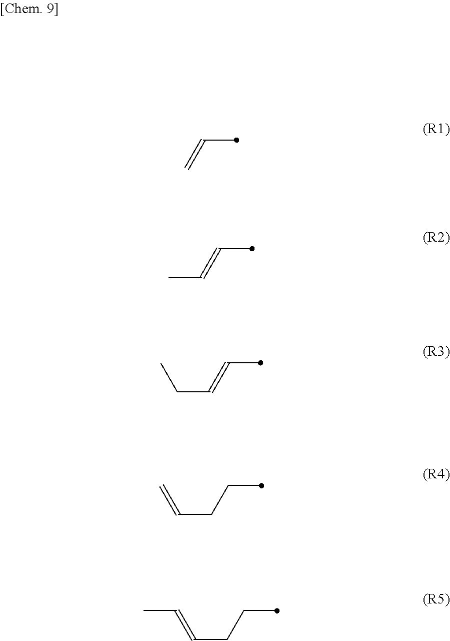

A^{M1} and A^{M2} each independently are preferably aromatic in a case where Δn is required to be increased, are preferably aliphatic in order to improve the response speed, preferably represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and further preferably represent the following structure.

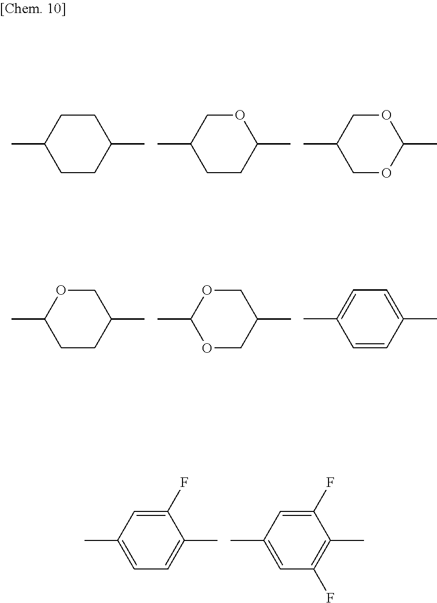

It is further preferable that A^{M1} and A^{M2} each independently represent the following structure.

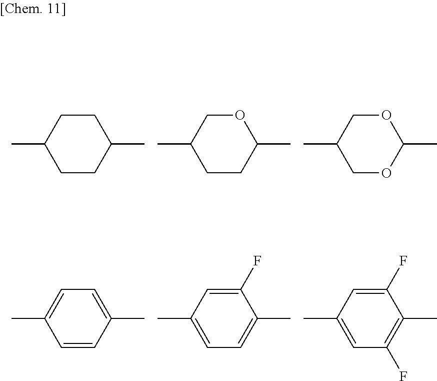

Z^{M2} and Z^{M2} each independently preferably represent —CH₂O—, —CF₂O—, —CH₂CH₂—, —CF₂CF₂— or a single bond, further preferably represent —CF₂O—, —CH₂CH₂— or a single bond, and particularly preferably represent —CF₂O— or a single bond.

n^{M1} is preferably 0, 1, 2, or 3, is preferably 0, 1, or 2, in a case of putting importance on improving Δε, 0 or 1 is preferable, and in a case where emphasis is placed on Tni, 1 or 2 is preferable.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 for one embodiment of the present invention. Further, in another embodiment of the present invention, the number of the types of the compounds to be used is 4, 5, 6, or 7 or more.

In the composition of the present invention, it is necessary that the content of the compound represented by General Formula (M) is appropriately adjusted according to the required performances such as solubility at low temperature, transition temperature, electrical reliability, birefringence, process adaptability, drop marks, burn-in, and dielectric anisotropy.

A lower limit of a preferable content of the compound represented by Formula (M) with respect to a total amount of the composition of the present invention is 1%, 10%, 20%, 30%, 40%, 50%, 55%, 60%, 65%, 70%, 75%, or 80%. An upper limit of the preferable content with respect to a total amount of the composition of the present invention is 95%, 85%, 75%, 65%, 55%, 45%, 35%, or 25%, in one embodiment of the present invention, for example.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

For example, the compound represented by General Formula (M) is preferably a compound selected from the compound group represented by General Formula (M-1).

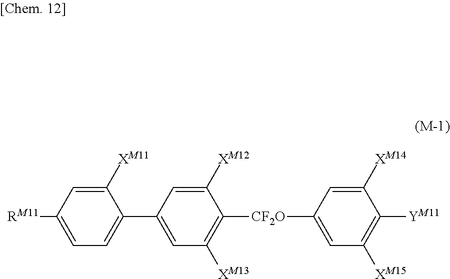

In the formula, R^{M11} represents an alkyl group having 1 to 5 carbon atoms, an alkenyl group having 2 to 5 carbon atoms, or an alkoxy group having 1 to 4 carbon atoms, X^{M11} to X^{M15} each independently represent a hydrogen atom or a fluorine atom, and Y^{M11} represents a fluorine atom or OCF₃.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 or more for one embodiment of the present invention.

A lower limit of a preferable content of the compound represented by Formula (M-1) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

Specifically, the compound represented by General Formula (M-1) is preferably compounds represented by Formula (M-1.1) to Formula (M-1.4), is preferably the compound represented by Formula (M-1.1) or Formula (M-1.2), and is further preferably the compound represented by Formula (M-1.2). In addition, it is preferable to use the compound represented by Formula (M-1.1) and the compound represented by Formula (M-1.2) at the same time.

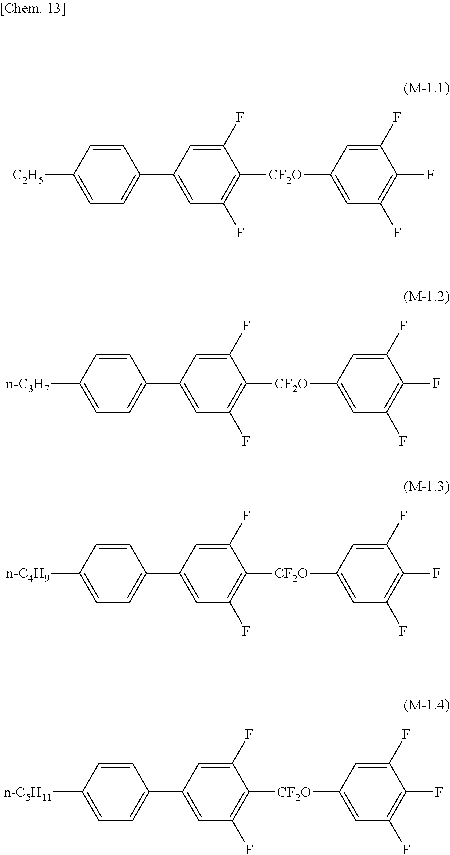

A lower limit of a preferable content of the compound represented by Formula (M-1.1) with respect to a total amount of the composition of the present invention is 1%, 2%, 5%, or 6%. An upper limit of the preferable content is 15%, 13%, 10%, 8%, or 5%.

A lower limit of a preferable total content of the compound represented by Formula (M-1.2) with respect to a total amount of the composition of the present invention is 1%, 2%, 5%, or 6%. An upper limit of the preferable content is 30%, 25%, 23%, 20%, 18%, 15%, 13%, 10%, or 8%.

A lower limit of a preferable total content of the compounds represented by Formula (M-1.1) and Formula (M-1.2) with respect to a total amount of the composition of the present invention is 1%, 2%, 5%, or 6%. An upper limit of the preferable content is 30%, 25%, 23%, 20%, 18%, 15%, 13%, 10%, or 8%.

Further, for example, the compound represented by General Formula (M) is preferably a compound selected from the compound group represented by General Formula (M-2).

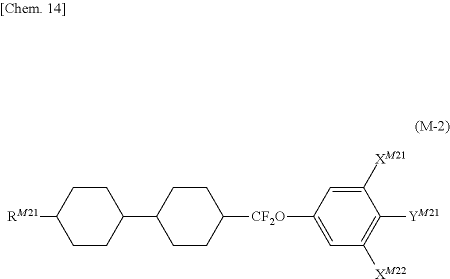

In the formula, R^{M21} represents an alkyl group having 1 to 5 carbon atoms, an alkenyl group having 2 to 5 carbon atoms, or an alkoxy group having 1 to 4 carbon atoms, X^{M21} and X^{M22} each independently represent a hydrogen atom or a fluorine atom, and Y^{M21} represents a fluorine atom, a chlorine atom, or OCF₃.

A lower limit of the preferable content of the compound represented by Formula (M-1) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. In a case where Tni of the composition of the present invention is kept high, and a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, the compound represented by General Formula (M-2) is preferably compounds represented by Formula (M-2.1) to Formula (M-2.5), and is preferably the compound represented by Formula (M-2.3) or/and Formula (M-2.5).

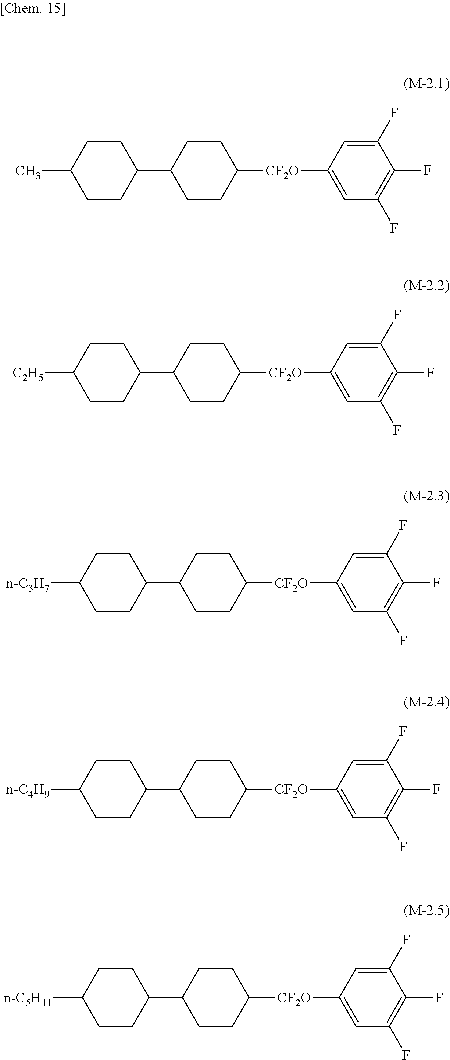

A lower limit of a preferable content of the compound represented by Formula (M-2.2) with respect to a total amount of the composition of the present invention is 1%, 2%, 5%, or 6%. An upper limit of the preferable content is 15%, 13%, 10%, 8%, or 5%.

A lower limit of a preferable content of the compound represented by Formula (M-2.3) with respect to a total amount of the composition of the present invention is 1%, 2%, 5%, or 6%. An upper limit of the preferable content is 30%, 25%, 23%, 20%, 18%, 15%, 13%, 10%, or 8%.

A lower limit of a preferable content of the compound represented by Formula (M-2.5) with respect to a total amount of the composition of the present invention is 1%, 2%, 5%, or 6%. An upper limit of the preferable content is 30%, 25%, 23%, 20%, 18%, 15%, 13%, 10%, or 8%.

A lower limit of a preferable total content of the compounds represented by Formulae (M-2.2), (M-2.3), and (M-2.5) with respect to a total amount of the composition of the present invention is 1%, 2%, 5%, or 6%. An upper limit of the preferable content is 30%, 25%, 23%, 20%, 18%, 15%, 13%, 10%, or 8%.

The content is preferably 1% or more, further preferably 5% or more, still further preferably 8% or more, still further preferably 10% or more, still further preferably 14% or more, and particularly preferably 16% or more, with respect to a total amount of the composition of the present invention. In addition, a maximum ratio is preferably 30% or less, further preferably 25% or less, still further preferably 22% or less, and particularly preferably less than 20%, in consideration of solubility at low temperature, transition temperature, and electrical reliability.

The compound represented by General Formula (M) used in the composition of the present invention is preferably a compound represented by General Formula (M-3).

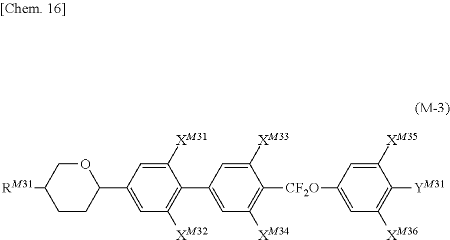

In the formula, R^{M31} represents an alkyl group having 1 to 5 carbon atoms, an alkenyl group having 2 to 5 carbon atoms, or an alkoxy group having 1 to 4 carbon atoms, X^{M31} to X^{M36} each independently represent a hydrogen atom or a fluorine atom, and Y^{M31} represents a fluorine atom, a chlorine atom, or OCF₃.

A type of the compound which can be combined is not particularly limited, and one or more compounds are preferably combined in consideration of solubility at low temperature, transition temperature, electrical reliability, birefringence, and the like.

A content of the compound represented by General Formula (M-3) has a lower limit and an upper limit for each embodiment, in consideration of solubility at low temperature, transition temperature, electrical reliability, and birefringence.

A lower limit of a preferable content of the compound represented by Formula (M-3) with respect to a total amount of the composition of the present invention is 1%, 2%, 4%, 5%, 8%, 10%, 13%, 15%, 18%, or 20%. An upper limit of the preferable content is 20%, 18%, 15%, 13%, 10%, 8%, or 5%.

Further, the compound represented by General Formula (M-3) used in the composition of the present invention is preferably, specifically, compounds represented by Formula (M-3.1) to Formula (M-3.4), and among the above, the compounds represented by Formula (M-3.1) and/or Formula (M-3.2) are preferably contained.

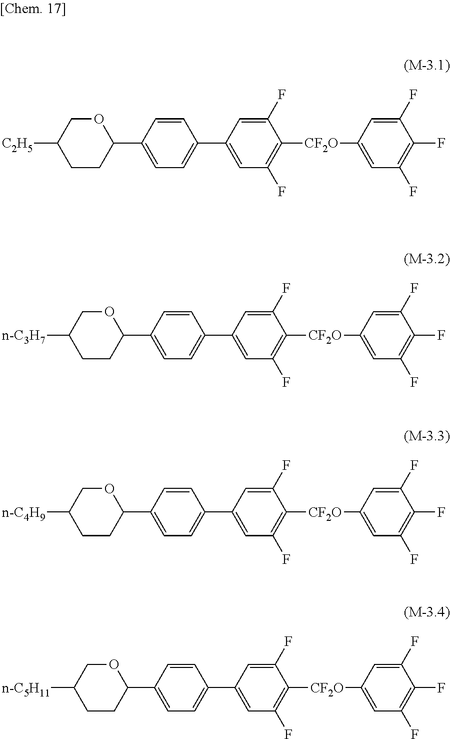

A lower limit of a preferable content of the compound represented by Formula (M-3.1) with respect to a total amount of the composition of the present invention is 1%, 2%, 4%, 5%, 8%, 10%, 13%, 15%, 18%, or 20%. An upper limit of the preferable content is 20%, 18%, 15%, 13%, 10%, 8%, or 5%.

A lower limit of a preferable content of the compound represented by Formula (M-3.2) with respect to a total amount of the composition of the present invention is 1%, 2%, 4%, 5%, 8%, 10%, 13%, 15%, 18%, or 20%. An upper limit of the preferable content is 20%, 18%, 15%, 13%, 10%, 8%, or 5%.

A lower limit of a preferable total content of the compounds represented by Formulae (M-3.1) and (M-3.2) with respect to a total amount of the composition of the present invention is 1%, 2%, 4%, 5%, 8%, 10%, 13%, 15%, 18%, or 20%. An upper limit of the preferable content is 20%, 18%, 15%, 13%, 10%, 8%, or 5%.

Further, the compound represented by General Formula (M) is preferably a compound selected from the group represented by General Formula (M-4).

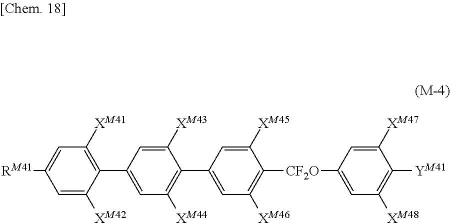

In the formula, R^{M41} represents an alkyl group having 1 to 5 carbon atoms, an alkenyl group having 2 to 5 carbon atoms, or an alkoxy group having 1 to 4 carbon atoms, X^{M41} to X^{M48} each independently represent a fluorine atom or a hydrogen atom, Y^{M41} represents a fluorine atom, a chlorine atom, or OCF₃.

A type of the compound which can be combined is not particularly limited, and one, two, or three or more compounds are preferably combined in consideration of solubility at low temperature, transition temperature, electrical reliability, birefringence, and the like.

A content of the compound represented by General Formula (M-4) has an upper limit and a lower limit for each embodiment, in consideration of properties such as solubility at low temperature, transition temperature, electrical reliability, and birefringence.

A lower limit of a preferable content of the compound represented by Formula (M-4) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where the composition of the present invention is used for a liquid crystal display element having a small cell gap, it is appropriate to increase the content of the compound represented by General Formula (M-4). In a case where the composition is used for a liquid crystal display element having low driving voltage, it is appropriate to increase the content of the compound represented by General Formula (M-4). In addition, in a case where the composition is used for a liquid crystal display element used in a low temperature environment, it is appropriate to decrease the content of the compound represented by General Formula (M-4). In a case where the composition is used for a liquid crystal display element having a high response speed, it is appropriate to decrease the content of the compound represented by General Formula (M-4).

Further, as the compound represented by General Formula (M-4) used in the composition of the present invention, specifically, compounds represented by Formula (M-4.1) to Formula (M-4.4) are preferable, among the above, the compounds represented by Formula (M-4.2) to Formula (M-4.4) are preferably contained, and the compound represented by Formula (M-4.2) is further preferably contained.

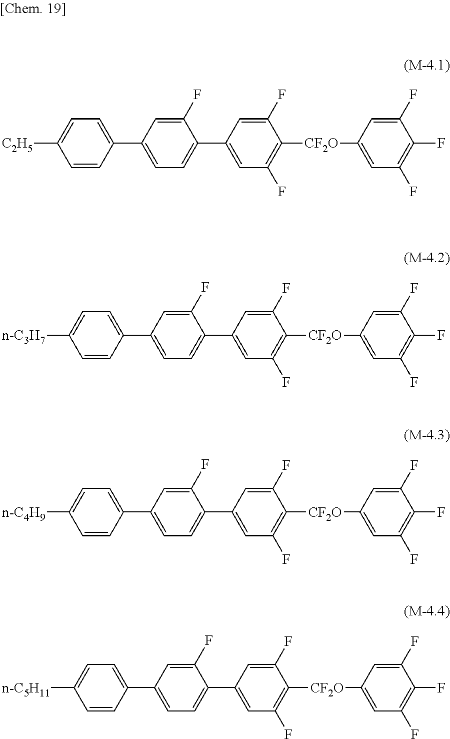

The compound represented by General Formula (M) is preferably a compound represented by General Formula (M-5).

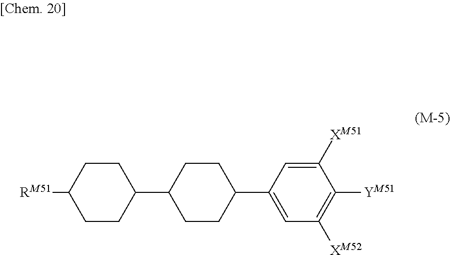

In the formula, R^{M51} represents an alkyl group having 1 to 5 carbon atoms, an alkenyl group having 2 to 5 carbon atoms, or an alkoxy group having 1 to 4 carbon atoms, X^{M51} and X^{M52} each independently represent a hydrogen atom or a fluorine atom, and Y^{M51} represents a fluorine atom, a chlorine atom, or OCF₃.

A type of the compound which can be combined is not limited, and the compound is appropriately used in combination for each embodiment, in consideration of solubility at low temperature, transition temperature, electrical reliability, and birefringence. For example, 1 type of the compound is combined in one embodiment of the present invention, 2 types are combined in another embodiment, 3 types are combined in yet another embodiment, 4 types are combined in yet another embodiment, 5 types are combined in yet another embodiment, and 6 types or more are combined in yet another embodiment.

A lower limit of a preferable content of the compound represented by Formula (M-5) with respect to a total amount of the composition of the present invention is 1%, 2%, 5%, 8%, 10%, 13%, 15%, 18%, 20%, 22%, 25%, or 30%. An upper limit of the preferable content is 50%, 45%, 40%, 35%, 33%, 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. In the case where Tni of the composition of the present invention is kept high, and a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, the compound represented by General Formula (M-5) is preferably compounds represented by Formula (M-5.1) to Formula (M-5.4), and preferably the compounds represented by Formula (M-5.1) to Formula (M-5.4).

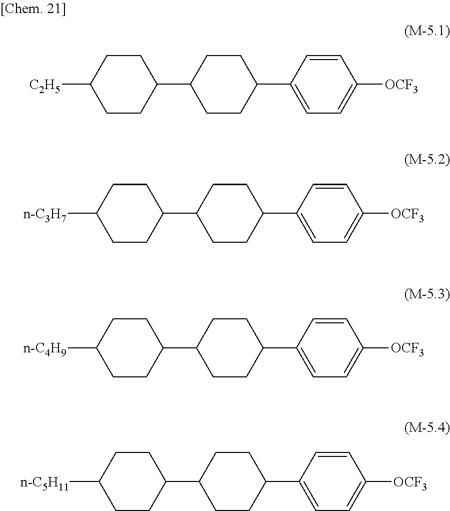

A lower limit of a preferable content of these compounds with respect to a total amount of the composition of the present invention is 1%, 2%, 5%, 8%, 10%, 13%, or 15%. An upper limit of the preferable content is 30%, 28%, 25%, 23%, 20%, 18%, 15%, 13%, 10%, 8%, or 5%.

Further, the compound represented by General Formula (M-5) is preferably compounds represented by Formula (M-5.11) to Formula (M-5.17), and preferably the compounds represented by Formula (M-5.11), Formula (M-5.13), and Formula (M-5.17).

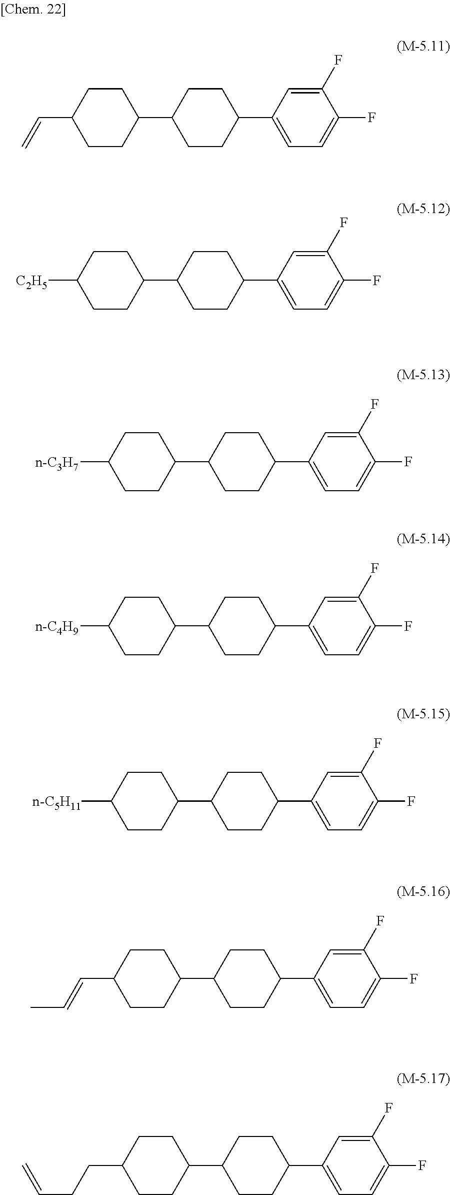

A lower limit of a preferable content of these compounds with respect to a total amount of the composition of the present invention is 1%, 2%, 5%, 8%, 10%, 13%, or 15%. An upper limit of the preferable content is 30%, 28%, 25%, 23%, 20%, 18%, 15%, 13%, 10%, 8%, or 5%.

Further, the compound represented by General Formula (M-5) is preferably compounds represented by Formula (M-5.21) to Formula (M-5.28), and is preferably the compounds represented by Formula (M-5.21), Formula (M-5.22), Formula (M-5.23), and Formula (M-5.25).

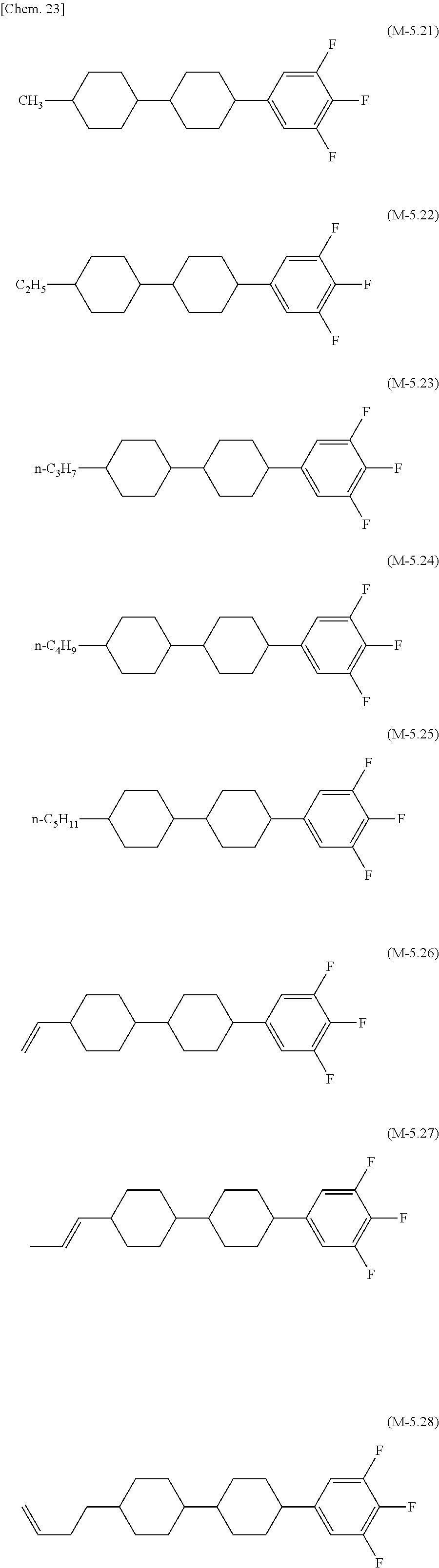

A lower limit of a preferable content of these compounds with respect to a total amount of the composition of the present invention is 1%, 2%, 5%, 8%, 10%, 13%, 15%, 18%, 20%, 22%, 25%, or 30%. An upper limit of the preferable content is 40%, 35%, 33%, 30%, 28%, 25%, 23%, 20%, 18%, 15%, 13%, 10%, 8%, or 5%.

Further, the compound represented by General Formula (M) is preferably a compound represented by General Formula (M-6).

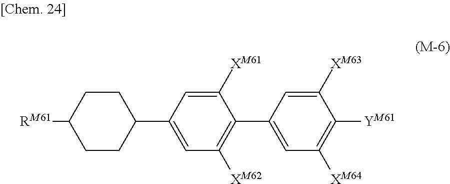

In the formula, R^{M61} represents an alkyl group having 1 to 5 carbon atoms, an alkenyl group having 2 to 5 carbon atoms, or an alkoxy group having 1 to 4 carbon atoms, X^{M61} to X^{M64} each independently represent a fluorine atom or a hydrogen atom, and Y^{M61} represents a fluorine atom, a chlorine atom, or OCF₃.

A type of the compound which can be combined is not limited, and the compound is appropriately used in combination for each embodiment, in consideration of solubility at low temperature, transition temperature, electrical reliability, and birefringence.

A lower limit of a preferable content of the compound represented by Formula (M-6) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where the composition of the present invention is used for a liquid crystal display element having a small driving voltage, it is appropriate to increase the content of the compound represented by General Formula (M-6). In a case where the composition is used for a liquid crystal display element having a high response speed, it is appropriate to decrease the content of the compound represented by General Formula (M-6).

Specifically, the compound represented by General Formula (M-6) is preferably compounds represented by Formula (M-6.1) to Formula (M-6.4), and among the above, the compounds represented by Formula (M-6.2) and Formula (M-6.4) are preferably contained.

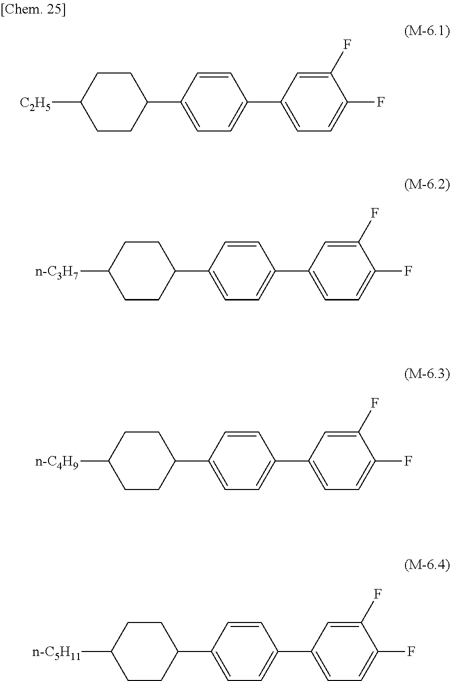

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Specifically, the compound represented by General Formula (M-6) is preferably compounds represented by Formula (M-6.11) to Formula (M-6.14), and among the above, the compounds represented by Formula (M-6.12) and Formula (M-6.14) are preferably contained.

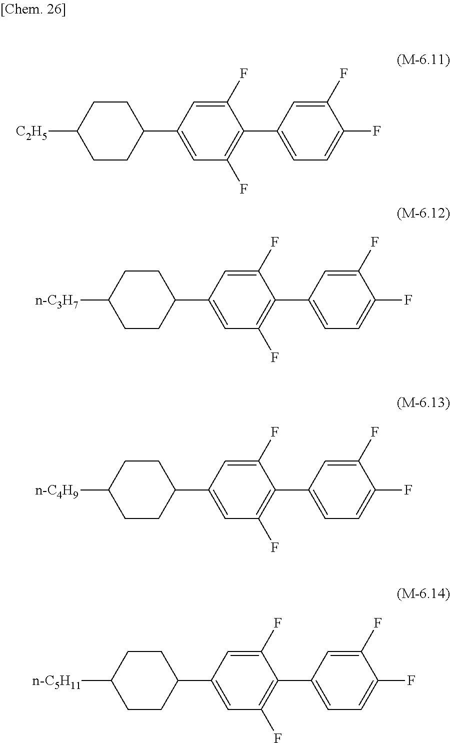

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Specifically, the compound represented by General Formula (M-6) is preferably compounds represented by Formula (M-6.21) to Formula (M-6.24), and among the above, the compounds represented by Formula (M-6.21), Formula (M-6.22), and Formula (M-6.24) are preferably contained.

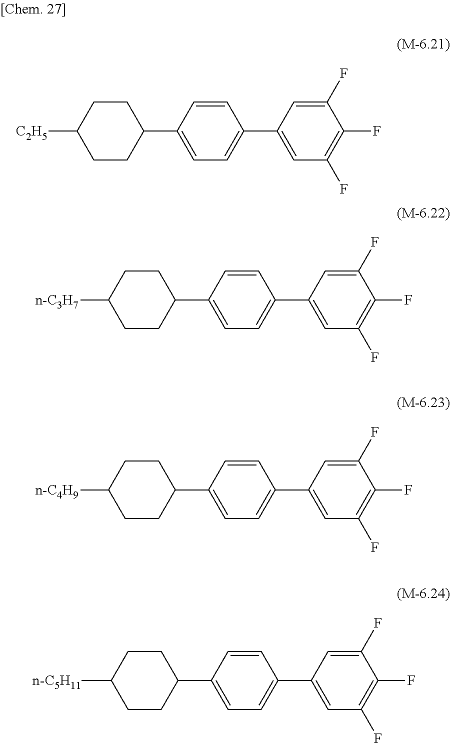

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Specifically, the compound represented by General Formula (M-6) is preferably compounds represented by Formula (M-6.31) to Formula (M-6.34), and among the above, the compounds represented by Formula (M-6.31) and Formula (M-6.32) are preferably contained.

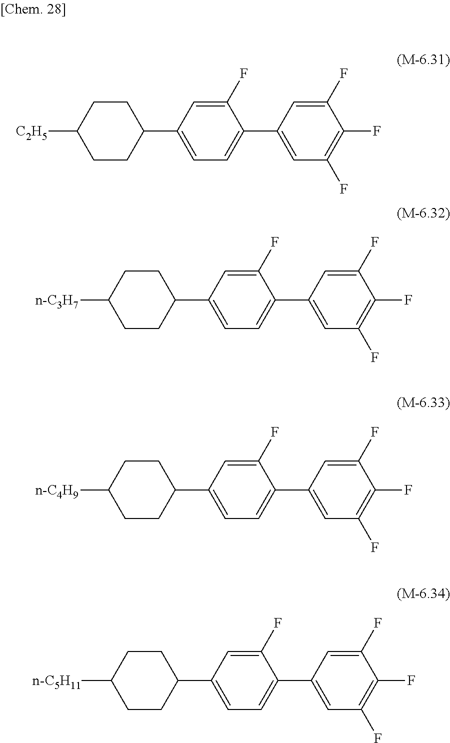

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Specifically, the compound represented by General Formula (M-6) is preferably compounds represented by Formula (M-6.41) to Formula (M-6.44), and among the above, the compound represented by Formula (M-6.42) is preferably contained.

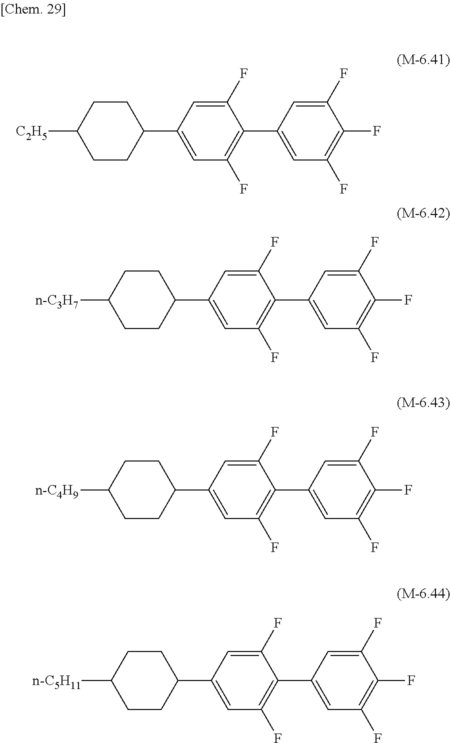

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M) is preferably a compound selected from the compound group represented by General Formula (M-7).

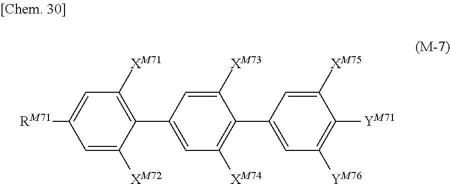

In the formula, X^{M71} to X^{M76} each independently represent a fluorine atom or a hydrogen atom, R^{M71} represents an alkyl group having 1 to 5 carbon atoms, an alkenyl group having 2 to 5 carbon atoms, or an alkoxy group having 1 to 4 carbon atoms, and Y^{M71} represents a fluorine atom or OCF₃.

A type of the compound which can be combined is not particularly limited, and 1 to 2 types of the compound is preferably contained, 1 to 3 types are more preferably contained, and 1 to 4 types are still more preferably contained.

A content of the compound represented by General Formula (M-7) has a lower limit and an upper limit for each embodiment, in consideration of solubility at low temperature, transition temperature, electrical reliability, and birefringence.

A lower limit of a preferable content of the compound represented by Formula (M-7) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where the composition of the present invention is used for a liquid crystal display element having a small cell gap, it is appropriate to increase the content of the compound represented by General Formula (M-7). In a case where the composition is used for a liquid crystal display element having low driving voltage, it is appropriate to increase the content of the compound represented by General Formula (M-7). In addition, in a case where the composition is used for a liquid crystal display element used in a low temperature environment, it is appropriate to decrease the content of the compound represented by General Formula (M-7). In a case where the composition is used for a liquid crystal display element having a high response speed, it is appropriate to decrease the content of the compound represented by General Formula (M-7).

Further, the compound represented by General Formula (M-7) is preferably compounds represented by Formula (M-7.1) to Formula (M-7.4), and preferably the compound represented by Formula (M-7.2).

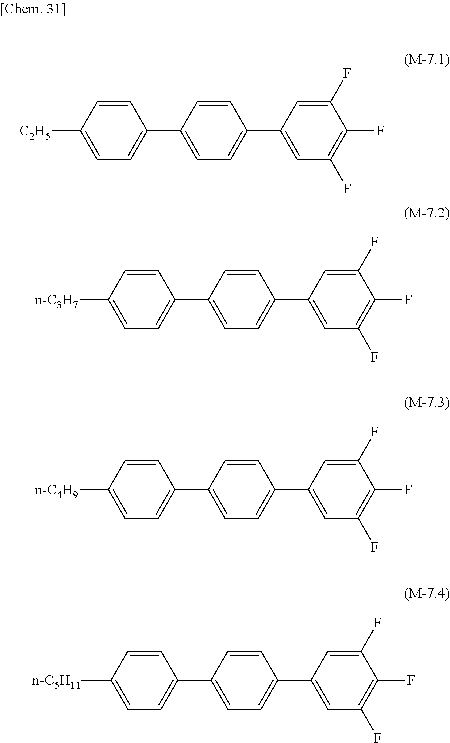

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M-7) is preferably compounds represented by the Formula (M-7.11) to Formula (M-7.14), and is preferably compounds represented by the Formula (M-7.11) and Formula (M-7.12).

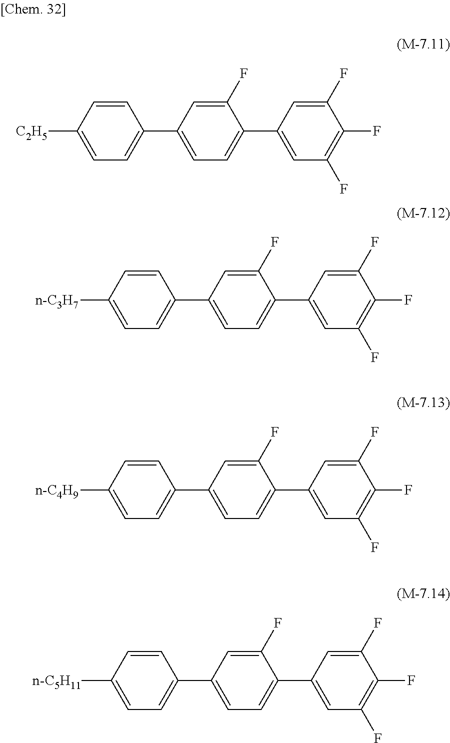

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M-7) is preferably compounds represented by the Formula (M-7.21) to Formula (M-7.24), and is preferably compound represented by Formula (M-7.21) and Formula (M-7.22).

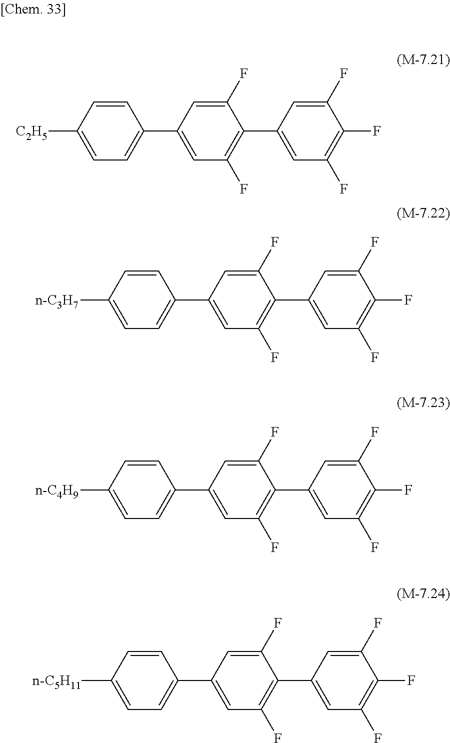

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M) is preferably a compound represented by General Formula (M-8).

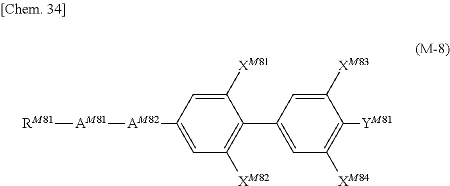

In the formula, X^{M81} to X^{M84} each independently represent a fluorine atom or a hydrogen atom, Y^{M81} represents a fluorine atom, a chlorine atom, or —OCF₃, R^{M81} represents an alkyl group having 1 to 5 carbon atoms, an alkenyl group having 2 to 5 carbon atoms, or an alkoxy group having 1 to 4 carbon atoms, A^{M81} and A^{M82} each independently represent a 1,4-cyclohexylene group, a 1,4-phenylene group, or the group represented as follows.

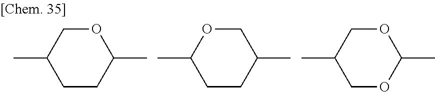

However, the hydrogen atom on the 1,4-phenylene group may be substituted with a fluorine atom.

A lower limit of a preferable content of the compound represented by General Formula (M-8) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, the compound represented by General Formula (M-8) used in the composition of the present invention is preferably, specifically, compounds represented by Formula (M-8.1) to Formula (M-8.4), and among the above, the compounds represented by Formula (M-8.1) and Formula (M-8.2) are preferably contained.

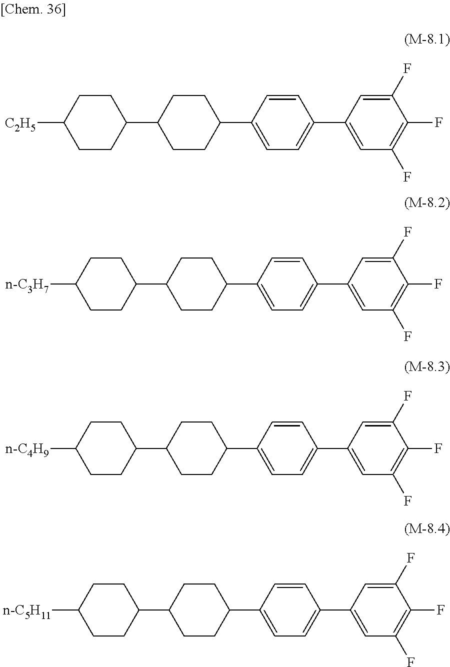

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M-8) used in the composition of the present invention is preferably, specifically, compounds represented by Formula (M-8.11) to Formula (M-8.14), and among the above, the compound represented by Formula (M-8.12) is preferably contained.

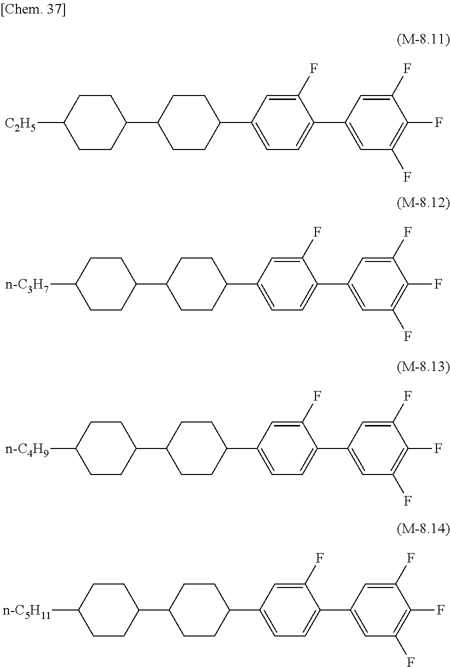

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M-8) used in the composition of the present invention is preferably, specifically, compounds represented by Formula (M-8.21) to Formula (M-8.24), and among the above, the compound represented by Formula (M-8.22) is preferably contained.

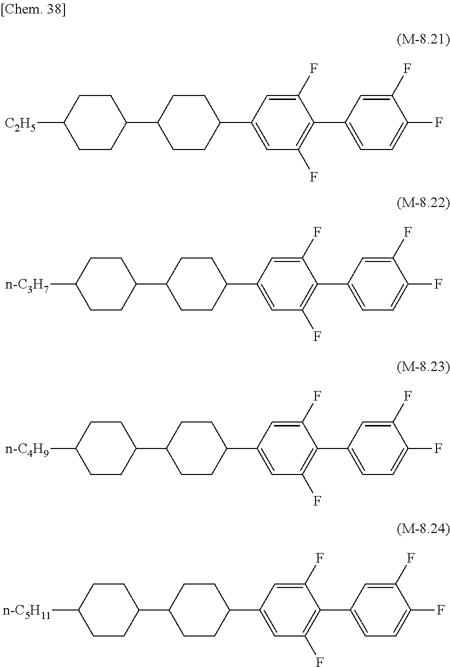

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M-8) used in the composition of the present invention is preferably, specifically, compounds represented by Formula (M-8.31) to Formula (M-8.34), and among the above, the compound represented by Formula (M-8.32) is preferably contained.

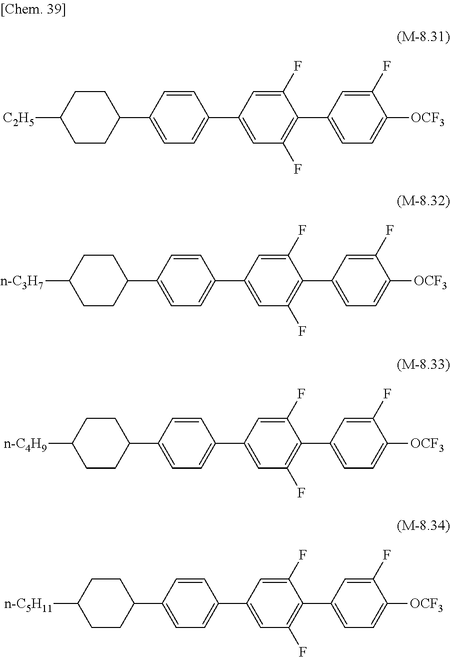

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M-8) used in the composition of the present invention is preferably, specifically, compounds represented by Formula (M-8.41) to Formula (M-8.44), and among the above, the compound represented by Formula (M-8.42) is preferably contained.

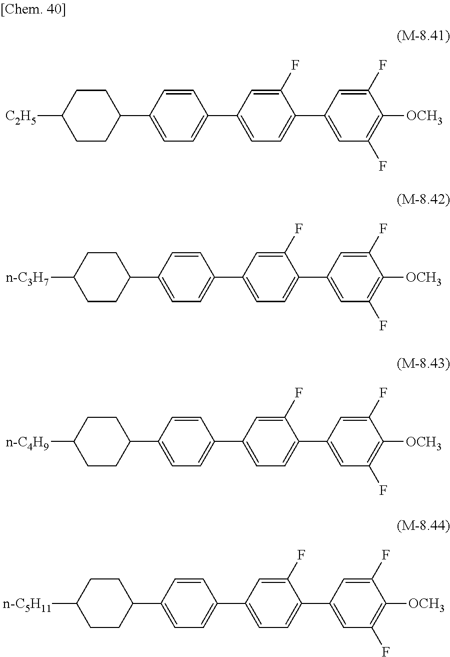

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

Further, the compound represented by General Formula (M-8) used in the composition of the present invention is preferably, specifically, compounds represented by Formula (M-8.51) to Formula (M-8.54), and among the above, the compound represented by Formula (M-8.52) is preferably contained.

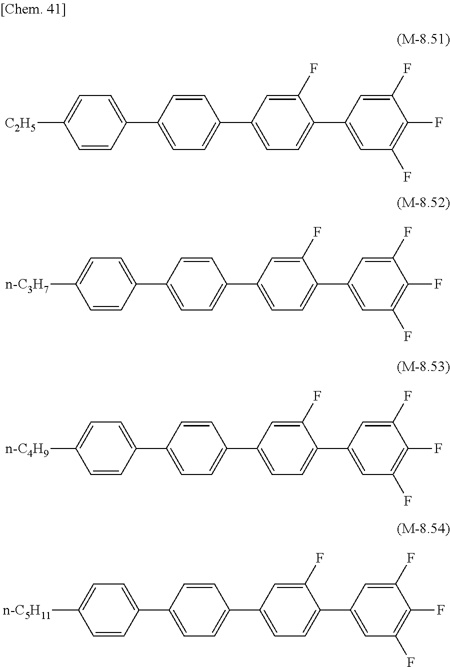

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In addition, the compound represented by General Formula (M) may have the following partial structure in the structure thereof.

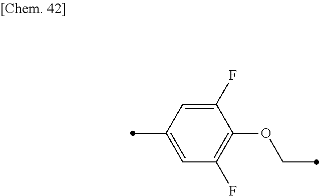

The black dot in the formula represents a carbon atom in the ring structure to which the above partial structure is bonded.

As the compound having the partial structure, the compounds represented by General Formulae (M-10) to (M-18) are preferable.

The compound represented by General Formula (M-10) is as follows.

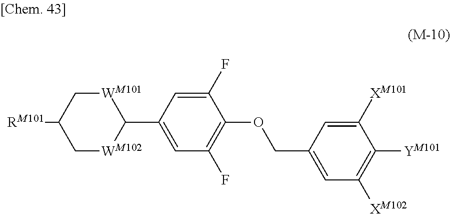

In the formula, X^{M101} and X^{M102} each independently represent a fluorine atom or a hydrogen atom, Y^{M101} represents a fluorine atom, a chlorine atom, or —OCF₃, R^{M101} represents an alkyl group having 1 to 5 carbon atoms, an alkenyl group having 2 to 5 carbon atoms, or an alkoxy group having 1 to 4 carbon atoms, and W^{M101} and W^{M102} each independently represent —CH₂— or —O—.

A lower limit of a preferable content of the compound represented by General Formula (M-10) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-10) used in the composition of the present invention, specifically, compounds represented by Formula (M-10.1) to Formula (M-10.12) are preferable, among the above, the compounds represented by Formula (M-10.5) to Formula (M-10.12) are preferably contained.

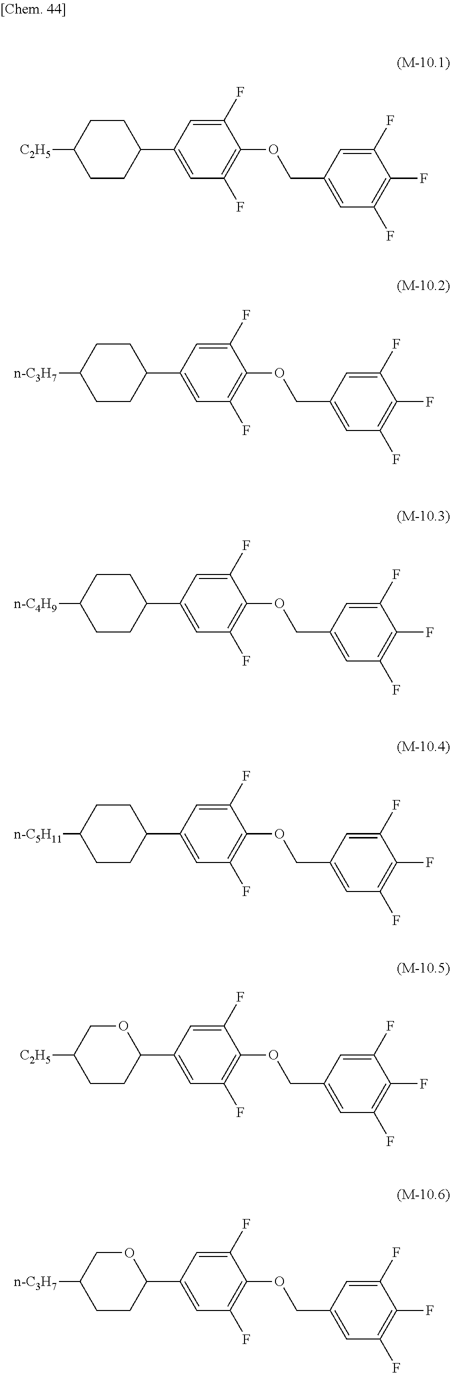

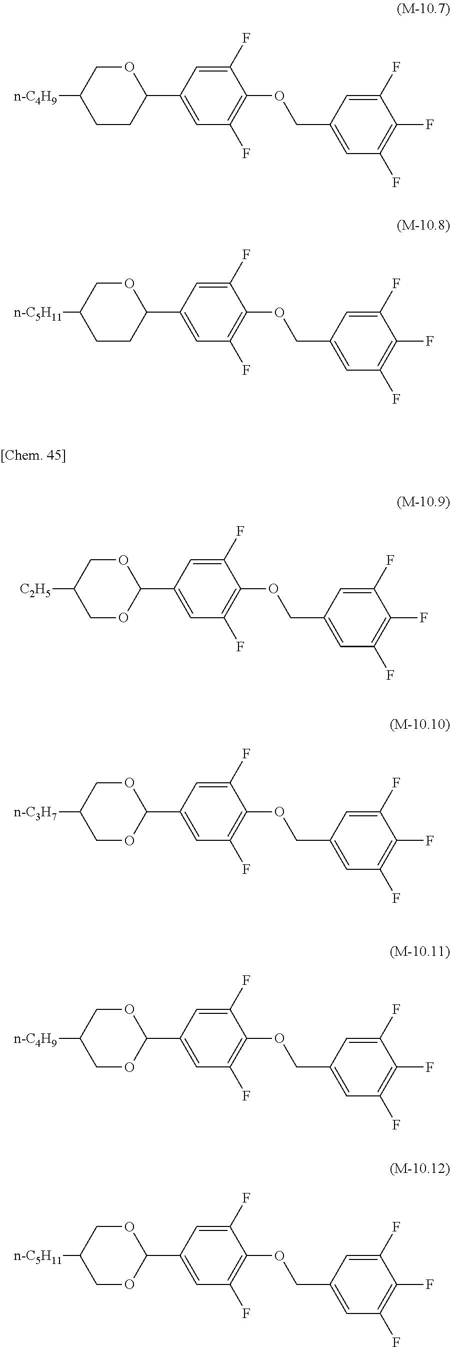

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-11) is as follows.

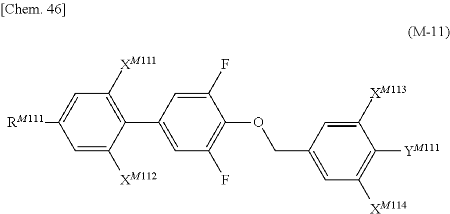

In the formula, X^{M111} to X^{M114} each independently represent a fluorine atom or a hydrogen atom, Y^{M111} represents a fluorine atom, a chlorine atom, or —OCF₃, R^{M111} represents an alkyl group having 1 to 5 carbon atoms, an alkenyl group having 2 to 5 carbon atoms, or an alkoxy group having 1 to 4 carbon atoms.

A lower limit of a preferable content of the compound represented by General Formula (M-11) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-11) used in the composition of the present invention, specifically, compounds represented by Formula (M-11.1) to Formula (M-11.8) are preferable, among the above, the compounds represented by Formula (M-11.1) to Formula (M-11.4) are preferably contained.

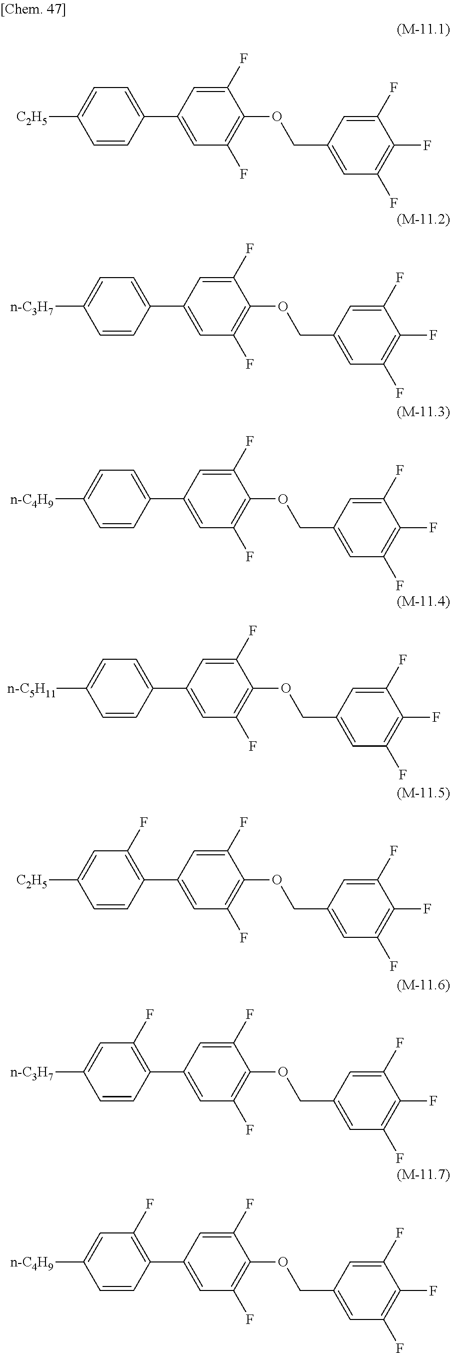

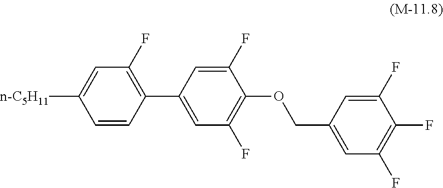

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-12) is as follows.

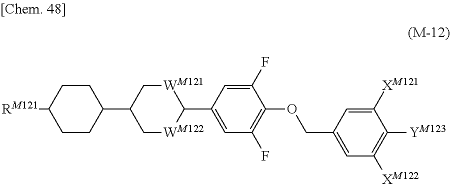

In the formula, X^{M121} and X^{M122} each independently represent a fluorine atom or a hydrogen atom, Y^{M121} represents a fluorine atom, a chlorine atom, or —OCF₃, R^{M121} represents an alkyl group having 1 to 5 carbon atoms, an alkenyl group having 2 to 5 carbon atoms, or an alkoxy group having 1 to 4 carbon atoms, and W^{M121} and W^{M122} each independently represent —CH₂— or —O—.

A lower limit of a preferable content of the compound represented by General Formula (M-12) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-12) used in the composition of the present invention, specifically, compounds represented by Formula (M-12.1) to Formula (M-12.12) are preferable, among the above, the compounds represented by Formula (M-12.5) to Formula (M-12.8) are preferably contained.

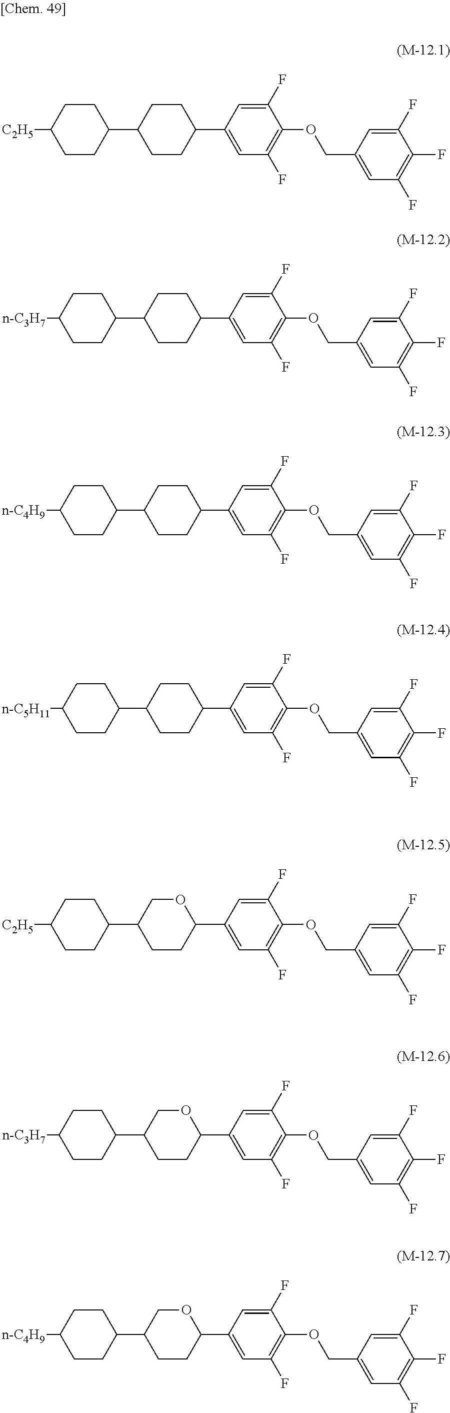

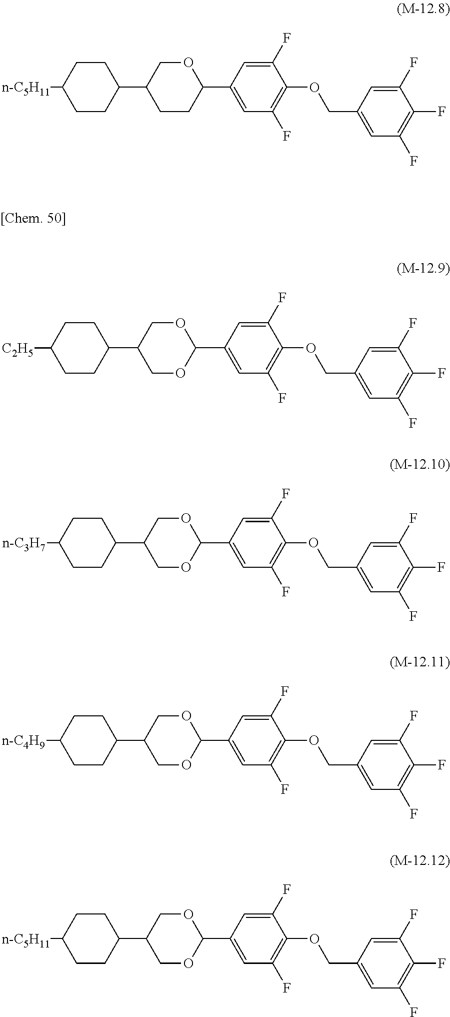

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-13) is as follows.

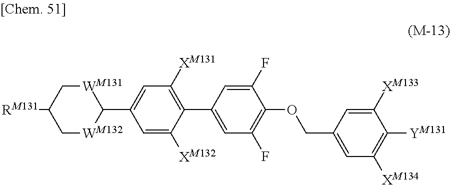

In the formula, X^{M131} to X^{M134} each independently represent a fluorine atom or a hydrogen atom, Y^{M131} represents a fluorine atom, a chlorine atom, or —OCF₃, R^{M131} represents an alkyl group having 1 to 5 carbon atoms, an alkenyl group having 2 to 5 carbon atoms, or an alkoxy group having 1 to 4 carbon atoms, and W^{M131} and W^{M132} each independently represent —CH₂— or —O—.

A lower limit of a preferable content of the compound represented by General Formula (M-13) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-13) used in the composition of the present invention, specifically, compounds represented by Formula (M-13.1) to Formula (M-13.28) are preferable, among the above, the compounds represented by Formulae (M-13.1) to (M-13.4), (M-13.11) to (M-13.14), and (M-13.25) to (M-13.28) are preferably contained.

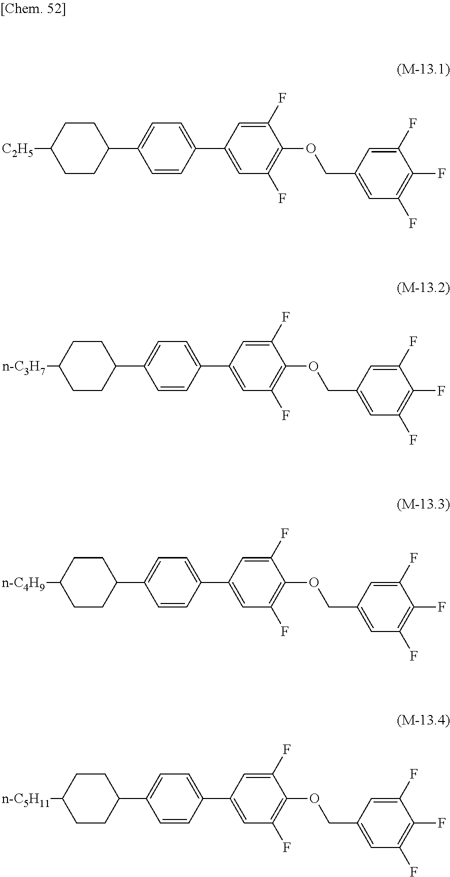

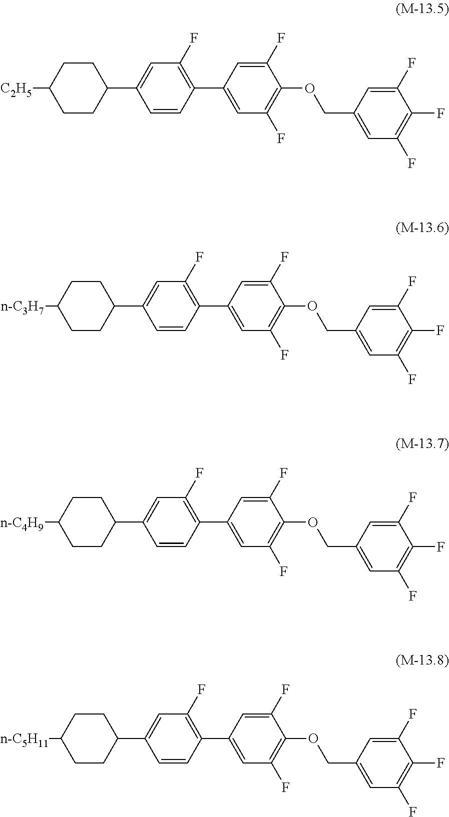

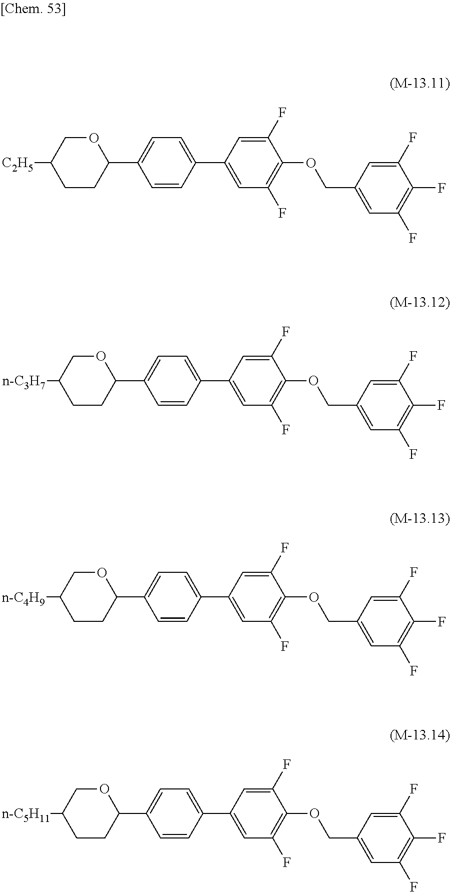

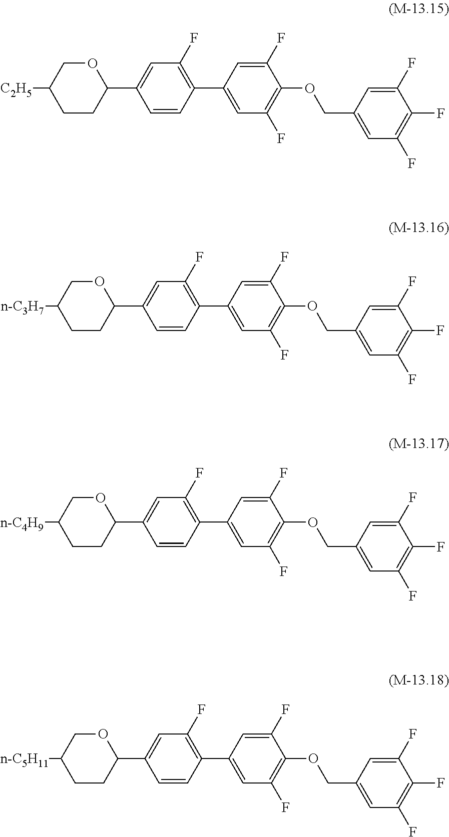

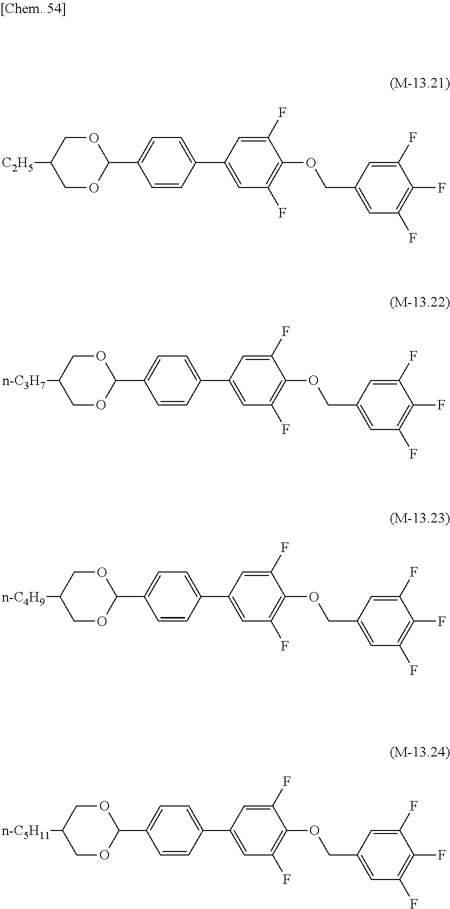

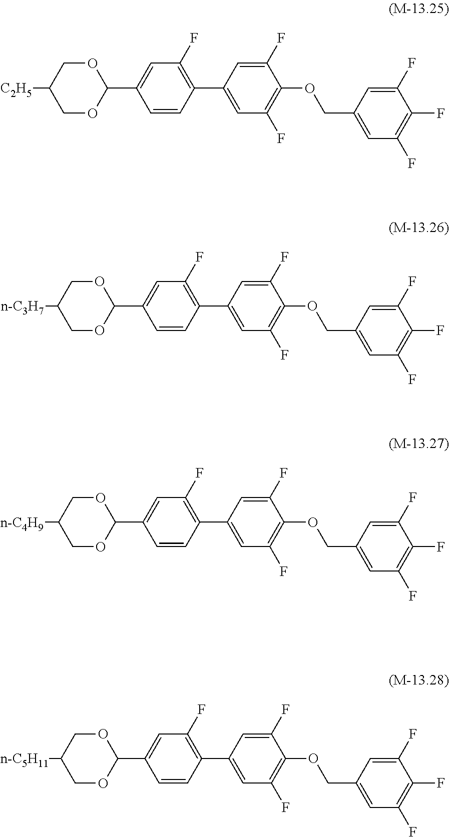

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-14) is as follows.

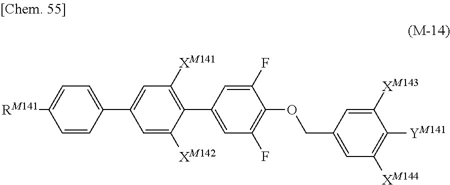

In the formula, X^{M141} to X^{M144} each independently represent a fluorine atom or a hydrogen atom, Y^{M141} represents a fluorine atom, a chlorine atom, or —OCF₃, R^{M141} represents an alkyl group having 1 to 5 carbon atoms, an alkenyl group having 2 to 5 carbon atoms, or an alkoxy group having 1 to 4 carbon atoms, and W⁴¹⁴ and W^{M142} each independently represent —CH₂— or —O—.

A lower limit of a preferable content of the compound represented by General Formula (M-14) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-14) used in the composition of the present invention, specifically, compounds represented by Formula (M-14.1) to Formula (M-14.8 are preferable, among the above, the compounds represented by Formula (M-14.5) and Formula (M-14.8) are preferably contained.

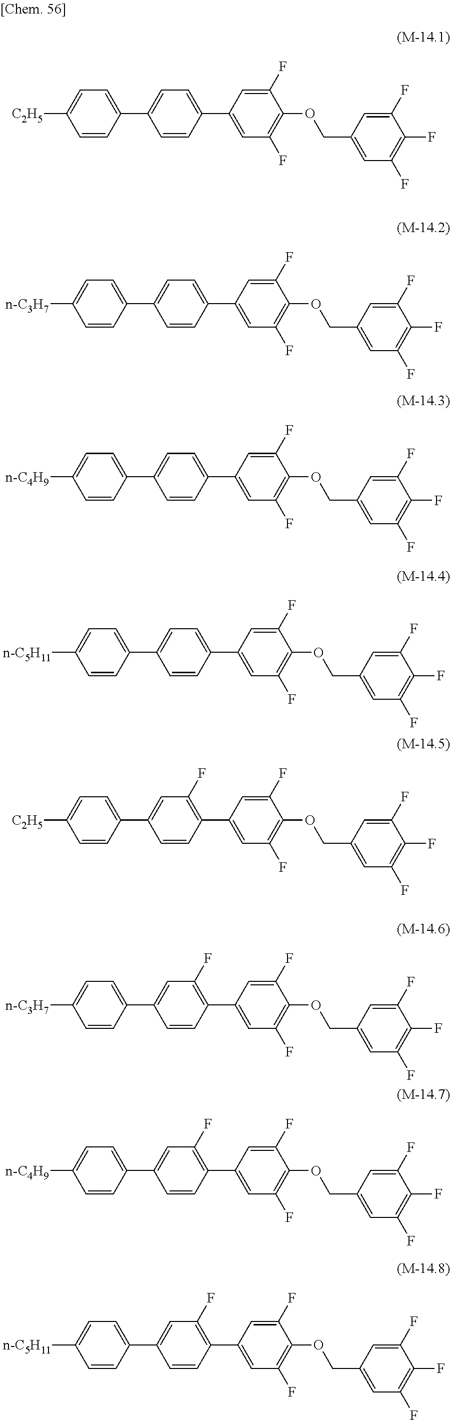

A lower limit a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-15) is as follows.

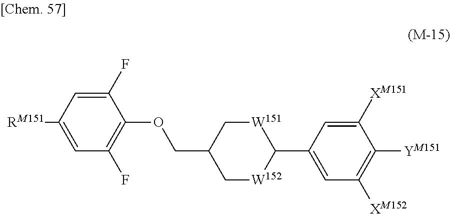

In the formula, X^{M151} and X^{M152} each independently represent a fluorine atom or a hydrogen atom, Y^{M151} represents a fluorine atom, a chlorine atom, or —OCF₃, R^{M151} represents an alkyl group having 1 to 5 carbon atoms, an alkenyl group having 2 to 5 carbon atoms, or an alkoxy group having 1 to 4 carbon atoms, and W^{M151} and W^{M152} each independently represent —CH₂— or —O—.

A lower limit of a preferable content of the compound represented by General Formula (M-15) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-15) used in the composition of the present invention, specifically, compounds represented by Formula (M-15.1) to Formula (M-15.14) are preferable, among the above, the compounds represented by Formula (M-15.5) to Formula (M-15.8), and Formula (M-15.11) to Formula (M-15.14) are preferably contained.

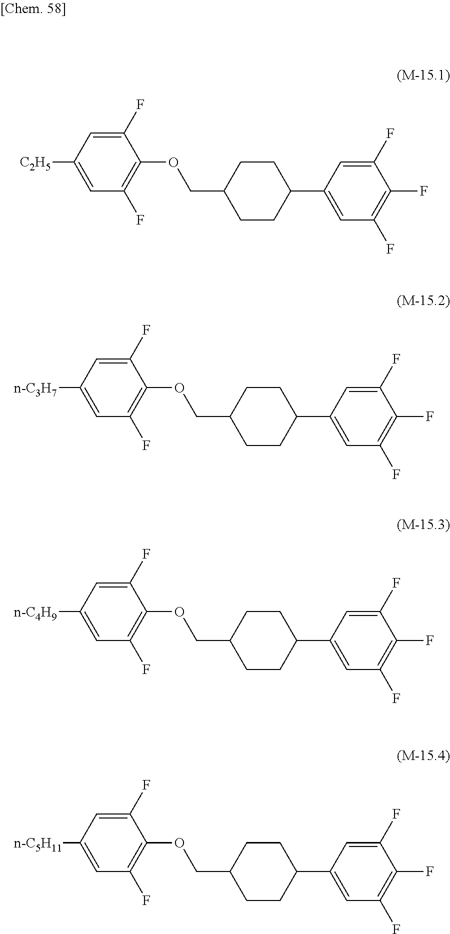

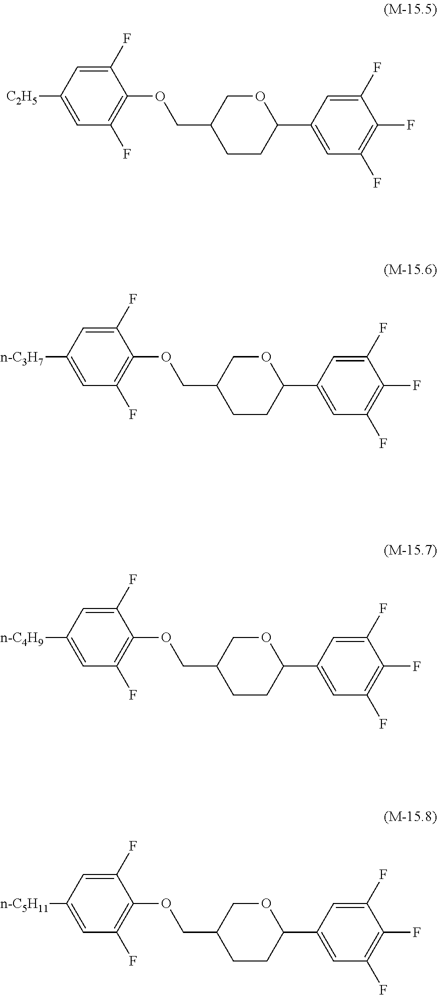

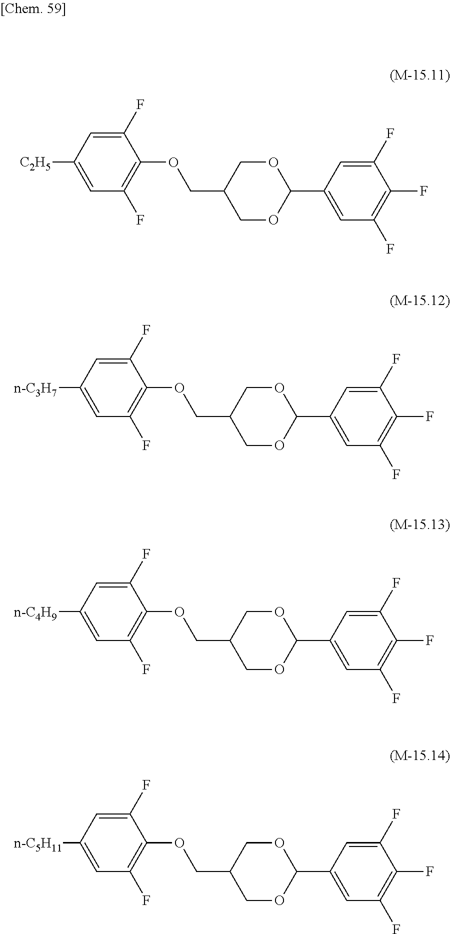

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-16) is as follows.

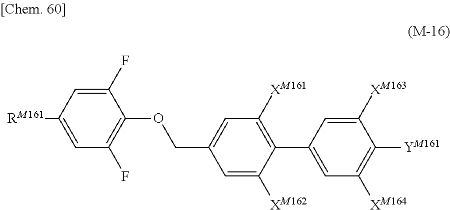

In the formula, X^{M161} to X^{M164} each independently represent a fluorine atom or a hydrogen atom, Y^{M161} represents a fluorine atom, a chlorine atom, or —OCF₃, and R^{M161} represents an alkyl group having 1 to 5 carbon atoms, an alkenyl group having 2 to 5 carbon atoms, or an alkoxy group having 1 to 4 carbon atoms.

A lower limit of a preferable content of the compound represented by General Formula (M-16) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-16) used in the composition of the present invention, specifically, compounds represented by Formula (M-16.1) to Formula (M-16.8) are preferable, among the above, the compounds represented by Formula (M-16.1) to Formula (M-16.4) are preferably contained.

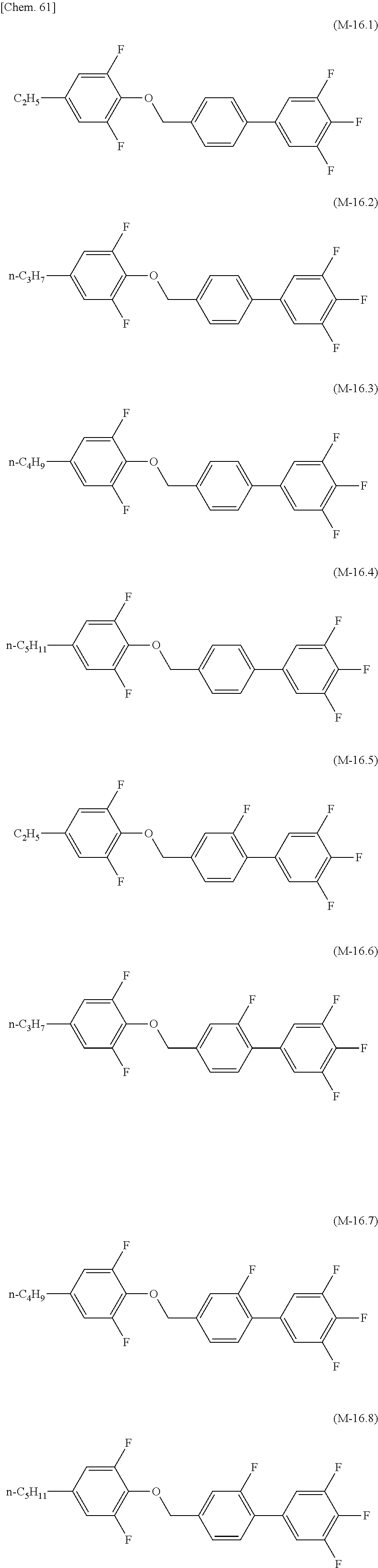

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-17) is as follows.

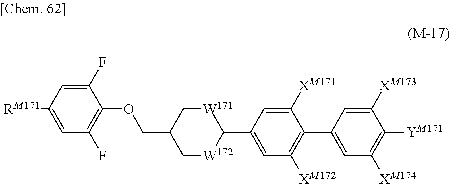

In the formula, X^{M171} to X^{M174} each independently represent a fluorine atom or a hydrogen atom, Y^{M171} represents a fluorine atom, a chlorine atom, or —OCF₃, R^{M171} represents an alkyl group having 1 to 5 carbon atoms, an alkenyl group having 2 to 5 carbon atoms, or an alkoxy group having 1 to 4 carbon atoms, and W^{M171} and W^{M172} each independently represent —CH₂— or —O—.

A lower limit of a preferable content of the compound represented by General Formula (M-17) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-17) used in the composition of the present invention, specifically, compounds represented by Formula (M-17.1) to Formula (M-17.52) are preferable, among the above, the compounds represented by Formula (M-17.9) to Formula (M-17.12), Formula (M-17.21) to Formula (M-17.28), and Formula (M-17.45) to Formula (M-17.48) are preferably contained.

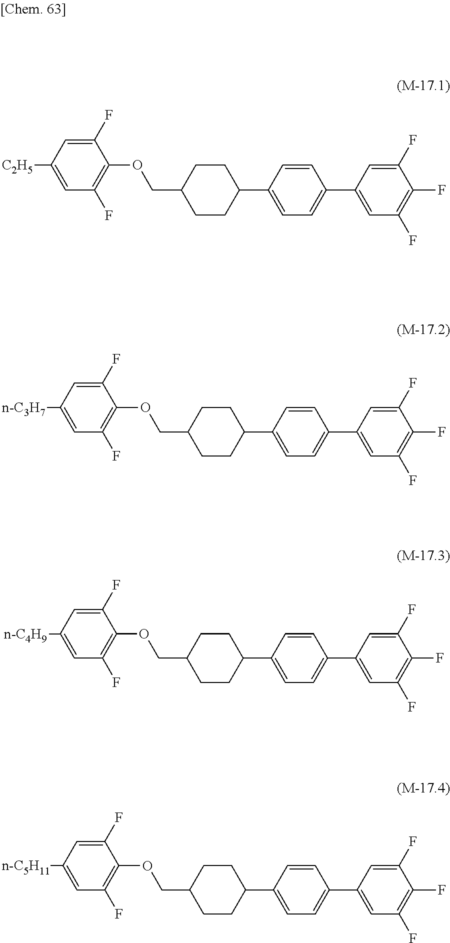

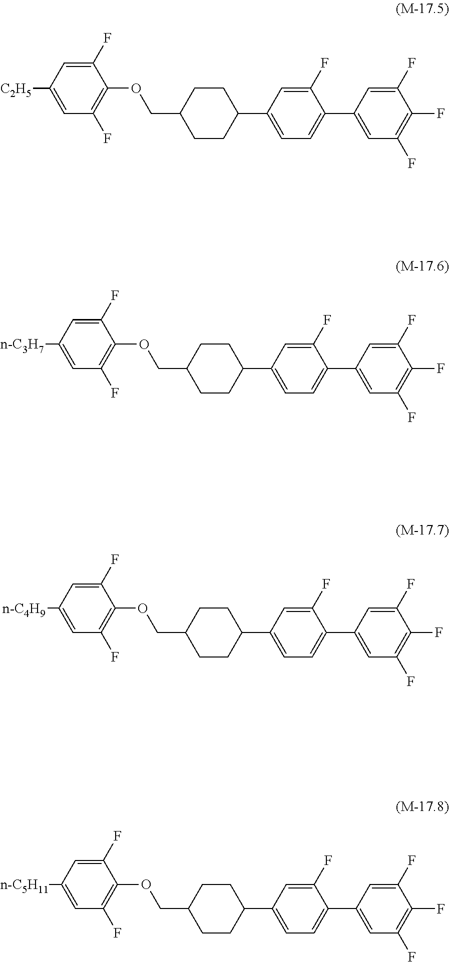

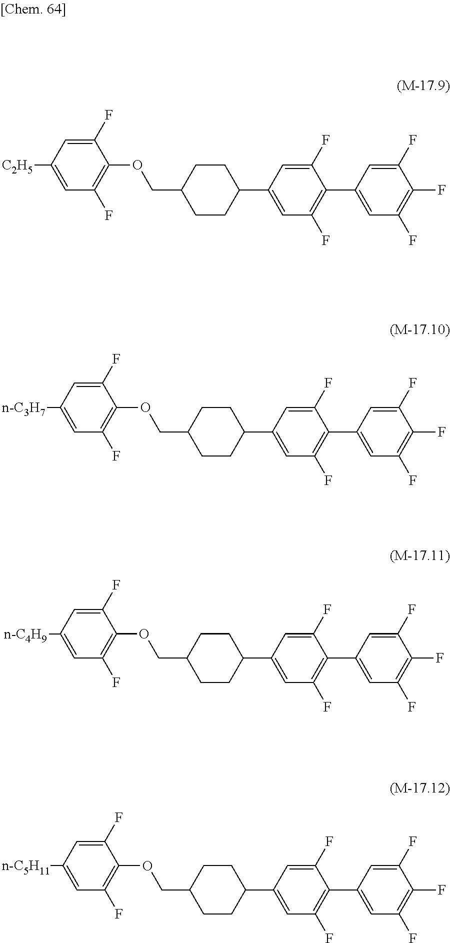

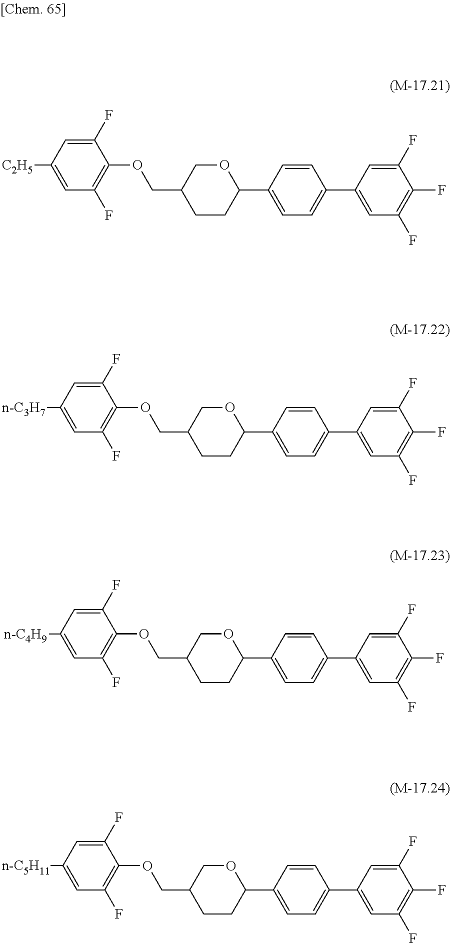

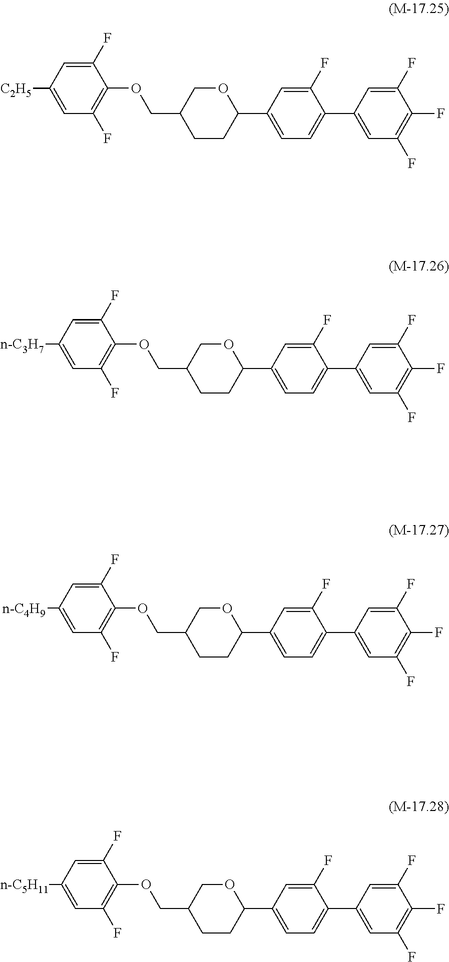

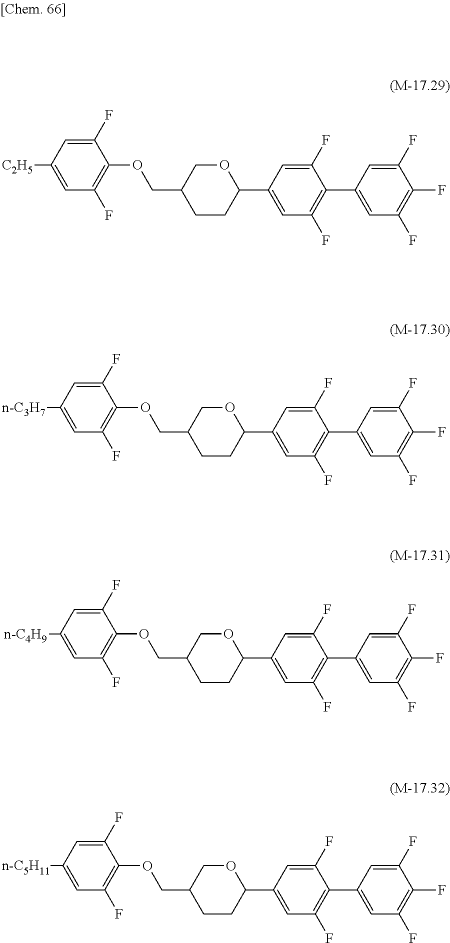

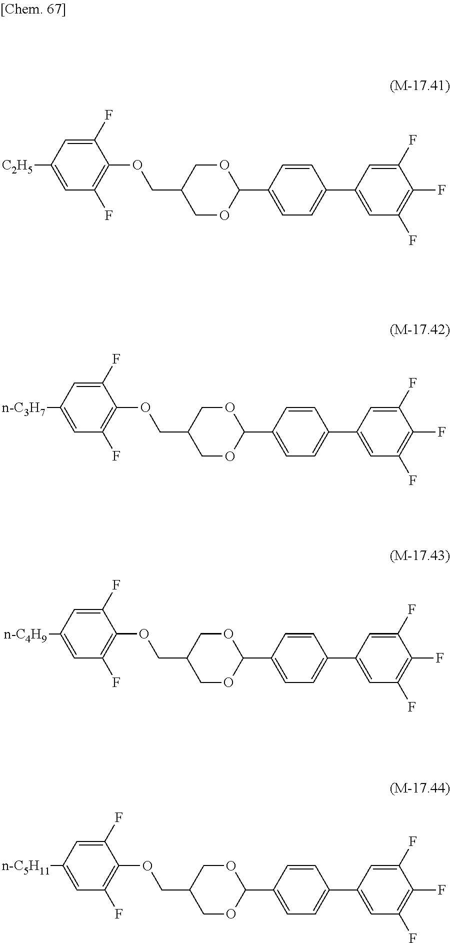

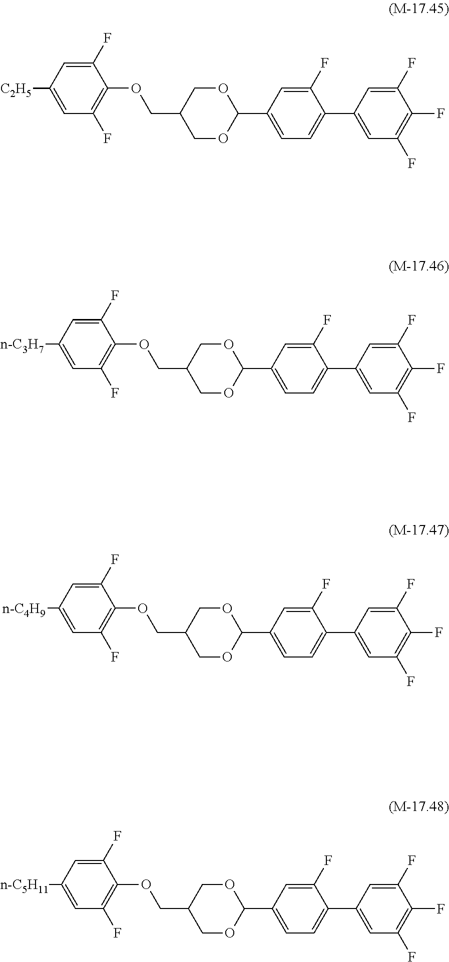

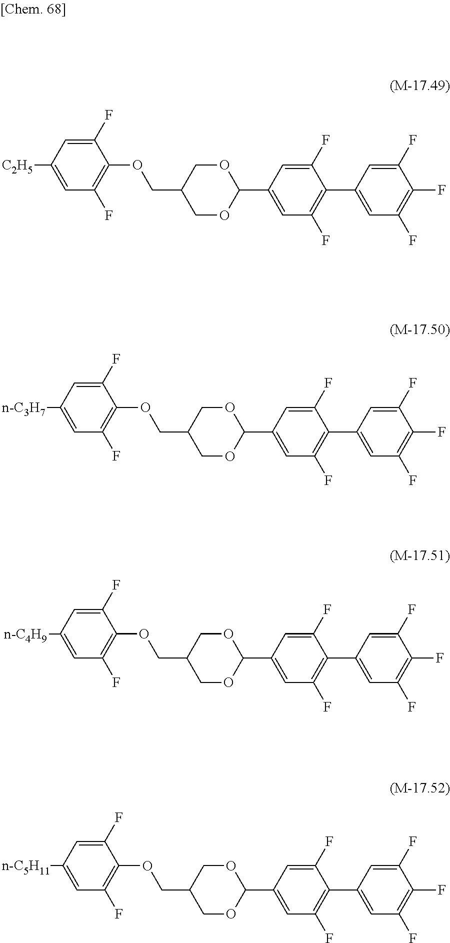

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The compound represented by General Formula (M-18) is as follows.

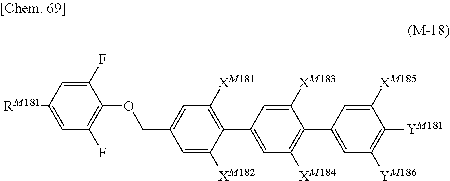

In the formula, X^{M181} to X^{M186} each independently represent a fluorine atom or a hydrogen atom, Y^{M181} represents a fluorine atom, a chlorine atom, or —OCF₃, and R^{M181} represents an alkyl group having 1 to 5 carbon atoms, an alkenyl group having 2 to 5 carbon atoms, or an alkoxy group having 1 to 4 carbon atoms.

A lower limit of a preferable content of the compound represented by General Formula (M-18) with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in the case where a composition in which burn-in hardly occurs is required, the lower limit is preferably low, and the upper limit is preferably low. In addition, when the dielectric anisotropy is needed to be increased in order to maintain low driving voltage, the lower limit is preferably high, and the upper limit is preferably high.

Further, as the compound represented by General Formula (M-18) used in the composition of the present invention, specifically, compounds represented by Formula (M-18.1) to Formula (M-18.12) are preferable, among the above, the compounds represented by Formula (M-18.5) to Formula (M-18.8) are preferably contained.

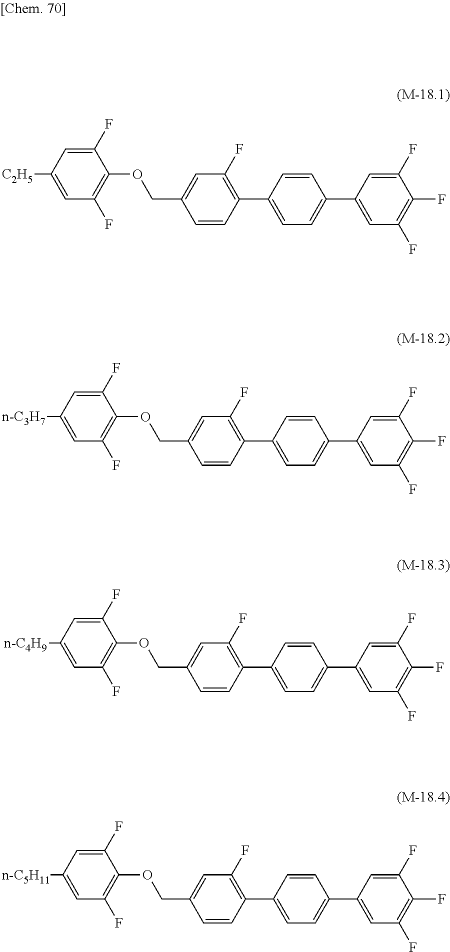

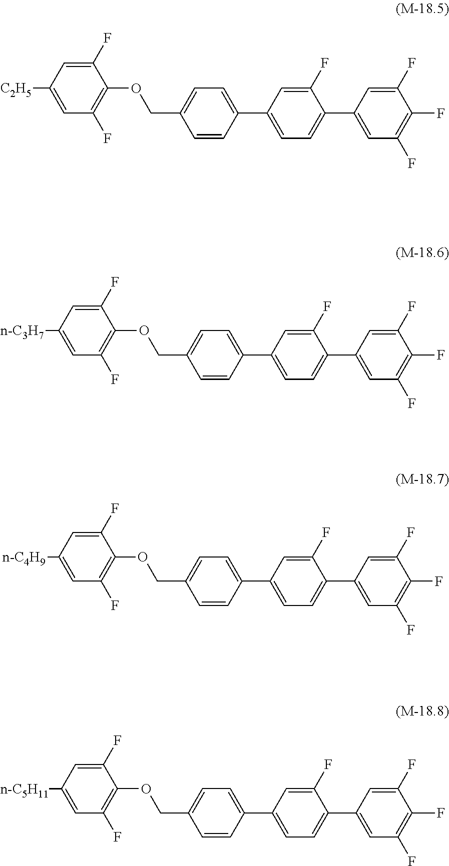

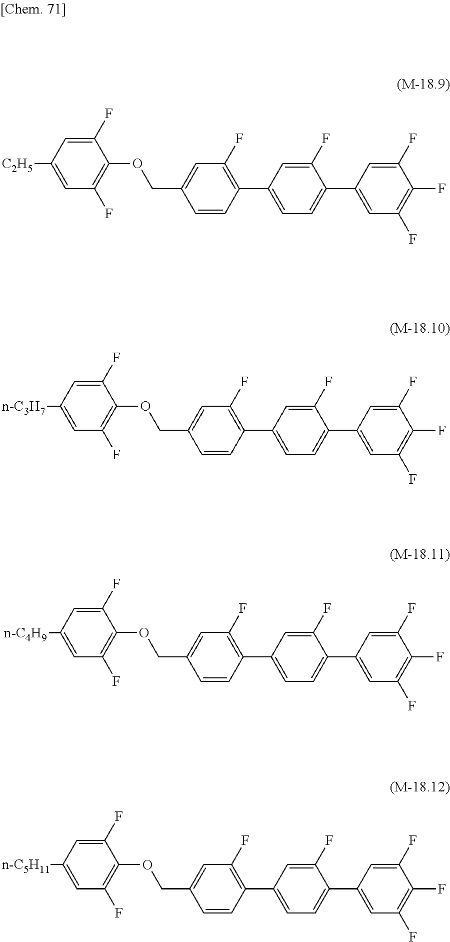

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The composition of the present invention preferably contains one or more kinds of compounds represented by General Formula (K). These compounds correspond to dielectrically positive compounds (Δε is greater than 2).

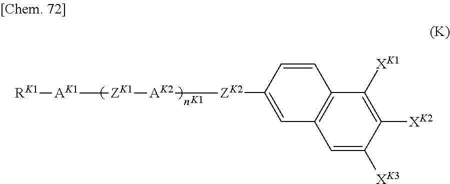

In the formula, R^{K1} represents an alkyl group having 1 to 8 carbon atoms, one or more non-adjacent —CH₂—'s in the alkyl group each independently may be substituted with —CH═CH—, —C≡C—, —O—, —CO—, —COO—, or —OCO—, n^{K1} represents 0, 1, 2, 3, or 4, A^{K1} and A^{K2} each independently represent a group selected from the group consisting of (a) a 1,4-cyclohexylene group (one —CH₂— or two or more non-adjacent —CH₂—'s existing in the group may be substituted with —O— or —S—) and (b) a 1,4-phenylene group (one —CH═ or two or more non-adjacent —CH═'s existing in this group may be substituted with —N═), the hydrogen atoms on the group (a) and group (b) each independently may be substituted with a cyano group, a fluorine atom, or a chlorine atom, Z^{K1} and Z^{K2} each independently represent a single bond, —CH₂CH₂—, —(CH₂)₄—, —OCH₂—, —CH₂O—, —OCF₂—, —CF₂O—, —COO—, —OCO—, or —C≡C—, in a case where n^{K1} is 2, 3, or 4 and a plurality of A^{K2}'s exist, the plurality of A^{K2}'s may be the same as or different from each other, in a case where n^{K1} is 2, 3, or 4 and a plurality of Z^{K1}'s exist, the plurality of Z^{K1}'s may be the same as or different from each other, X^{K1} and X^{K3} each independently a hydrogen atom, a chlorine atom, or a fluorine atom, X^{K2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.

In General Formula (K), R^{K1} preferably represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, is further preferably an alkyl group having 1 to 5 carbon atoms or an alkenyl group having 2 to 5 carbon atoms, further preferably represents an alkyl group having 2 to 5 carbon atoms or an alkenyl group having 2 to 3 carbon atoms, and particularly preferably represents an alkenyl group (a propenyl group) having 3 carbon atoms.

In a case of putting importance on the reliability, R^{K1} is preferably an alkyl group, and in a case of putting importance on the low viscosity, R^{K1} is preferably an alkenyl group.

In a case where a ring structure to which R^{K1} is bonded is a phenyl group (aromatic group), R^{K1} is preferably a linear alkyl group having 1 to 5 carbon atoms, a linear alkoxy group having 1 to 4 carbon atoms, and an alkenyl group having 4 to 5 carbon atoms, and in a case where a ring structure to which R^{K1} is bonded is a saturated ring structure such as cyclohexane, pyran, and dioxane, R^{K1} is preferably a linear alkyl group having 1 to 5 carbon atoms, a linear alkoxy group having 1 to 4 carbon atoms, and a linear alkenyl group having 2 to 5 carbon atoms. In order to stabilize the nematic phase, it is preferable that the total oxygen atom is 5 or less in a case where the carbon atom exists, and it is preferably in a linear shape.

As an alkenyl group, it is preferably selected from the group represented by any one of Formula (R1) to Formula (R5) (the black dot in each formula represents a carbon atom in the ring structure to which the alkenyl group is bonded).

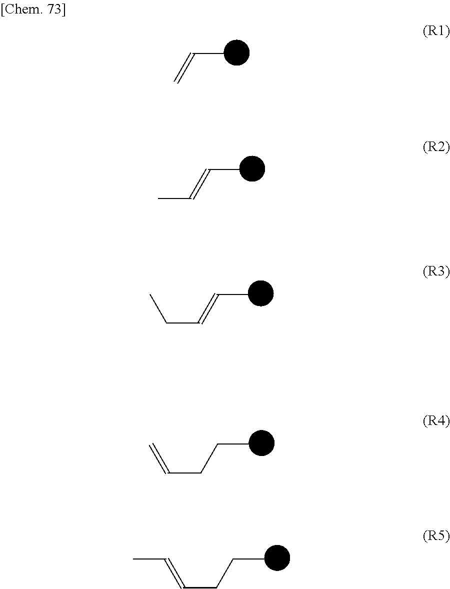

A^{K1} and A^{K2} each independently are preferably aromatic in a case where Δn is required to be increased, are preferably aliphatic in order to improve the response speed, preferably represent a trans-1,4-cyclohexylene group, a 1,4-phenylene group, a 2-fluoro-1,4-phenylene group, a 3-fluoro-1,4-phenylene group, a 3, 5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and further preferably represent the following structure.

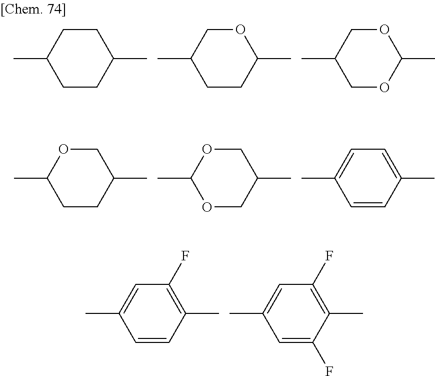

It is further preferable that A^{K1} and A^{K2} each independently represent the following structure.

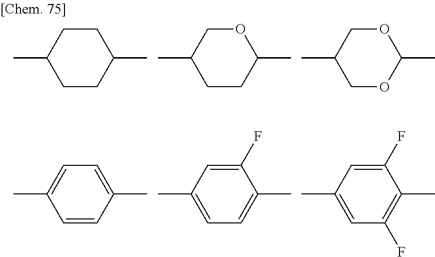

Z^{K1} and Z^{K2} each independently preferably represent —CH₂O—, —CF₂O—, —CH₂CH₂—, —CF₂CF₂— or a single bond, further preferably represent —CF₂O—, —CH₂CH₂— or a single bond, and particularly preferably represent —CF₂O— or a single bond.

n^{K1} is preferably 0, 1, 2, or 3, is preferably 0, 1, or 2, in a case of putting importance on improving Δε, 0 or 1 is preferable, and in a case where emphasis is placed on Tni, 1 or 2 is preferable.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 for one embodiment of the present invention. Further, in another embodiment of the present invention, the number of the types of the compounds to be used is 4, 5, 6, or 7 or more.

In the composition of the present invention, it is necessary that the content of the compound represented by General Formula (K) is appropriately adjusted according to the required performances such as solubility at low temperature, transition temperature, electrical reliability, birefringence, process adaptability, drop marks, burn-in, and dielectric anisotropy.

A lower limit of a preferable content of the compound represented by Formula (K) with respect to a total amount of the composition of the present invention is 1%, 10%, 20%, 30%, 40%, 50%, 55%, 60%, 65%, 70%, 75%, or 80%. An upper limit of the preferable content with respect to a total amount of the composition of the present invention is 95%, 85%, 75%, 65%, 55%, 45%, 35%, or 25% in one embodiment of the present invention, for example.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

For example, the compound represented by General Formula (K) is preferably a compound selected from the compound group represented by General Formula (K-1).

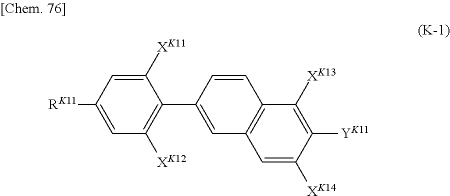

In the formula, R^{K11} represents an alkyl group having 1 to 5 carbon atoms, an alkenyl group having 2 to 5 carbon atoms, or an alkoxy group having 1 to 4 carbon atoms, X^{K11} to X^{K14} each independently represent a hydrogen atom or a fluorine atom, and Y^{K11} represents a fluorine atom or OCF₃.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 or more for one embodiment of the present invention.

A lower limit of a preferable content of the compound represented by Formula (K-1) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

Specifically, the compound represented by General Formula (K-1) is preferably compounds represented by Formula (K-1.1) to Formula (K-1.4), is preferably the compound represented by Formula (K-1.1) or Formula (K-1.2), and is further preferably the compound represented by Formula (K-1.2). In addition, it is preferable to use the compound represented by Formula (K-1.1) and the compound represented by Formula (K-1.2) at the same time.

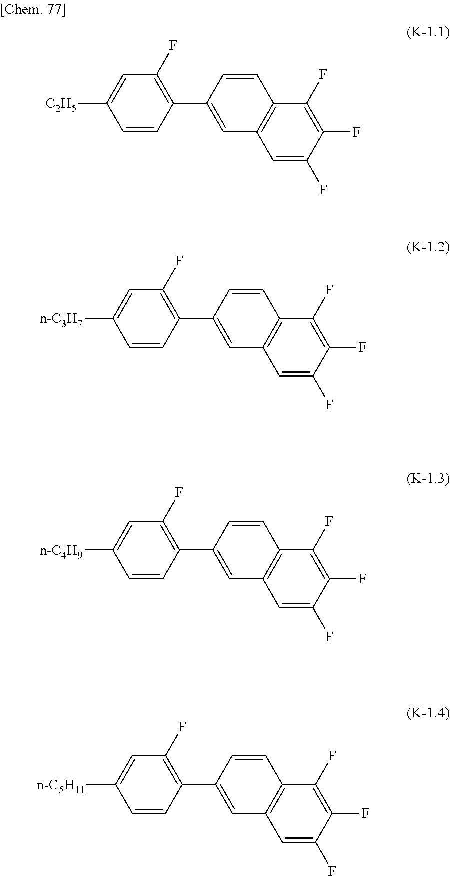

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

For example, the compound represented by General Formula (K) is preferably a compound selected from the compound group represented by General Formula (K-2).

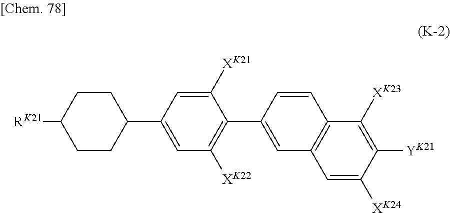

In the formula, R^{K21} represents an alkyl group having 1 to 5 carbon atoms, an alkenyl group having 2 to 5 carbon atoms, or an alkoxy group having 1 to 4 carbon atoms, X^{K21} to X^{K24} each independently represent a hydrogen atom or a fluorine atom, and Y^{K21} represents a fluorine atom or OCF₃.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 or more for one embodiment of the present invention.

A lower limit of a preferable content of the compound represented by Formula (K-2) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

Specifically, the compound represented by General Formula (K-2) is preferably compounds represented by Formula (K-2.1) to Formula (K-2.8), is preferably the compound represented by Formula (K-2.5) or Formula (K-2.6), and is further preferably the compound represented by Formula (K-2.6). In addition, it is preferable to use the compound represented by Formula (K-2.5) and the compound represented by Formula (K-2.6) at the same time.

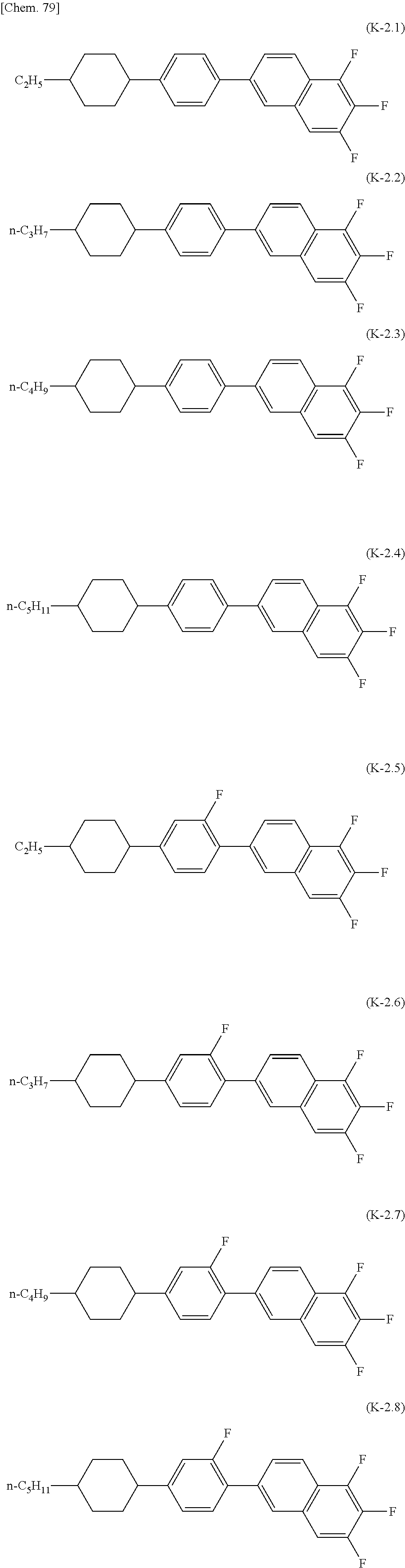

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

For example, the compound represented by General Formula (K) is preferably a compound selected from the compound group represented by General Formula (K-3).

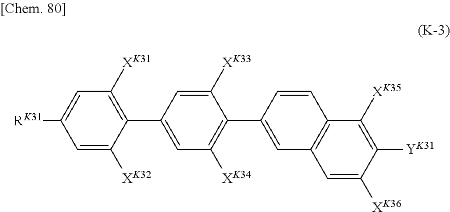

In the formula, R^{K31} represents an alkyl group having 1 to 5 carbon atoms, an alkenyl group having 2 to 5 carbon atoms, or an alkoxy group having 1 to 4 carbon atoms, X^{K31} to X^{K36} each independently represent a hydrogen atom or a fluorine atom, and Y^{K31} represents a fluorine atom or OCF₃.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 or more for one embodiment of the present invention.

A lower limit of a preferable content of the compound represented by Formula (K-3) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

Specifically, the compound represented by General Formula (K-3) is preferably compounds represented by Formula (K-3.1) to Formula (K-3.4), is preferably the compound represented by Formula (K-3.1) or Formula (K-3.2). In addition, it is preferable to use the compound represented by Formula (K-3.1) and the compound represented by Formula (K-3.2) at the same time.

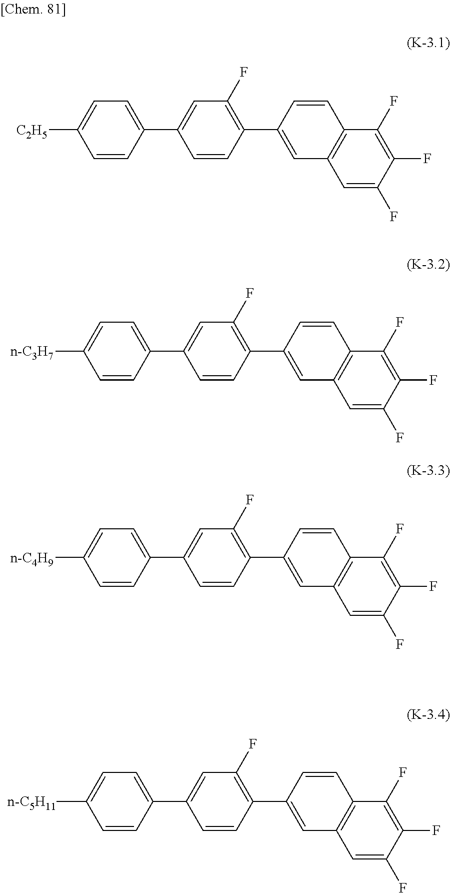

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

For example, the compound represented by General Formula (K) is preferably a compound selected from the compound group represented by General Formula (K-4).

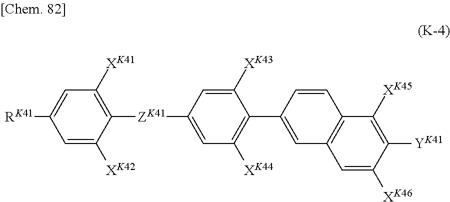

In the formula, R^{K41} represents an alkyl group having 1 to 5 carbon atoms, an alkenyl group having 2 to 5 carbon atoms, or an alkoxy group having 1 to 4 carbon atoms, X^{K41} to X^{K46} each independently represent a hydrogen atom or a fluorine atom, Y^{K41} represents a fluorine atom or OCF₃, and Z^{K41} represents —OCH₂—, —CH₂O—, —OCF₂—, or —CF₂O—.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 or more for one embodiment of the present invention.

A lower limit of a preferable content of the compound represented by General Formula (K-4) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

Specifically, the compound represented by General Formula (K-4) is preferably compounds represented by Formula (K-4.1) to Formula (K-4.18), is preferably the compounds represented by Formula (K-4.1), Formula (K-4.2), Formula (K-4.11), and Formula (K-4.12). In addition, it is preferable to use the compounds represented by Formula (K-4.1), Formula (K-4.2), Formula (K-4.11), and Formula (K-4.12) at the same time.

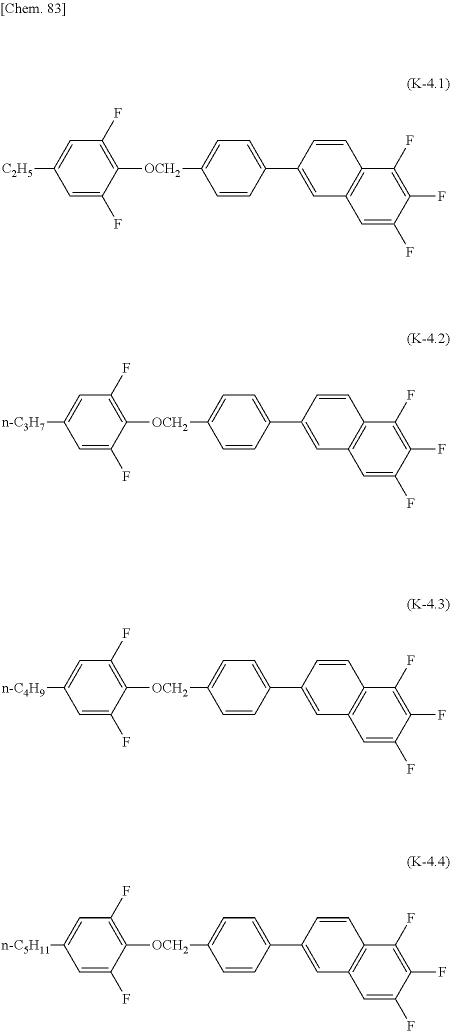

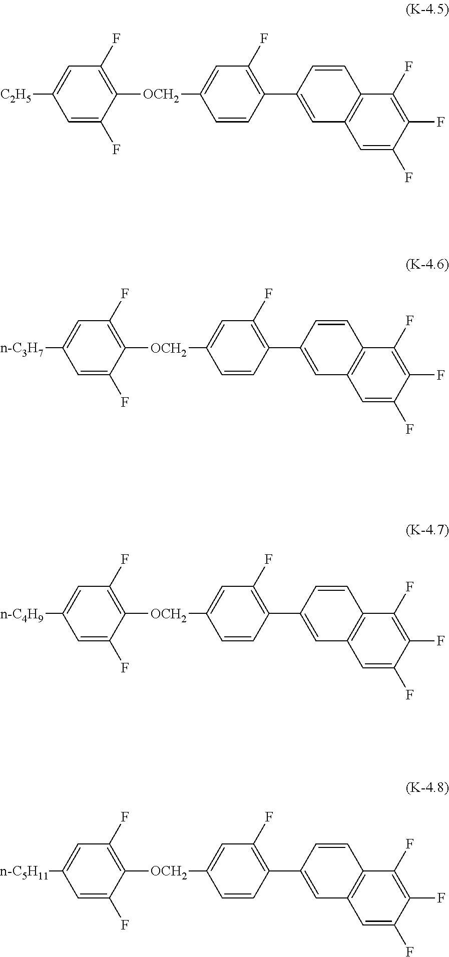

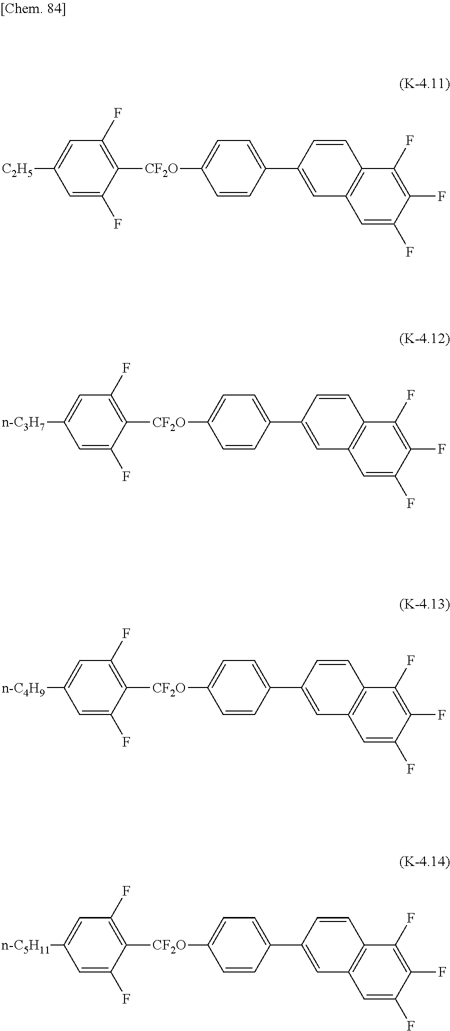

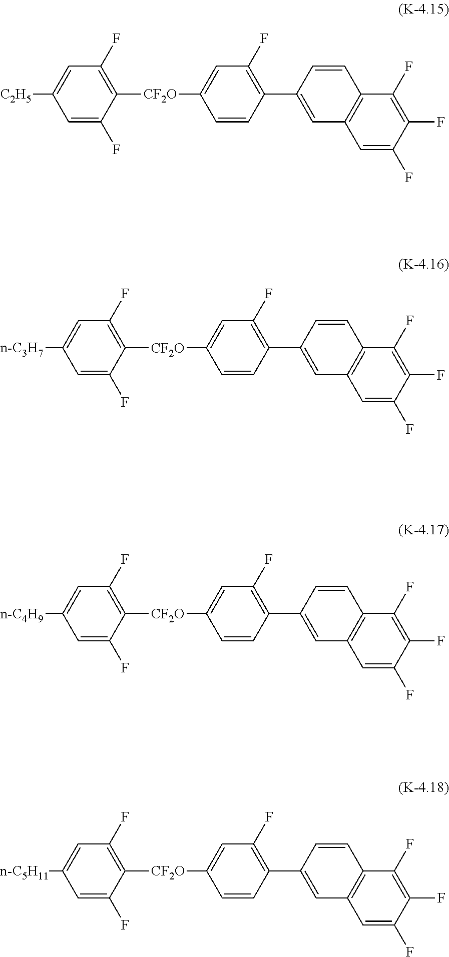

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

For example, the compound represented by General Formula (K) is preferably a compound selected from the compound group represented by General Formula (K-5).

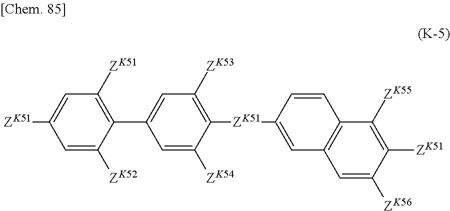

In the formula, R^{K51} represents an alkyl group having 1 to 5 carbon atoms, an alkenyl group having 2 to 5 carbon atoms, or an alkoxy group having 1 to 4 carbon atoms, X^{K51} to X^{K56} each independently represent a hydrogen atom or a fluorine atom, Y^{K51} represents a fluorine atom or OCF₃, and Z^{K51} represents —OCH₂—, —CH₂O—, —OCF₂—, or —CF₂O—.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 or more for one embodiment of the present invention.

A lower limit of a preferable content of the compound represented by Formula (K-5) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

Specifically, the compound represented by General Formula (K-5) is preferably compounds represented by Formula (K-5.1) to Formula (K-5.18), is further preferably the compounds represented by Formula (K-5.11) to Formula (K-5.14), and is still further preferably the compound represented by Formula (K-5.12).

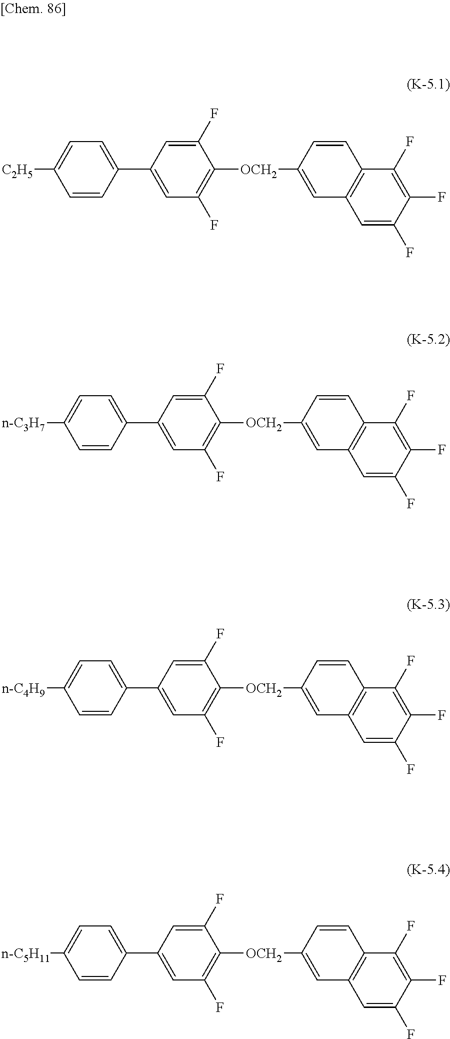

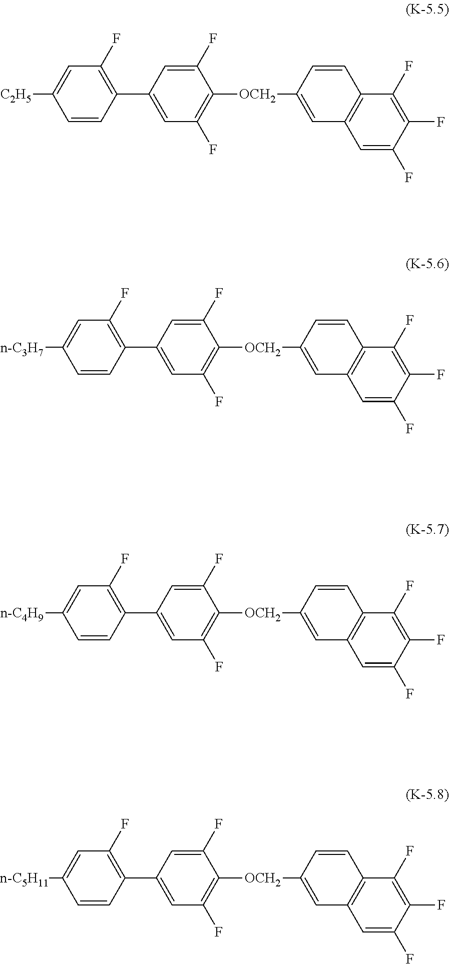

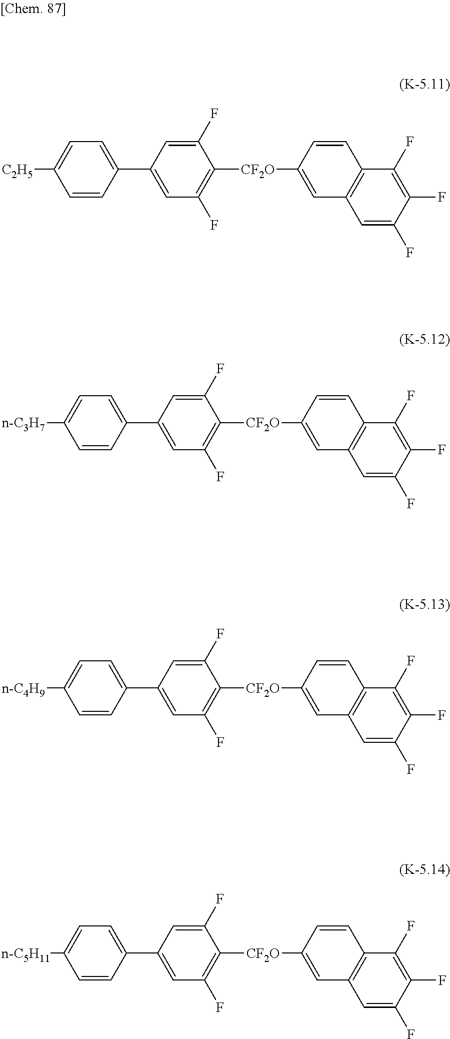

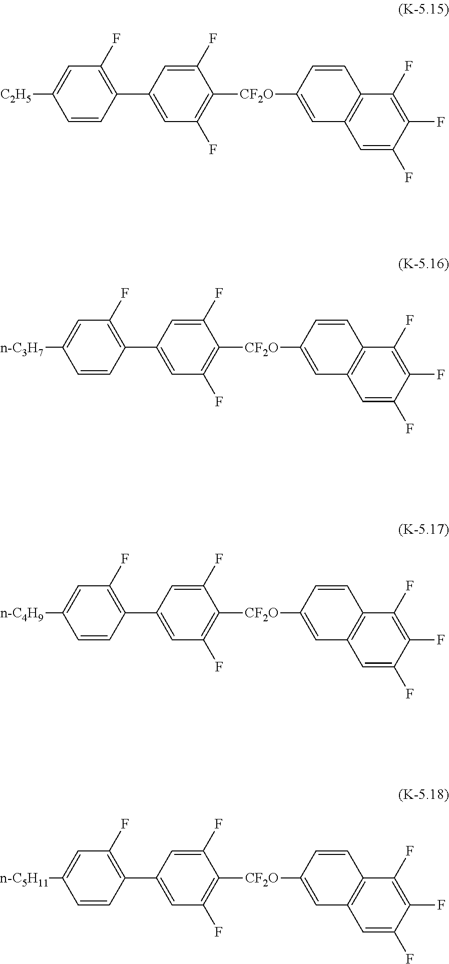

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

For example, the compound represented by General Formula (K) is preferably a compound selected from the compound group represented by General Formula (K-6).

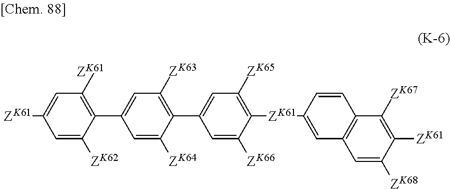

In the formula, Rⁱ⁶¹ represents an alkyl group having 1 to 5 carbon atoms, an alkenyl group having 2 to 5 carbon atoms, or an alkoxy group having 1 to 4 carbon atoms, X^{K61} to X^{K68} each independently represent a hydrogen atom or a fluorine atom, Y^{K61} represents a fluorine atom or OCF₃, and Z^{K61} represents —OCH₂—, —CH₂O—, —OCF₂— or —CF₂O—.

A type of the compound which can be combined is not particularly limited, and the compound is combined according to the required performances such as solubility at low temperature, transition temperature, electrical reliability, and birefringence. The number of the types of the compounds to be used is, for example, 1, 2, or 3 or more for one embodiment of the present invention.

A lower limit of a preferable content of the compound represented by Formula (K-6) with respect to a total amount of the composition of the present invention is 1%, 2%, 5%, 8%, 10%, 13%, 15%, 18%, 20%, 22%, 25%, or 30%. An upper limit of the preferable content is 30%, 28%, 25%, 23%, 20%, 18%, 15%, 13%, 10%, 8%, or 5%.

In a case where a composition having a high response speed is needed, while maintaining low viscosity of the composition of the present invention, the lower limit is preferably low, and the upper limit is preferably low. Further, in a case where the composition having excellent temperature stability is needed, while maintaining high Tni of the composition of the present invention, the lower limit is preferably low, and the upper limit is preferably low. In addition, when the dielectric anisotropy is needed to be increased in order to maintain low driving voltage, the lower limit is preferably high, and the upper limit is preferably high.

Specifically, the compound represented by General Formula (K-6) is preferably compounds represented by Formula (K-6.1) to Formula (K-6.18), is preferably the compounds represented by Formula (K-6.15) to Formula (K-6.18), and is further preferably the compounds represented by Formula (K-6.16) and Formula (K-6.17). In addition, it is preferable to use the compounds represented by Formula (K-6.16) and Formula (K-6.17) at the same time.

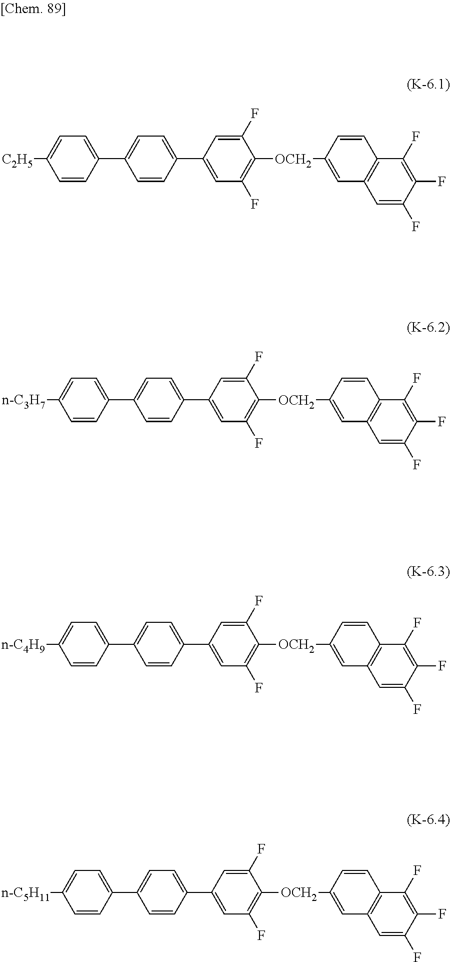

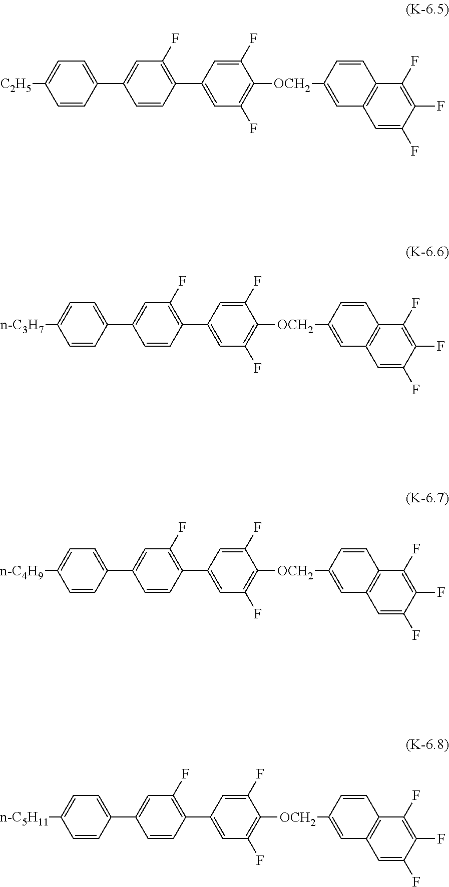

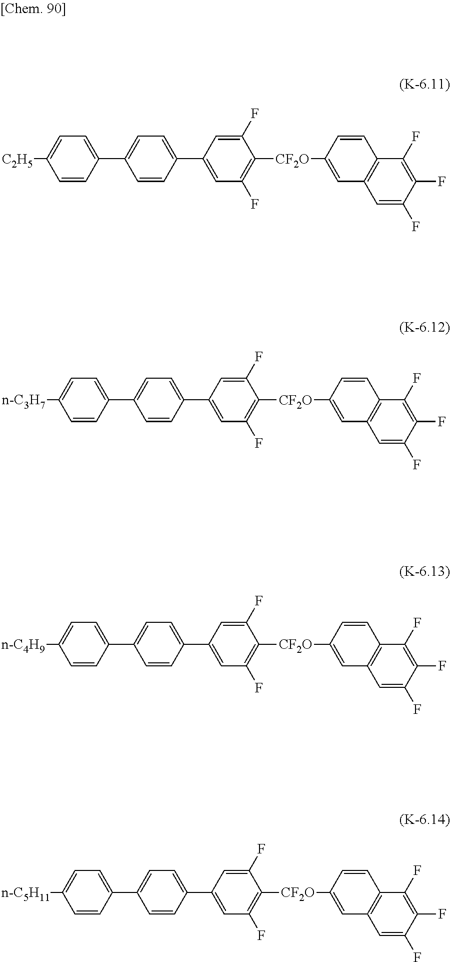

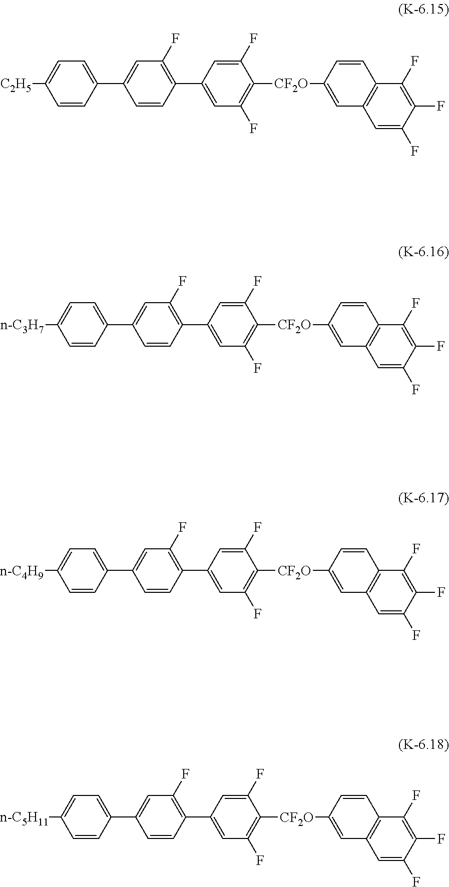

A lower limit of a preferable content of these compounds with respect to a total amount of the composition of the present invention is 1%, 2%, 4%, 5%, 8%, 10%, 13%, 15%, 18%, or 20%. An upper limit of the preferable content is 30%, 28%, 25%, 23%, 20%, 18%, 15%, 13%, 10%, 8%, or 5%.

The composition of the present invention preferably contains one or more kinds of compounds represented by General Formula (L). The compound represented by General Formula (L) is a nearly neutral compound (the value of Δε is from −2 to 2) in a dielectric manner.

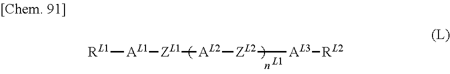

In the formula, R^{L1} and R^{L2} each independently represent an alkyl group having 1 to 8 carbon atoms, one or more non-adjacent —CH₂—'s in the alkyl group each independently may be substituted with —CH═CH—, —C≡C—, —O—, —CO—, —COO—, or —OCO—, n^{L1} represents 0, 1, 2, or 3, A^{L1}, A^{L2}, and A^{L3} each independently represent a group selected from the group consisting of (a) a 1,4-cyclohexylene group (one —CH₂— or two or more non-adjacent —CH₂—'s existing in this group may be substituted with —O—), (b) a 1,4-phenylene group (one —CH═ or two or more non-adjacent —CH═'s existing in this group may be substituted with —N═), and (c) a naphthalene-2,6-diyl group, a 1,2,3,4-tetrahydronaphthalene-2,6-diyl group, or a decahydronaphthalene-2,6-diyl group (one —CH═ or two or more non-adjacent —CH═'s existing in a naphthalene-2,6-diyl group or a 1,2,3,4-tetrahydronaphthalene-2,6-diyl group may be substituted with —N═), and the group (a), the group (b), and the group (c) each independently may be substituted with a cyano group, fluorine atom, or a chlorine atom, Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—, in a case where n^{L1} is 2 or 3, and a plurality of A^{L2}'s exist, the plurality of A^{L2}'s may be the same as or different from each other, and in a case where n^{L1} is 2 or 3, and a plurality of Z^{L2}'s exist, the plurality of Z^{L2}'s may be the same as or different from each other, provided that compounds represented by General Formulae (i), (ii), and (J) are excluded.

The compound represented by General Formula (L) may be used singly, or in combination. A type of the compound which can be combined is not particularly limited, and the compound is used in combination according to desired performances such as solubility at low temperature, transition temperature, electrical reliability, and birefringence. The number of the types of the compounds to be used is, for example, 1 for one embodiment of the present invention. Alternatively, in another embodiment of the present invention, the number of the types of the compounds to be used is 2, 3, 4, 5, 6, 7, 8, 9, or 10 or more.

In the composition of the present invention, it is necessary that the content of the compound represented by Formula (L-1-2.2) and the compound represented by General Formula (L) is appropriately adjusted according to the required performances such as solubility at low temperature, transition temperature, electrical reliability, birefringence, process adaptability, drop marks, burn-in, and dielectric anisotropy.

A lower limit of a preferable content of the compound represented by Formula (L-1-2.2) and compound represented by General Formula (L) with respect to a total amount of the composition of the present invention is 1%, 10%, 20%, 30%, 40%, 50%, 55%, 60%, 65%, 70%, 75%, or 80%. An upper limit of the preferable content is 95%, 85%, 75%, 65%, 55%, 45%, 35%, or 25%.

In a case where a composition having a high response speed is needed, while maintaining low viscosity of the composition of the present invention, the lower limit is preferably high, and the upper limit is preferably high. Further, in a case where a composition having excellent temperature stability is needed, while maintaining high Tni of the composition of the present invention, the lower limit is preferably high, and the upper limit is preferably high. In addition, when the dielectric anisotropy is needed to be increased in order to maintain low driving voltage, the lower limit is preferably low, and the upper limit is preferably low.

In a case of putting importance on the reliability, both R^{L1} and R^{L2} are preferably an alkyl group, in a case of putting importance on reducing the volatility of the compound, R^{L1} and R^{L2} are preferably an alkoxy group, and in a case of putting importance on the low viscosity, at least one of the above is preferably an alkenyl group.

In a case where a ring structure to which R^{L1} and R^{L2} are bonded is a phenyl group (aromatic group), R^{L1} and R^{L2} are preferably a linear alkyl group having 1 to 5 carbon atoms, a linear alkoxy group having 1 to 4 carbon atoms, and an alkenyl group having 4 to 5 carbon atoms, and in a case where a ring structure to which R^{L1} and R^{L2} are bonded is a saturated ring structure such as cyclohexane, pyran, and dioxane, R^{L1} and R^{L2} are preferably a linear alkyl group having 1 to 5 carbon atoms, a linear alkoxy group having 1 to 4 carbon atoms, and a linear alkenyl group having 2 to 5 carbon atoms. In order to stabilize the nematic phase, it is preferable that the total oxygen atom is 5 or less in a case where the carbon atom exists, and it is preferably in a linear shape.

As an alkenyl group, it is preferably selected from the group represented by any one of Formula (R1) to Formula (R5) (the black dot in each formula represents a carbon atom in the ring structure to which the alkenyl group is bonded).

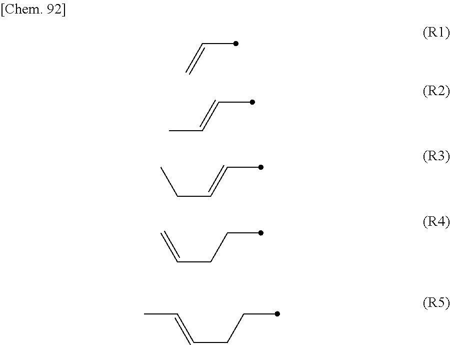

In a case of putting importance on the response speed, n^{L1} is preferably 0, and in order to improve the upper limit temperature of the nematic phase, n^{L1} is preferably 2 or 3, and is preferably 1 for balance of them. In addition, in order to satisfy the properties required as the composition, it is preferable to combine compounds having different values.

A^{L1}, A^{L2}, and A^{L3} are preferably aromatic in a case where Δn is required to be increased, are preferably aliphatic in order to improve the response speed, each independently preferably represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2, 6-diyl group, and further preferably represent the following structure.

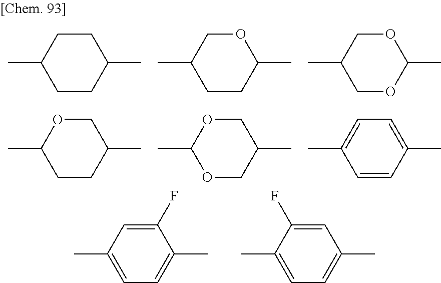

It is further preferable that A^{L1}, A^{L2}, and A^{L3} each independently represent a trans-1,4-cyclohexylene group or a 1,4-phenylene group.

In a case of putting importance on the response speed, Z^{L1} and Z^{L2} are preferably a single bond.

The compound represented by General Formula (L) is preferably a compound selected from the compound group represented by General Formula (L-1) to (L-8).

The compound represented by General Formula (L-1) is the following compound.

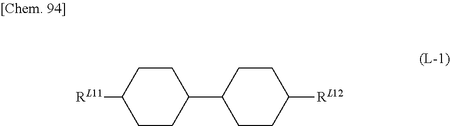

In the formula, R^{L11} and R^{L12} each independently represent the same meaning as the meaning of R^{L1} and R^{L2} in General Formula (L).

R^{L11} and R^{L12} are preferably a linear alkyl group having 1 to 5 carbon atoms, a linear alkoxy group having 1 to 4 carbon atoms, and a linear alkenyl group having 2 to 5 carbon atoms.

The compound represented by General Formula (L-1) can be used alone, and two or more thereof also can be used in combination. A type of the compound which can be combined is not particularly limited, and the compound is used in combination according to desired performances such as solubility at low temperature, transition temperature, electrical reliability, and birefringence. The number of the types of the compounds to be used is, for example, 1, 2, 3, 4, or 5 or more, for one embodiment of the present invention.

A lower limit of a preferable content with respect to a total amount of the composition of the present invention is 1%, 2%, 3%, 5%, 7%, 10%, 15%, 20%, 25%, 30%, 35%, 40%, 45%, 50%, or 55%. An upper limit of the preferable content with respect to a total amount of the composition of the present invention is 95%, 90%, 85%, 80%, 75%, 70%, 65%, 60%, 55%, 50%, 45%, 40%, 35%, 30%, or 25%.

In a case where a composition having a high response speed is needed, while maintaining low viscosity of the composition of the present invention, the lower limit is preferably high and the upper limit is preferably high. Further, in a case where a compound having excellent temperature stability is needed, while maintaining high Tni of the composition of the present invention, the lower limit preferably has an intermediate value and the upper limit preferably has an intermediate value. In addition, in a case where dielectric anisotropy is needed to be increased in order to maintain low driving voltage, the lower limit is preferably low and the upper limit is preferably low.

Further, the compound represented by General Formula (L-1) is preferably a compound selected from the compound group represented by General Formula (L-1-1).

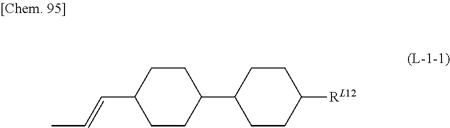

In the formula, R^{L12} represents the same meaning as the meaning in General Formula (L-1).

The compound represented by General Formula (L-1-1) is preferably a compound selected from the compound group represented by Formula (L-1-1.1) to Formula (L-1-1.3), preferably a compound represented by Formula (L-1-1.2) or Formula (L-1-1.3), and particularly preferably a compound represented by Formula (L-1-1.3).

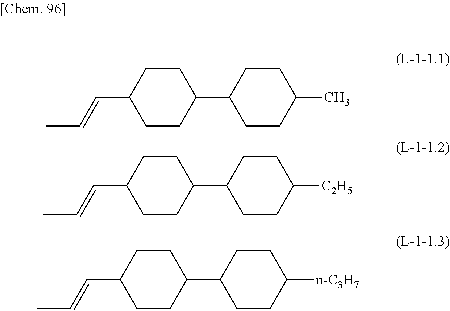

A lower limit of a preferable content of the compound represented by Formula (L-1-1.3) with respect to a total amount of the composition of the present invention is 1%, 2%, 3%, 5%, 7%, or 10%. An upper limit of the preferable content with respect to a total amount of the composition of the present invention is 20%, 15%, 13%, 10%, 8%, 7%, 6%, 5%, or 3%.

A lower limit of a preferable total content of the compound represented by Formula (L-1-1.3) and compound represented by Formula (L-1-2.2) with respect to a total amount of the composition of the present invention is 10%, 15%, 20%, 25%, 27%, 30%, 35%, 40%. An upper limit of the preferable content with respect to a total amount of the composition of the present invention is 60%, 55%, 50%, 45%, 43%, 40%, 38%, 35%, 32%, 30%, 27%, 25%, or 22%.

The compound represented by General Formula (L-1) is preferably a compound selected from the compound group represented by General Formula (L-1-2).

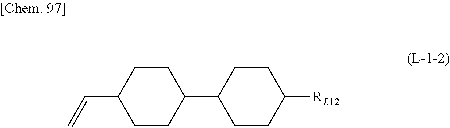

In the formula, R^{L12} represents the same meaning as the meaning in General Formula (L-1), provided that the compound represented by Formula (L-1-2.2) is excluded.

A lower limit of a preferable content of the compound represented by Formula (L-1-2) with respect to a total amount of the composition of the present invention is 1%, 5%, 10%, 15%, 17%, 20%, 23%, 25%, 27%, 30%, or 35%. An upper limit of the preferable content with respect to a total amount of the composition of the present invention is 60%, 55%, 50%, 45%, 42%, 40%, 38%, 35%, 33%, or 30%.

Further, the compound represented by General Formula (L-1-2) is preferably a compound selected from the compound group represented by Formula (L-1-2.1) to Formula (L-1-2.4), and preferably the compounds represented by Formula (L-1-2.1) to Formula (L-1-2.4). In particular, the compound represented by Formula (L-1-2.1) is preferable in order to particularly improve the response speed of the composition of the present invention. In addition, when Tni higher than the response speed is required, the compound represented by Formula (L-1-2.3) or Formula (L-1-2.4) is preferably used. It is not preferable to set the content of the compounds represented by Formula (L-1-2.3) and Formula (L-1-2.4) to 30% or more in order to improve solubility at low temperature.

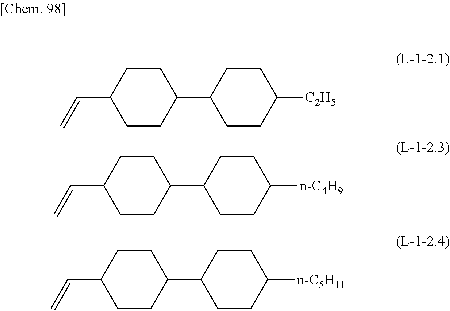

The compound represented by General Formula (L-1) is preferably a compound selected from the compound group represented by General Formula (L-1-3).

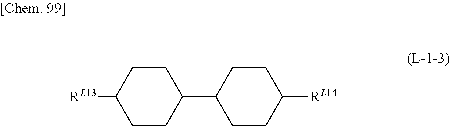

In the formula, R^{L13} and R^{L14} each independently represent an alkyl group having 1 to 8 carbon atoms or an alkoxy group having 1 to 8 carbon atoms.

R^{L13} and R^{L14} are preferably a linear alkyl group having 1 to 5 carbon atoms, a linear alkoxy group having 1 to 4 carbon atoms and a linear alkenyl group having 2 to 5 carbon atoms.

A lower limit of a preferable content of the compound represented by Formula (L-1-3) with respect to a total amount of the composition of the present invention is 1%, 5%, 10%, 13%, 15%, 17%, 20%, 23%, 25%, or 30%. An upper limit of the preferable content with respect to a total amount of the composition of the present invention is 60%, 55%, 50%, 45%, 40%, 37%, 35%, 33%, 30%, 27%, 25%, 23%, 20%, 17%, 15%, 13%, or 10%.

Further, the compound represented by General Formula (L-1-3) is preferably a compound selected from the compound group represented by Formula (L-1-3.1) to Formula (L-1-3.12), and preferably a compound represented by Formula (L-1-3.1), Formula (L-1-3.3), or Formula (L-1-3.4). In particular, the compound represented by Formula (L-1-3.1) is preferable in order to particularly improve the response speed of the composition of the present invention. In addition, when Tni higher than the response speed is required, the compound represented by Formula (L-1-3.3), Formula (L-1-3.4), Formula (L-1-3.11), or Formula (L-1-3.12) is preferably used. It is not preferable to set the total content of the compounds represented by Formula (L-1-3.3), Formula (L-1-3.4), Formula (L-1-3.11), and Formula (L-1-3.12) to 20% or more in order to improve solubility at low temperature.

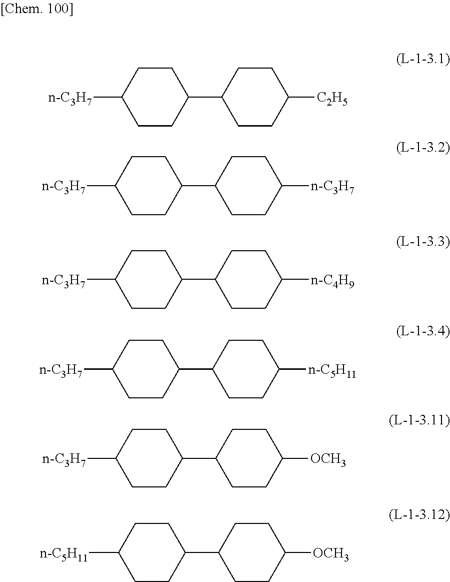

A lower limit of a preferable content of the compound represented by Formula (L-1-3.1) with respect to a total amount of the composition of the present invention is 1%, 2%, 3%, 5%, 7%, 10%, 13%, 15%, 18%, or 20%. An upper limit of the preferable content with respect to a total amount of the composition of the present invention is, 20%, 17%, 15%, 13%, 10%, 8%, 7%, or 6%.

The compound represented by General Formula (L-1) is preferably a compound selected from the compound group represented by General Formula (L-1-4) and/or (L-1-5)

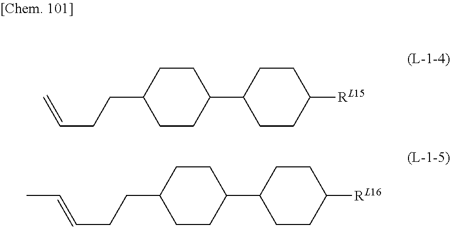

In the formula, R^{L15} and R^{L16} each independently represent an alkyl group having 1 to 8 carbon atoms or an alkoxy group having 1 to 8 carbon atoms.

R^{L15} and R^{L16} are preferably a linear alkyl group having 1 to 5 carbon atoms, a linear alkoxy group having 1 to 4 carbon atoms and a linear alkenyl group having 2 to 5 carbon atoms.

A lower limit of a preferable content of the compound represented by Formula (L-1-4) with respect to a total amount of the composition of the present invention is 1%, 5%, 10%, 13%, 15%, 17%, or 20%. An upper limit of the preferable content with respect to a total amount of the composition of the present invention is, 25%, 23%, 20%, 17%, 15%, 13%, or 10%.

A lower limit of a preferable content of the compound represented by Formula (L-1-5) with respect to a total amount of the composition of the present invention is 1%, 5%, 10%, 13%, 15%, 17%, or 20%. An upper limit of the preferable content with respect to a total amount of the composition of the present invention is, 25%, 23%, 20%, 17%, 15%, 13%, or 10%.

Further, the compounds represented by General Formulae (L-1-4) and (L-1-5) are preferably compounds selected from the compound group represented by Formula (L-1-4.1) to Formula (L-1-5.3), and are preferably the compound represented by Formula (L-1-4.2) or Formula (L-1-5.2).

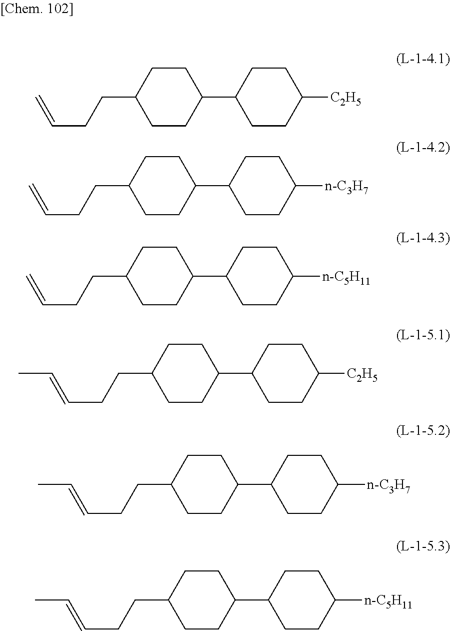

A lower limit of a preferable content of the compound represented by Formula (L-1-4.2) with respect to a total amount of the composition of the present invention is 1%, 2%, 3%, 5%, 7%, 10%, 13%, 15%, 18%, or 20%. An upper limit of the preferable content with respect to a total amount of the composition of the present invention is 20%, 17%, 15%, 13%, 10%, 8%, 7%, or 6%.

It is preferable to combine two or more kinds of compounds selected from the compounds represented by Formula (L-1-1.3), Formula (L-1-2.2), Formula (L-1-3.1), Formula (L-1-3.3), Formula (L-1-3.4), Formula (L-1-3.11), and Formula (L-1-3.12), and it is preferable to combine two or more kinds of compounds selected from the compounds represented by Formula (L-1-1.3), Formula (L-1-2.2), Formula (L-1-3.1), Formula (L-1-3.3), Formula (L-1-3.4), and Formula (L-1-4.2). A lower limit of a preferable total content of these compounds with respect to a total amount of the composition of the present invention is 1%, 2%, 3%, 5%, 7%, 10%, 13%, 15%, 18%, 20%, 23%, 25%, 27%, 30%, 33%, or 35%. An upper limit with respect to a total amount of the composition of the present invention is 80%, 70%, 60%, 50%, 45%, 40%, 37%, 35%, 33%, 30%, 28%, 25%, 23%, or 20%. In a case of putting importance on the reliability of the composition, it is preferable to combine two or more kinds of compounds selected from the compounds represented by Formula (L-1-3.1), Formula (L-1-3.3) and Formula (L-1-3.4), and in a case of putting importance on the response speed of the composition, it is preferable to combine two or more kinds of compounds selected from the compounds represented by Formula (L-1-1.3) and Formula (L-1-2.2).

The compound represented by General Formula (L-2) is the following compound.

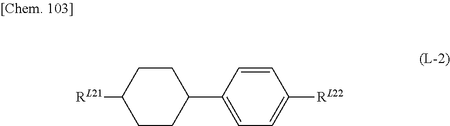

In the formula, R^{L21} and R^{L22} each independently represent the same meaning as the meaning of R^{L1} and R^{L2} in General Formula (L).

R^{L21} is preferably an alkyl group having 1 to 5 carbon atoms or an alkenyl group having 2 to 5 carbon atoms, R^{L22} is preferably an alkyl group having 1 to 5 carbon atoms, an alkenyl group having 4 to 5 carbon atoms or an alkoxy group having 1 to 4 carbon atoms.

The compound represented by General Formula (L-1) can be used alone, and two or more thereof also can be used in combination. A type of the compound which can be combined is not particularly limited, and the compound is used in combination according to desired performances such as solubility at low temperature, transition temperature, electrical reliability, and birefringence. The number of the types of the compounds to be used is, for example, 1, 2, 3, 4, or 5 or more, for one embodiment of the present invention.

In a case of putting importance on solubility at low temperature, it is highly effective to set the content to a great amount, and in contrast, in a case of putting importance on the response speed, it is highly effective to set the content to a small amount. Further, in a case of improving drop marks or burn-in properties, it is preferable to set the content in an intermediate range.

A lower limit of a preferable content of the compound represented by Formula (L-2) with respect to a total amount of the composition of the present invention is 1%, 2%, 3%, 5%, 7%, or 10%. An upper limit of the preferable content with respect to a total amount of the composition of the present invention is 20%, 15%, 13%, 10%, 8%, 7%, 6%, 5%, or 3%.

Further, the compound represented by General Formula (L-2) is preferably a compound selected from the compound group represented by Formula (L-2.1) to Formula (L-2.6), and preferably compounds represented by Formula (L-2.1), Formula (L-2.3), Formula (L-2.4), and Formula (L-2.6).

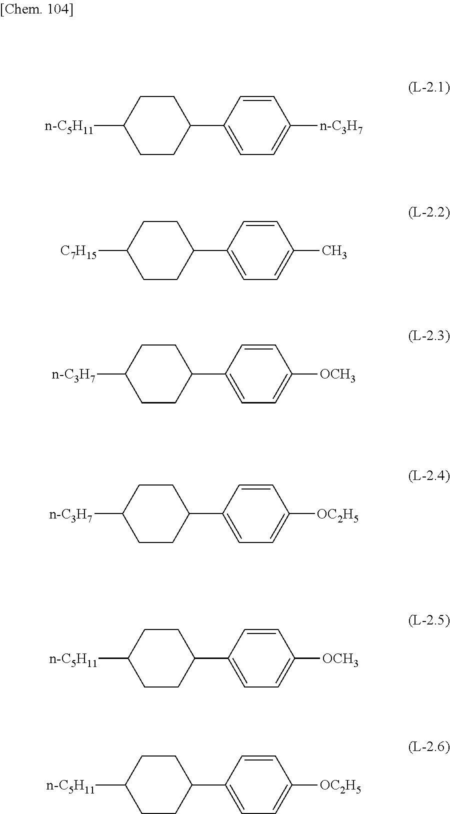

The compound represented by General Formula (L-3) is the following compound.

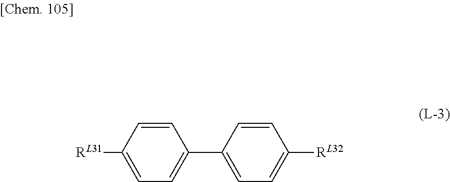

In the formula, R^{L31} and R^{L32} each independently represent the same meaning as the meaning of R^{L1} and R^{L2} in General Formula (L).

R^{L31} and R^{L32} are each independently preferably an alkyl group having 1 to 5 carbon atoms, an alkenyl group having 4 to 5 carbon atoms or an alkoxy group having 1 to 4 carbon atoms.

The compound represented by General Formula (L-3) can be used alone, and two or more thereof also can be used in combination. A type of the compound which can be combined is not particularly limited, and the compound is used in combination according to desired performances such as solubility at low temperature, transition temperature, electrical reliability, and birefringence. The number of the types of the compounds to be used is, for example, 1, 2, 3, 4, or 5 or more, for one embodiment of the present invention.

A lower limit of a preferable content of the compound represented by Formula (L-3) with respect to a total amount of the composition of the present invention is 1%, 2%, 3%, 5%, 7%, or 10%. An upper limit of the preferable content with respect to a total amount of the composition of the present invention is 20%, 15%, 13%, 10%, 8%, 7%, 6%, 5%, or 3%.

In a case of obtaining high birefringence, it is highly effective to set the content to a great amount, and in contrast, in a case of putting importance on high Tni, it is highly effective to set the content to a small amount. Further, in a case of improving drop marks or burn-in properties, it is preferable to set the content in an intermediate range.

Further, the compound represented by General Formula (L-3) is preferably a compound selected from the compound group represented by Formula (L-3.1) to Formula (L-3.4), and preferably compounds represented by Formula (L-3.2) to Formula (L-3.7).

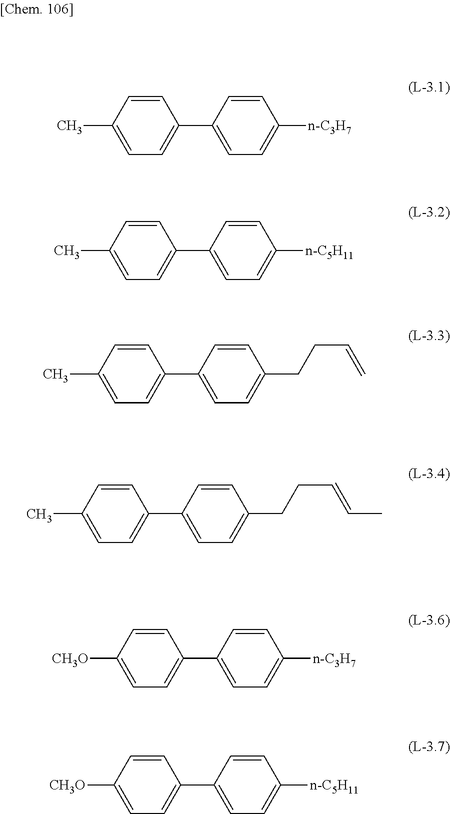

The compound represented by General Formula (L-4) is the following compound.

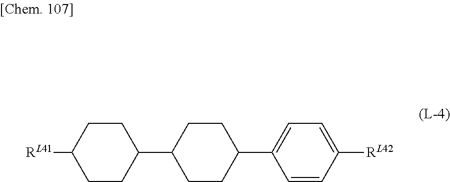

In the formula, R^{L41} and R^{L42} each independently represent the same meaning as the meaning of R^{L1} and R^{L2} in General Formula (L).

R^{L41} is preferably an alkyl group having 1 to 5 carbon atoms or an alkenyl group having 2 to 5 carbon atoms, R^{L42} is preferably an alkyl group having 1 to 5 carbon atoms, an alkenyl group having 4 to 5 carbon atoms or an alkoxy group having 1 to 4 carbon atoms.

The compound represented by General Formula (L-4) can be used alone, and two or more thereof also can be used in combination. A type of the compound which can be combined is not particularly limited, and the compound is used in combination according to desired performances such as solubility at low temperature, transition temperature, electrical reliability, and birefringence. The number of the types of the compounds to be used is, for example, 1, 2, 3, 4, or 5 or more, for one embodiment of the present invention.

In the composition of the present invention, it is necessary that the content of the compound represented by General Formula (L-4) is appropriately adjusted according to the required performances such as solubility at low temperature, transition temperature, electrical reliability, birefringence, process adaptability, drop marks, burn-in, and dielectric anisotropy.

A lower limit of a preferable content of the compound represented by Formula (L-4) with respect to a total amount of the composition of the present invention is 1%, 2%, 3%, 5%, 7%, 10%, 14%, 16%, 20%, 23%, 26%, 30%, 35%, or 40%. An upper limit of the preferable content of the compound represented by Formula (L-4) with respect to a total amount of the composition of the present invention is 50%, 40%, 35%, 30%, 20%, 15%, 10%, or 5%.

The compound represented by General Formula (L-4) is preferably, for example, compounds represented by Formula (L-4.1) to Formula (L-4.3).

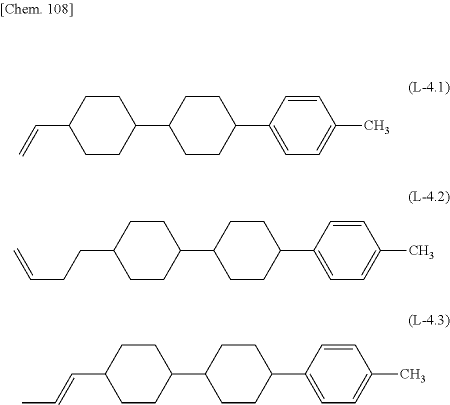

Depending on the required performances such as solubility at low temperature, transition temperature, electrical reliability, and birefringence, the compound represented by Formula (L-4.1) may be included, the compound represented by Formula (L-4.2) may be included, both the compound represented by Formula (L-4.1) and the compound represented by Formula (L-4.2) may be included, and all of the compounds represented by Formula (L-4.1) to Formula (L-4.3) may be included. A lower limit of a preferable content of the compound represented by Formula (L-4.1) or Formula (L-4.2) with respect to a total amount of the composition of the present invention is 3%, 5%, 7%, 9%, 11%, 12%, 13%, 18%, or 21%. A preferable upper limit is 45, 40%, 35%, 30%, 25%, 23%, 20%, 18%, 15%, 13%, 10%, or 8%.

In a case of both the compound represented by Formula (L-4.1) and the compound represented by Formula (L-4.2) are included, a lower limit of a preferable content of both the compounds with respect to a total amount of the composition of the present invention is 15%, 19%, 24%, or 30%. A preferable upper limit is 45, 40%, 35%, 30%, 25%, 23%, 20%, 18%, 15%, or 13%.

Further, the compound represented by General Formula (L-4) is preferably, for example, compounds represented by Formula (L-4.4) to Formula (L-4.6), and is further preferably the compound represented by Formula (L-4.4).

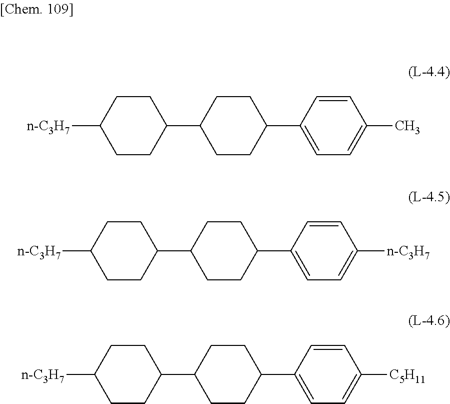

Depending on the required performances such as solubility at low temperature, transition temperature, electrical reliability, and birefringence, the compound represented by Formula (L-4.4) may be included, the compound represented by Formula (L-4.5) may be included, and both the compound represented by Formula (L-4.4) and the compound represented by Formula (L-4.5) may be included.

A lower limit of a preferable content of the compound represented by Formula (L-4.4) or Formula (L-4.5) with respect to a total amount of the composition of the present invention is 3%, 5%, 7%, 9%, 11%, 12%, 13%, 18%, or 21%. A preferable upper limit is 45, 40%, 35%, 30%, 25%, 23%, 20%, 18%, 15%, 13%, 10%, or 8%.

In a case containing both the compound represented by Formula (L-4.4) and the compound represented by Formula (L-4.5), a lower limit of the preferable content of the both compounds with respect to a total amount of the composition of the present invention is 15%, 19%, 24%, or 30%, and a preferable upper limit is 45, 40%, 35%, 30%, 25%, 23%, 20%, 18%, 15%, or 13%.

The compound represented by General Formula (L-4) is preferably compounds represented by Formula (L-4.7) to Formula (L-4.10), and particularly preferably the compound represented by Formula (L-4.9).

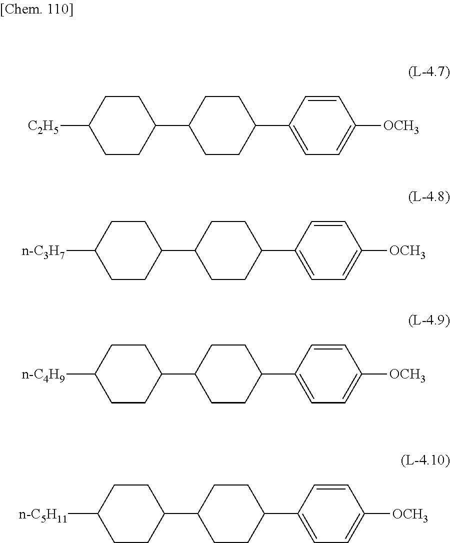

The compound represented by General Formula (L-5) is the following compound.

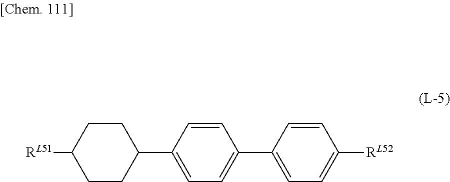

In the formula, R^{L51} and R^{L52} each independently represent the same meaning as the meaning of R^{L1} and R^{L2} in General Formula (L).

R^{L51} is preferably an alkyl group having 1 to 5 carbon atoms or an alkenyl group having 2 to 5 carbon atoms, R^{L52} is preferably an alkyl group having 1 to 5 carbon atoms, an alkenyl group having 4 to 5 carbon atoms or an alkoxy group having 1 to 4 carbon atoms.

The compound represented by General Formula (L-5) can be used alone, and two or more thereof also can be used in combination. A type of the compound which can be combined is not particularly limited, and the compound is used in combination according to desired performances such as solubility at low temperature, transition temperature, electrical reliability, and birefringence. The number of the types of the compounds to be used is, for example, 1, 2, 3, 4, or 5 or more, for one embodiment of the present invention.

In the composition of the present invention, it is necessary that the content of the compound represented by General Formula (L-5) is appropriately adjusted according to the required performances such as solubility at low temperature, transition temperature, electrical reliability, birefringence, process adaptability, drop marks, burn-in, and dielectric anisotropy.

A lower limit of a preferable content of the compound represented by Formula (L-5) with respect to a total amount of the composition of the present invention is 1%, 2%, 3%, 5%, 7%, 10%, 14%, 16%, 20%, 23%, 26%, 30%, 35%, or 40%. An upper limit of the preferable content of the compound represented by Formula (L-5) with respect to a total amount of the composition of the present invention is 50%, 40%, 35%, 30%, 20%, 15%, 10%, or 5%.

Further, the compound represented by General Formula (L-5) is preferably, for example, a compound represented by Formula (L-5.1) or Formula (L-5.2), and particularly preferably a compound represented by Formula (L-5.1).

A lower limit of a preferable content of these compounds with respect to a total amount of the composition of the present invention is 1%, 2%, 3%, 5%, or 7%. An upper limit of the preferable content of these compounds is 20%, 15%, 13%, 10%, or 9%.

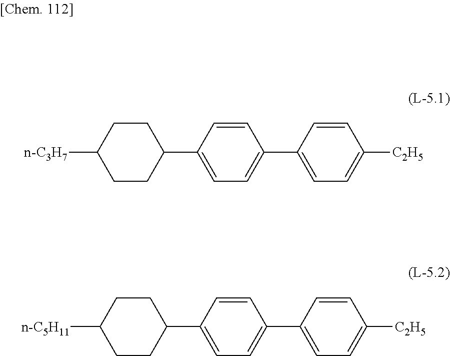

The compound represented by General Formula (L-5) is preferably a compound represented by Formula (L-5.3) or Formula (L-5.4).

A lower limit of the preferable content of these compounds with respect to a total amount of the composition of the present invention is 1%, 2%, 3%, 5%, or 7%. An upper limit of the preferable content of these compounds is 20%, 15%, 13%, 10%, or 9%.

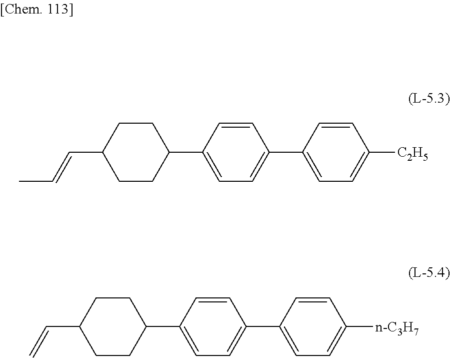

The compound represented by General Formula (L-5) is preferably, for example, a compound selected from the compound group represented by Formula (L-5.5) to Formula (L-5.7), and particularly preferably a compound represented by Formula (L-5.7).

A lower limit of a preferable content of these compounds with respect to a total amount of the composition of the present invention is 1%, 2%, 3%, 5%, or 7%. An upper limit of the preferable content of these compounds is 20%, 15%, 13%, 10%, or 9%.

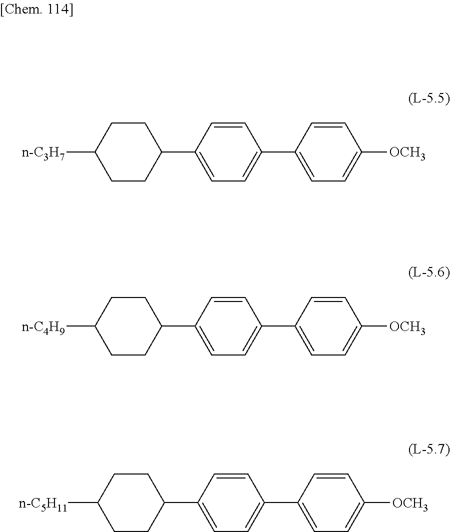

The compound represented by General Formula (L-6) is the following compound.

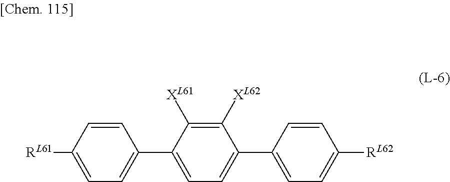

In the formula, R^{L61} and R^{L62} each independently represent the same meaning as the meaning of R^{L1} and R^{L2} in General Formula (L), and X^{L61} and X^{L62} each independently represent a hydrogen atom or a fluorine atom.

R^{L61} and R^{L62} are each independently preferably an alkyl group having 1 to 5 carbon atoms or an alkenyl group having 2 to 5 carbon atoms, and it is preferable that one of X^{L61} and X^{L62} is a fluorine atom and the other one is a hydrogen atom.

The compound represented by General Formula (L-6) can be used alone, and two or more thereof also can be used in combination. A type of the compound which can be combined is not particularly limited, and the compound is used in combination according to desired performances such as solubility at low temperature, transition temperature, electrical reliability, and birefringence. The number of the types of the compounds to be used is, for example, 1, 2, 3, 4, or 5 or more, for one embodiment of the present invention.

A lower limit of a preferable content of the compound represented by Formula (L-6) with respect to a total amount of the composition of the present invention is 1%, 2%, 3%, 5%, 7%, 10%, 14%, 16%, 20%, 23%, 26%, 30%, 35%, or 40%. An upper limit of the preferable content of the compound represented by Formula (L-6) with respect to a total amount of the composition of the present invention is 50%, 40%, 35%, 30%, 20%, 15%, 10%, or 5%. In a case of putting importance on the increase of Δn, it is preferable to increase the content, and in a case of putting importance on precipitation at low temperature, it is preferable to decrease the content.

Further, the compound represented by General Formula (L-6) is preferably, for example, compounds represented by Formula (L-6.1) to Formula (L-6.9).

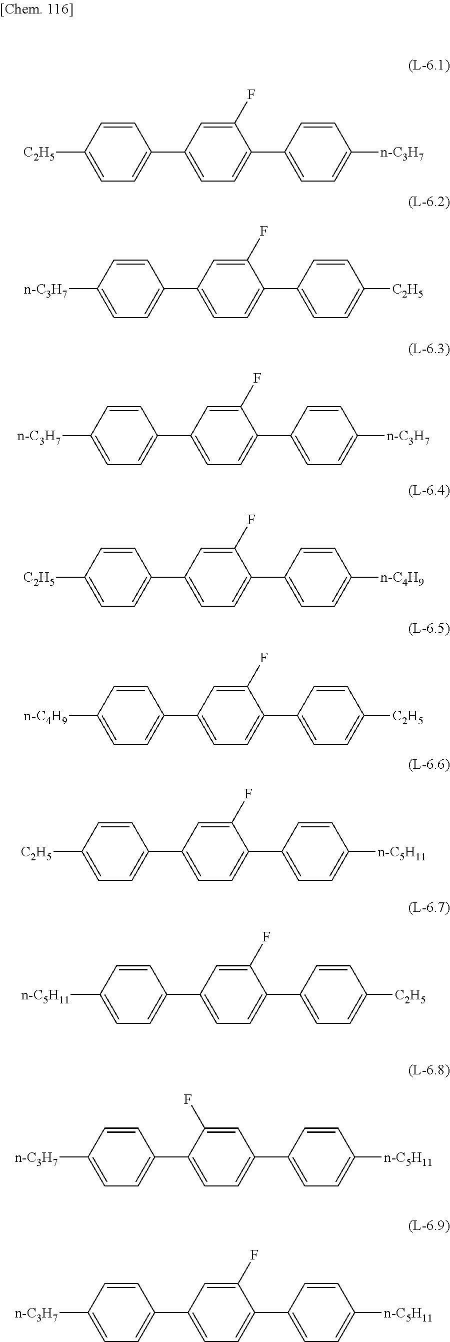

A type of the compound which can be combined is not particularly limited, and 1 to 3 types from the compounds is preferably contained, and 1 to 4 types is more preferably contained. In addition, since a wide molecular weight distribution of the compound to be selected is effective for solubility, for example, it is preferable to select 1 type from the compound represented by Formula (L-6.1) or (L-6.2), 1 type from the compound represented by Formula (L-6.4) or (L-6.5), 1 type from the compound represented by Formula (L-6.6) or (L-6.7), and 1 type from the compound represented by Formula (L-6.8) or (L-6.9), and appropriately combine the selected compounds. Among the above, it is preferable to contain the compounds represented by Formula (L-6.1), Formula (L-6.3), Formula (L-6.4), Formula (L-6.6), and Formula (L-6.9).

Further, the compound represented by General Formula (L-6) is preferably, for example, compounds represented by Formula (L-6.10) to Formula (L-6.17), and among the above, the compound represented by Formula (L-6.11) is preferable.

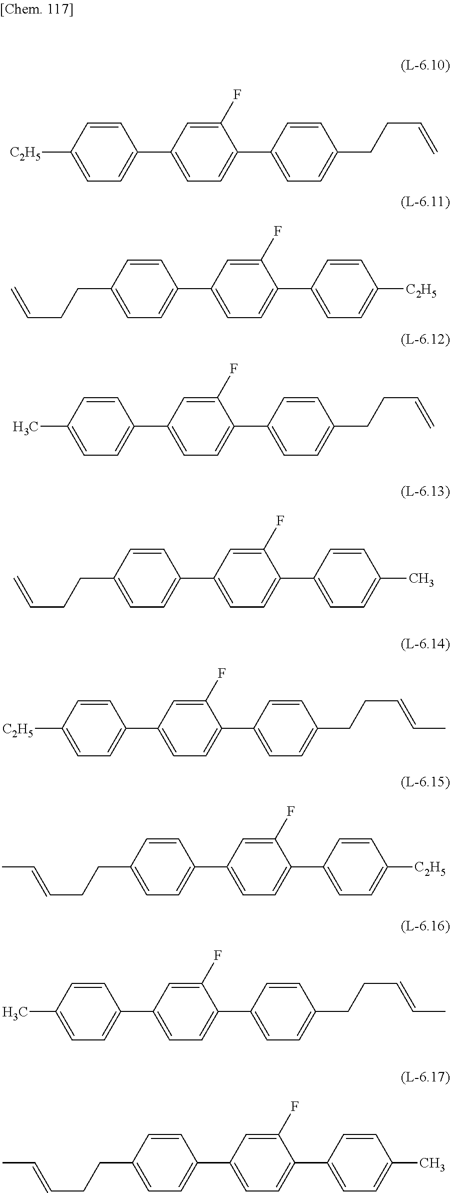

A lower limit of a preferable content of these compounds with respect to a total amount of the composition of the present invention is 1%, 2%, 3%, 5%, or 7%. An upper limit of the preferable content of these compounds is 20%, 15%, 13%, 10%, or 9%.

The compound represented by General Formula (L-7) is the following compound.

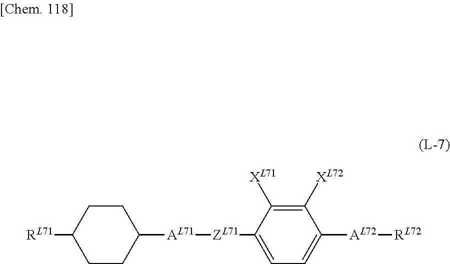

In the formula, R^{L71} and R^{L72} each independently represent the same meaning as the meaning of R^{L1} and R^{L2} in General Formula (L), and A^{L71} and A^{L72} each independently represent the same meaning as the meaning of A^{L2} and A^{L3} in General Formula (L); however, hydrogen atoms on A^{L71} and A^{L72} each independently may be substituted with a fluorine atom, Z^{L71} represents the same meaning as the meaning of Z^{L2} in General Formula (L), and X^{L71} and X^{L72} each independently represent a fluorine atom or a hydrogen atom.

In the formula, R^{L71} and R^{L72} are each independently preferably an alkyl group having 1 to 5 carbon atoms, an alkenyl group having 2 to 5 carbon atoms, or an alkoxy group having 1 to 4 carbon atoms, A^{L71} and A^{L72} each independently preferably 1,4-cyclohexylene group or a 1,4-phenylene group, hydrogen atom on A^{L71} and A^{L72} each independently may be substituted with a fluorine atom, Q^{L71} is preferably a single bond or COO—, and is further preferably a single bond, and X^{L71} and X^{L72} are preferably or a hydrogen atom.

A type of the compound which can be combined is not particularly limited, and the compound is combined according to the required performances such as solubility at low temperature, transition temperature, electrical reliability, and birefringence. The number of the types of the compounds to be used is, for example, 1, 2, 3, or 4 for one embodiment of the present invention.

In the composition of the present invention, it is necessary that the content of the compound represented by General Formula (L-7) is appropriately adjusted according to the required performances such as solubility at low temperature, transition temperature, electrical reliability, birefringence, process adaptability, drop marks, burn-in, and dielectric anisotropy.

A lower limit of a preferable content of the compound represented by Formula (L-7) with respect to a total amount of the composition of the present invention is 1%, 2%, 3%, 5%, 7%, 10%, 14%, 16%, or 20%. An upper limit of the preferable content of the compound represented by Formula (L-7) with respect to a total amount of the composition of the present invention is 30%, 25%, 23%, 20%, 18%, 15%, 10%, or 5%.

In a case where an embodiment in which the composition of the present invention has high Tni is desired, it is preferable to increase the content of the compound represented by Formula (L-7), and in a case where an embodiment in which the composition has low viscosity is desired, it is preferable to decrease the content.

Further, the compound represented by General Formula (L-7) is preferably compounds represented by Formula (L-7.1) to Formula (L-7.4), and preferably a compound represented by Formula (L-7.2).

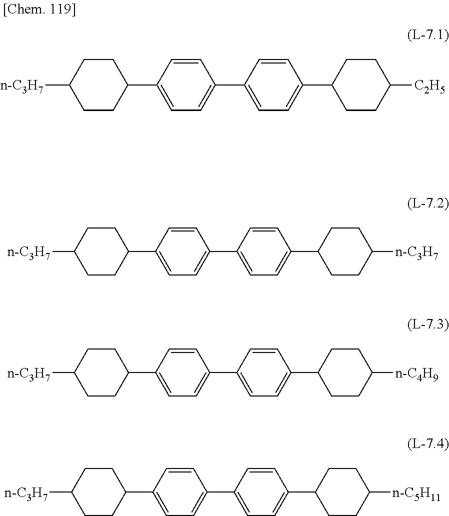

Further, the compound represented by General Formula (L-7) is preferably, for example, compounds represented by Formula (L-7.11) to Formula (L-7.13), and is further preferably the compound represented by Formula (L-7.11).

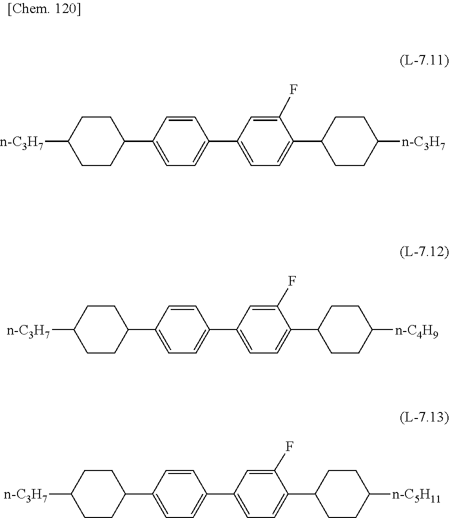

Further, the compound represented by General Formula (L-7) is compounds represented by Formula (L-7.21) to Formula (L-7.23), and is preferably the compound represented by Formula (L-7.21).

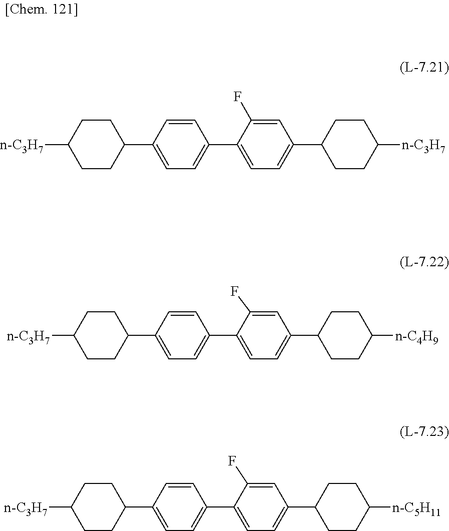

Further, the compound represented by General Formula (L-7) is preferably compounds represented by Formula (L-7.31) to Formula (L-7.34), and preferably a compound represented by Formula (L-7.31) and/or Formula (L-7.32).

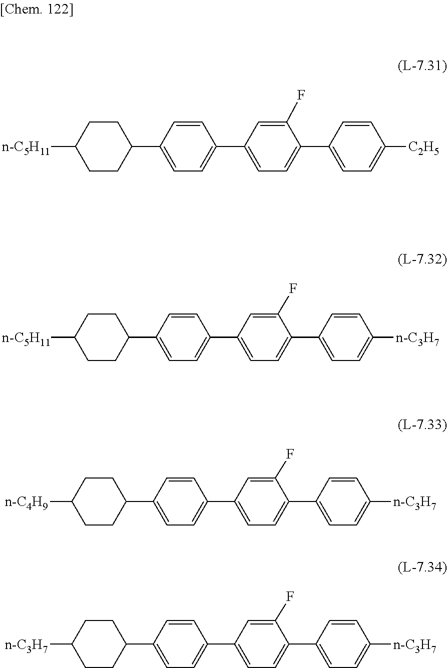

Further, the compound represented by General Formula (L-7) is preferably compounds represented by Formula (L-7.41) to Formula (L-7.44), and preferably a compound represented by Formula (L-7.41) and/or Formula (L-7.42).

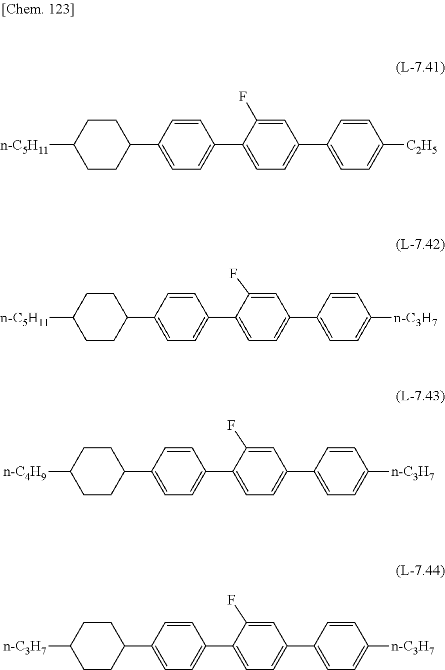

The compound represented by General Formula (L-8) is the following compound.

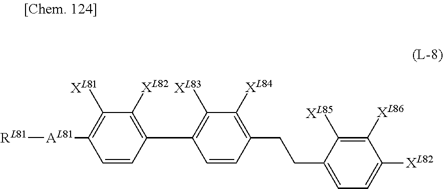

In the formula, R^{L81} and R^{L82} each independently represent the same meaning as the meaning of R^{L1} and R^{L2} General Formula (L), and A^{L81} represents the same meaning as the meaning of A^{L1} General Formula (L), or a single bond; however, hydrogen atoms on A^{L81} each independently may be substituted with a fluorine atom, and X^{L81} to X^{L86} each independently represent a fluorine atom or a hydrogen atom.

In the formula, R^{L81} and R^{L82} are each independently preferably an alkyl group having 1 to 5 carbon atoms, an alkenyl group having 2 to 5 carbon atoms, or an alkoxy group having 1 to 4 carbon atoms, A^{L81} is preferably a 1,4-cyclohexylene group or a 1,4-phenylene group, hydrogen atoms on A^{L71} and A^{L72} each independently may be substituted with a fluorine atom, the number of fluorine atoms on the same ring structure in General Formula (L-8) is preferably 0 or 1, and the number of fluorine atoms in the molecule is preferably 0 or 1.

A type of the compound which can be combined is not particularly limited, and the compound is combined according to the required performances such as solubility at low temperature, transition temperature, electrical reliability, and birefringence. The number of the types of the compounds to be used is, for example, 1, 2, 3, or 4 for one embodiment of the present invention.

In the composition of the present invention, it is necessary that the content of the compound represented by General Formula (L-8) is appropriately adjusted according to the required performances such as solubility at low temperature, transition temperature, electrical reliability, birefringence, process adaptability, drop marks, burn-in, and dielectric anisotropy.

A lower limit of a preferable content of the compound represented by Formula (L-8) with respect to a total amount of the composition of the present invention is 1%, 2%, 3%, 5%, 7%, 10%, 14%, 16%, or 20%. An upper limit of the preferable content compound represented by Formula (L-8) with respect to a total amount of the composition of the present invention is 30%, 25%, 23%, 20%, 18%, 15%, 10%, or 5%.

In a case where an embodiment in which the composition of the present invention has high Tni is desired, it is preferable to increase the content of the compound represented by Formula (L-8), and in a case where an embodiment in which the composition has low viscosity is desired, it is preferable to decrease the content.

Further, the compound represented by General Formula (L-8) is preferably compounds represented by Formula (L-8.1) to Formula (L-8.28), and is further preferably compounds represented by Formula (L-8.3), Formula (L-8.5), Formula (L-8.6), Formula (L-8.13), Formula (L-8.16) to Formula (L-8.18), and Formula (L-8.23) to Formula (L-8.28).

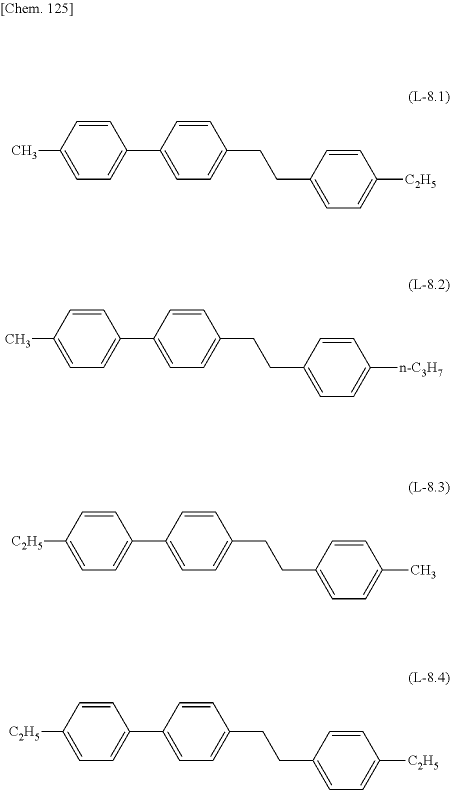

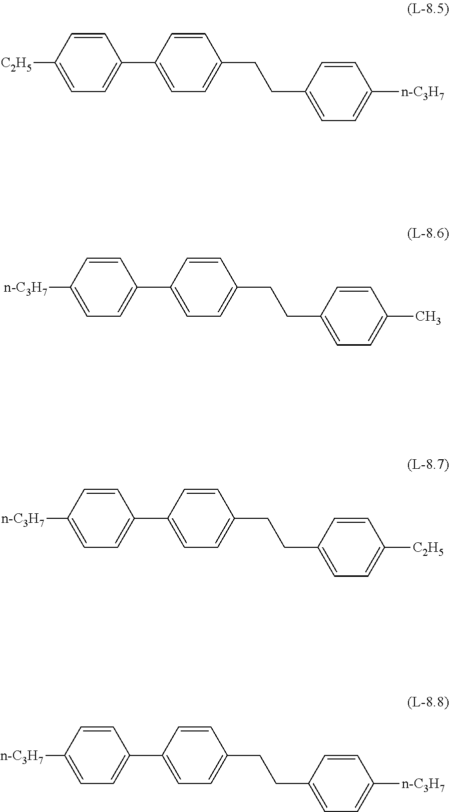

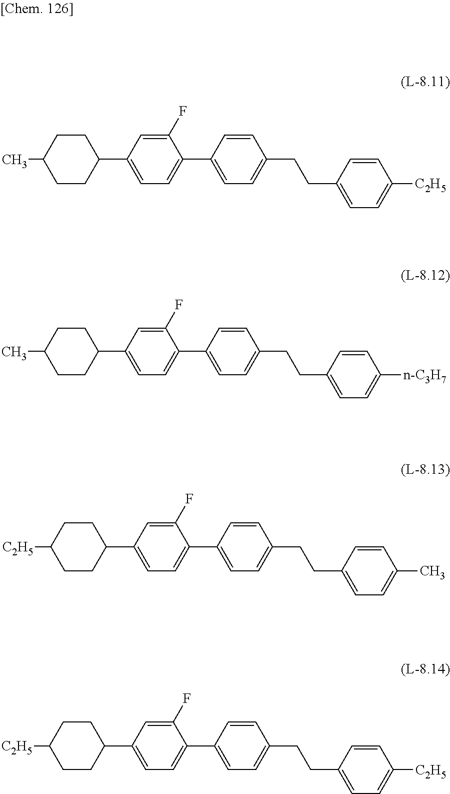

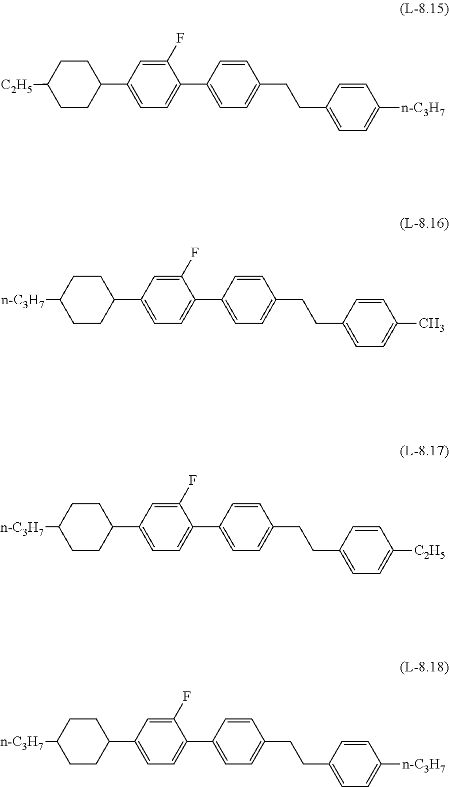

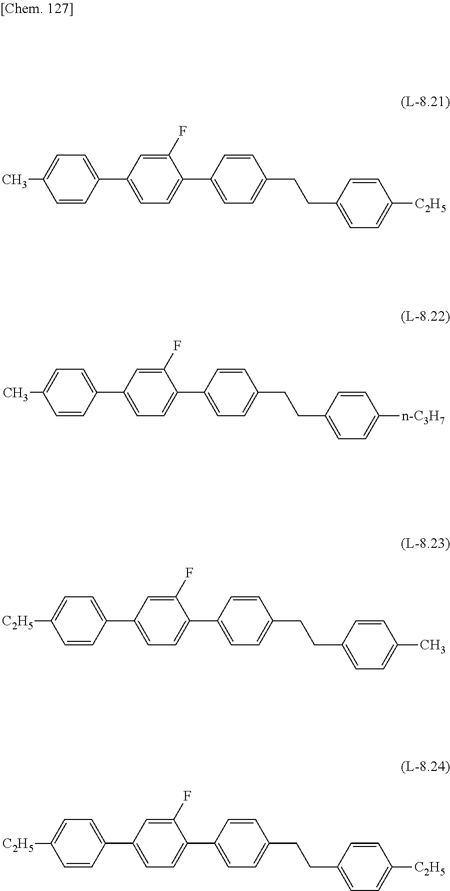

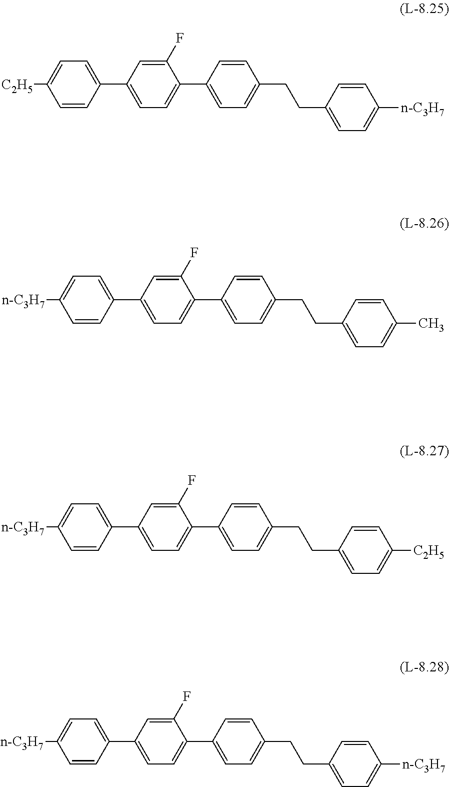

A lower limit of a preferable total content of the compounds represented by General Formula (i), General Formula (ii), General Formula (L), and General Formula (J) with respect to a total amount of the composition of the present invention is 80%, 85%, 88%, 90%, 92%, 93%, 94%, 95%, 96%, 97%, 98%, 99%, or 100%. An upper limit of the preferable content is 100%, 99%, 98%, or 95%.

A lower limit of a preferable total content of the compounds represented by General Formula (i), General Formula (ii), General Formula (L), and General Formula (M) with respect to a total amount of the composition of the present invention is 80%, 85%, 88%, 90%, 92%, 93%, 94%, 95%, 96%, 97%, 98%, 99%, or 100%. An upper limit of the preferable content is 100%, 99%, 98%, or 95%.

A lower limit of a preferable total content of the compounds represented by General Formula (i), General Formula (ii), General Formula (L-1) to General Formula (L-8), General Formula (M-1) to General Formula (M-18), and General Formula (K-1) to General Formula (K-6) with respect to a total amount of the composition of the present invention is 80%, 85%, 88%, 90%, 92%, 93%, 94%, 95%, 96%, 97%, 98%, 99%, or 100%. An upper limit of the preferable content is 100%, 99%, 98%, or 95%.

The composition of the present invention preferably does not contain a compound having a structure in which oxygen atoms are bonded to each other within a molecule such as a peracid (—CO—OO—) structure.

In a case of putting importance on the reliability and long term stability of the composition, the content of the compound having a carbonyl group is preferably 5% or less, further preferably 3% or less, and still further preferably 1% or less with respect to a total mass of the composition, and the composition substantially not containing the compound is the most preferable.

In a case of putting importance on stability upon UV irradiation, the content of the compound in which a chlorine atom is substituted is preferably 15% or less, preferably 10% or less, preferably 8% or less, further preferably 5% or less, and preferably 3% or less with respect to a total mass of the composition, and the composition substantially not containing the compound is still more preferable.

It is preferable to increase the content of the compound in which the ring structures within a molecule are all 6-membered rings, the content of the compound in which the ring structures within a molecule are all 6-membered rings is preferably 80% or more, further preferably 90% or more, and still further preferably 95% or more with respect to a total mass of the composition, and the composition formed of only the compound in which the ring structures within a molecule are substantially all 6-membered rings is the most preferable.

In order to suppress degradation of the composition due to oxidization, it is preferable to decrease the content of the compound having a cyclohexenylene group as a ring structure, the content of the compound having a cyclohexenylene group is preferably 10% or less, preferably 8% or less, further preferably 5% or less, and preferably 3% or less with respect to a total mass of the composition, and the composition substantially not containing the compound is still more preferable.

In a case of putting importance on improving viscosity and Tni, it is preferable to decrease the content of the compound having a 2-methylbenzene-1,4-diyl group within a molecule, in which a hydrogen atom may be substituted with halogen, the content of the compound having a 2-methylbenzene-1,4-diyl group within a molecule is preferably 10% or less, preferably 8% or less, further preferably 5% or less, and preferably 3% or less with respect to a total mass of the composition, and the composition substantially not containing the compound is still more preferable.

The meaning of substantially not containing in the present application is not containing anything except the unintentional substances.

In a case where the compound included in the composition according to one embodiment of the present invention has an alkenyl group as a side chain, when the alkenyl group bonds to cyclohexane, the number of carbon atoms of the alkenyl group is preferably 2 to 5, and when the alkenyl group bonds to benzene, the number of carbon atoms of the alkenyl group is preferably 4 to 5, and an unsaturated bond of the alkenyl group preferably does not directly bond to benzene.

The composition of the present invention may include a polymerizable compound in order to manufacture a liquid crystal display element such as a PS mode, a horizontal electric field type PSA mode, or a horizontal electric field type PSVA mode. As the polymerizable compound which can be used, a photopolymerizable monomer can be exemplified, in which polymerization proceeds upon irradiation with an energy ray such as light, and a polymerizable compound can be exemplified, which has a liquid crystal skeleton in which a plurality of 6-membered rings such as a biphenyl derivative and a terphenyl derivative are connected with each other, as a structure. More specifically, a bifunctional monomer represented by General Formula (XX) is preferable.

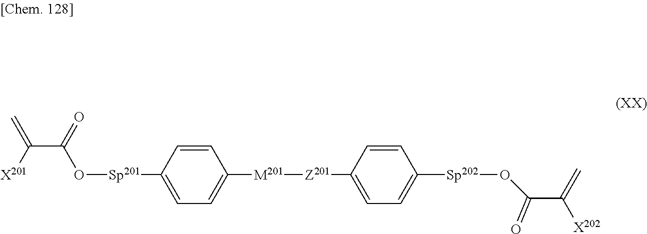

In the formula, X²⁰¹ and X²⁰² each independently represent a hydrogen atom or a methyl group, Sp²⁰¹ and Sp²⁰² each independently preferably a single bond, an alkylene group having 1 to 8 carbon atoms, or —O—(CH₂)ₛ— (in the formula, s represents an integer of 2 to 7, and an oxygen atom bonds to an aromatic ring), Z²⁰¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond, and M²⁰¹ represents a 1,4-phenylene group, a trans-1,4-cyclohexylene group, or a single bond, and in all of the 1,4-phenylene groups in the formula, an arbitrary hydrogen atom may be substituted with a fluorine atom.

X²⁰¹ and X²⁰² are preferably any of diacrylate derivatives representing a hydrogen atom and dimethacrylate derivatives having a methyl group, and one is preferably a compound representing a hydrogen atom, and the other is preferably a compound representing a methyl group. With regard to the polymerization rate of these compounds, the diacrylate derivative is the fastest, the dimethacrylate derivative is the slowest, and the asymmetric compound is in the middle of the above derivatives, and it is possible to use preferable aspects according to the purpose. In the PSA display element, the dimethacrylate derivative is particularly preferable.

Sp²⁰¹ and Sp²⁰² each independently represent a single bond, an alkylene group having 1 to 8 carbon atoms, or —O—(CH₂)ₛ—. However, in the PSA display element, at least one of Sp²⁰¹ and Sp²⁰² is preferably a single bond, and an aspect is preferable in which both of Sp²⁰¹ and Sp²⁰² represent a compound representing a single bond, or one represents a single bond and the other represents an alkylene group having 1 to 8 carbon atoms or —O—(CH₂)ₛ—. In this case, an alkyl group having 1 to 4 carbon atoms is preferable, and s is preferably 1 to 4.

Z²⁰¹ is preferably —OCH₂—, —CH₂O—, —COO—, —OCO—, —CF₂O—, —OCF₂—, —CH₂CH₂—, —CF₂CF₂—, or a single bond, —COO—, —OCO—, or a single bond is more preferable, and a single bond is particularly preferable.

M²⁰¹ represents a 1,4-phenylene group, a trans-1,4-cyclohexylene group, or a single bond, in which a hydrogen atom may be substituted with a fluorine atom, and a 1,4-phenylene group or a single bond is preferable. When C represents a ring structure other than a single bond, Z²⁰¹ is preferably a linking group other than a single bond, and when M²⁰¹ is a single bond, Z²⁰¹ is preferably a single bond.

From this viewpoint, the ring structure between Sp²⁰¹ and Sp²⁰² in General Formula (XX) is preferably, specifically, a structure described below.

In General Formula (XX), when M²⁰⁰ represents a single bond, and the ring structure is formed by two rings, the ring structure preferably represents Formula (XXa-1) to Formula (XXa-5) described below, more preferably Formula (XXa-1) to Formula (XXa-3), and particularly preferably Formula (XXa-1).

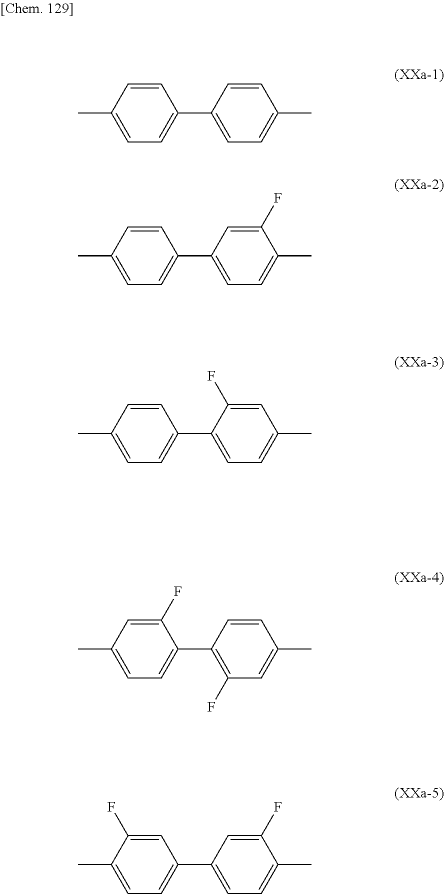

In the formula, both ends bond to Sp²⁰¹ or Sp²⁰².

The polymerizable compound including these skeletons has an alignment regulation force after polymerization, which is optimal for the PSA type liquid crystal display element, and since an excellent alignment state can be obtained, display unevenness can be suppressed, or display unevenness does not occur at all.

From the above, as the polymerizable monomer, General Formula (XX-1) to General Formula (XX-4) are particularly preferable, and among the above, General Formula (XX-2) is the most preferable.

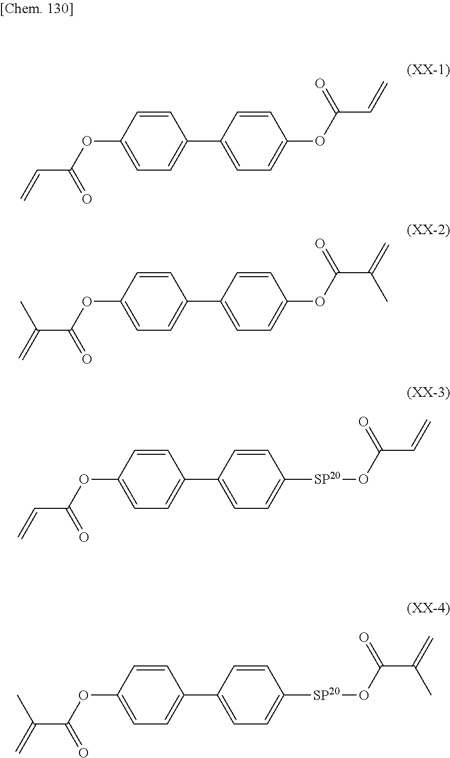

In the formulae, Sp²⁰ represents an alkylene group having 2 to 5 carbon atoms.

When the monomer is added to the composition of the present invention, polymerization proceeds even in a case where a polymerization initiator does not exist, but the polymerization initiator may be included in order to promote polymerization. The examples of the polymerization initiator include benzoin ethers, benzophenones, acetophenones, benzyl ketals, and acylphosphine oxides.

The composition of the present invention may further include a compound represented by General Formula (Q).

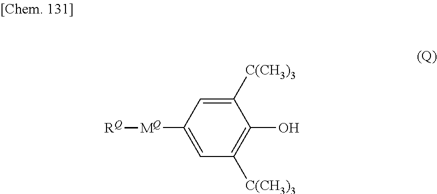

In the formula, R^{Q} represents a linear alkyl group having 1 to 22 carbon atoms or a branched alkyl group, one or more CH₂ groups in the alkyl group may be substituted with —O—, —CH═CH—, —CO—, —OCO—, —COO—, —C≡C—, —CF₂O—, or —OCF₂—, so as not to be directly adjacent to an oxygen atom, and M^{Q} is a trans-1,4-cyclohexylene group, a 1,4-phenylene group, or a single bond.

R^{Q} represents a linear alkyl group having 1 to 22 carbon atoms or a branched alkyl group, one or more CH₂ groups in the alkyl group may be substituted with —O—, —CH═CH—, —CO—, —OCO—, —COO—, —C≡C—, —CF₂O—, or —OCF₂—, so as not to be directly adjacent to an oxygen atom, a linear alkyl group having 1 to 10 carbon atoms, a linear alkoxy group, a linear alkyl group in which one CH₂ group is substituted with —OCO— or —COO—, a branched alkyl group, a branched alkoxy group, or a branched alkyl group in which one CH₂ group is substituted with —OCO— or —COO— is preferable, and a linear alkyl group having 1 to 20 carbon atoms, a linear alkyl group in which one CH₂ group is substituted with —OCO— or —COO—, a branched alkyl group, a branched alkoxy group, or a branched alkyl group in which one CH₂ group is substituted with —OCO— or —COO— is more preferable. M^{Q} represents a trans-1,4-cyclohexylene group, a 1,4-phenylene group, or a single bond, and a trans-1,4-cyclohexylene group or a 1,4-phenylene group is preferable.

The compound represented by General Formula (Q) is preferably, more specifically, compounds represented by General Formula (Q-a) to General Formula (Q-d) described below.

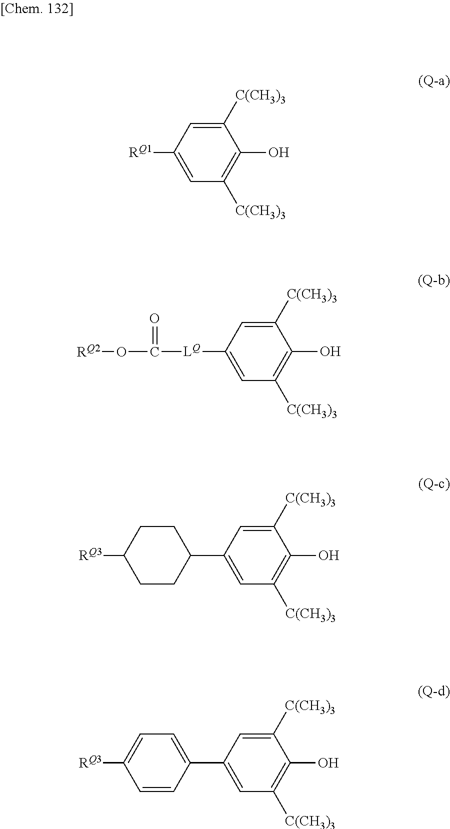

In the formulae, R^{Q1} is preferably a linear alkyl group having 1 to 10 carbon atoms or a branched alkyl group, R^{Q2} is preferably a linear alkyl group having 1 to 20 carbon atoms or a branched alkyl group, R^{Q3} is preferably a linear alkyl group having 1 to 8 carbon atoms, a branched alkyl group, a linear alkoxy group, or a branched alkoxy group, L^{Q} is preferably a linear alkylene group having 1 to 8 carbon atoms or a branched alkylene group, and among the compounds represented by General Formula (Q-a) to General Formula (Q-d), the compounds represented by General Formula (Q-c) and General Formula (Q-d) are more preferable.

The composition of the present invention preferably includes one or two compounds represented by General Formula (Q), and more preferably one to five types of the compounds, and the content thereof is preferably 0.001% to 1%, more preferably 0.001% to 0.1%, and particularly preferably 0.001% to 0.05%.

Since the polymerizable compound included in the composition is polymerized upon irradiation with an ultraviolet ray, a liquid crystal aligning ability is given, and the composition of the present invention including the polymerizable compound is used for a liquid crystal display element controlling a transmitted light quantity using double refraction of the composition. As the liquid crystal display element, an active matrix liquid crystal display element (AM-LCD), a nematic liquid crystal display element (TN), a super twisted nematic liquid crystal display element (STN-LCD), an OCB-LCD, and an in plane switching liquid crystal display element (IPS-LCD) are useful, and the AM-LCD is particularly useful, and a transmissive or reflective liquid crystal display element can be used.

For two pieces of substrates of a liquid crystal cell used in the liquid crystal display element, a transparent material having flexibility such as a glass or a plastic can be used. Meanwhile, an opaque material such as silicon may be used. Transparent substrates having a transparent electrode layer can be obtained by sputtering indium tin oxide (ITO) on the transparent substrates, for example, a glass plate.

A color filter can be created by, for example, a pigment dispersion method, a printing method, an electrodeposition method, or a dyeing method. One example of the method for creating a color filter using the pigment dispersion method is described. A curable coloring composition for a color filter is applied to the transparent substrates, and the substrates are subjected to a patterning process and heated or cured upon irradiation with light. This step is performed for three colors of red, green, and blue, respectively, thereby creating a pixel unit for a color filter. Moreover, a pixel electrode may be provided in which an active element such as a TFT, a thin film diode, a metallic insulator, and a metal specific resistance element is disposed on the substrates.

The substrates faced each other so as to have the transparent electrode layer inside. At that time, an interval of the substrates may be adjusted via a spacer. At this time, the interval is preferably adjusted such that the thickness of the obtained light adjusting layer is 1 to 100 μm, and 1.5 to 10 μm is more preferable, and when a polarizing plate is used, it is preferable to adjust a product of the refractive index anisotropy Δn and the cell thickness d of the liquid crystal such that the contrast is maximized. In addition, when two pieces of the polarizing plate are used, it is possible to adjust a polarizing axis of each polarizing plate such that a viewing angle or contrast becomes excellent. Further, a phase difference film can be used in order to widen a viewing angle. The examples of the spacer include glass particles, plastic particles, alumina particles, and a columnar spacer formed of a photoresist material. After that, a sealant such as an epoxy-based thermosetting composition is screen-printed on the substrates provided with a liquid crystal injection port, the substrates are adhered to each other and heated so as to heat and cure the sealant.

As a method for interposing the composition containing a polymerizable compound between two pieces of the substrate, a common vacuum injection method or ODF method can be used. However, according to the vacuum injection method, drop marks are not generated, but injection marks remain, which is a problem. The present invention can be appropriately used for a display element manufactured by the ODF method. In the manufacturing step of the liquid crystal display element by the ODF method, an epoxy-based photo-thermosetting sealant is drawn on any one of the backplane or frontplane substrate in a closed-loop bank shape using a dispenser, a predetermined amount of the composition is added dropwise under a degassed atmosphere, and then the frontplane and the backplane are adhered to each other, thereby manufacturing a liquid crystal display element. It is possible to appropriately use the composition of the present invention, since the composition is stably added dropwise in the ODF process.

As the method for polymerizing the polymerizable compound, it is preferable to polymerize the compound upon irradiation with active energy rays such as an ultraviolet ray or an electron beam singly, in combination, or in an order, since an appropriate polymerization rate is desired in order to obtain excellent alignment properties of the liquid crystal. When the ultraviolet ray is used, a polarizing light source may be used, and a nonpolarizing light source may be used. In addition, when polymerization is performed in a state where the composition containing the polymerizable compound is interposed between the two pieces of substrate, at least the irradiation side of the substrate should have appropriate transparency with respect to active energy rays. In addition, polymerization may be performed such that only after a predetermined portion is polymerized using a mask upon irradiation with light, an alignment state of the unpolymerized portion is changed by changing conditions such as an electric field, a magnetic field, or a temperature, and is further irradiated with active energy rays. In particular, at the time of exposing the compound to an ultraviolet ray, it is preferable to expose the compound to an ultraviolet ray while applying an alternating current electric field to the composition containing the polymerizable compound. As the alternating current electric field to be applied, an alternating current having a frequency of 10 Hz to 10 kHz is preferable, an alternating current having a frequency of 60 Hz to 10 kHz is more preferable, and a voltage is selected depending on a desired pretilt angle of a liquid crystal display element. In other words, the pretilt angle of the liquid crystal display element can be controlled by the voltage to be applied. In the liquid crystal display element for a horizontal electric field type MVA mode, it is preferable to control the pretilt angle to 80 degrees to 89.9 degrees, from a viewpoint of alignment stability and contrast.

It is preferable to set the temperature upon irradiation within a temperature range at which a liquid crystal state of the composition of the present invention is maintained. It is preferable to perform polymerization at a temperature close to room temperature, that is, typically at a temperature of 15° C. to 35° C. As a lamp for generating an ultraviolet ray, a metal halide lamp, a high pressure mercury lamp, or an ultra high pressure mercury lamp can be used. In addition, as a wavelength of the ultraviolet ray to be irradiated, it is preferable to irradiate the compound with an ultraviolet ray in the wavelength range, which is not a composition absorption wavelength range, and if necessary, it is preferable to cut the ultraviolet ray for use. An intensity of the ultraviolet ray to be irradiated is preferably 0.1 mW/cm to 100 W/cm², and more preferably 2 mW/cm² to 50 W/cm². An energy amount of the ultraviolet ray to be irradiated can be appropriately adjusted, and 10 mJ/cm² to 500 J/cm² are preferable, and 100 mJ/cm² to 200 J/cm² are more preferable. Upon irradiation with an ultraviolet ray, the intensity may be changed. An irradiation time of the ultraviolet ray is appropriately selected depending on the intensity of the ultraviolet ray to be irradiated, and 10 seconds to 3,600 seconds are preferable, and 10 seconds to 600 seconds are more preferable.

A liquid crystal display element using the composition of the present invention, in which both high-speed responsiveness and suppression of display defects are obtained, is useful, and in particular, useful for a liquid crystal display element for active matrix driving, and the element can be applied to a liquid crystal display element for a VA mode, a PSVA mode, a PSA mode, an IPS mode, or an ECB mode.

### Example

The present invention will be more specifically described below using Examples, and the present invention is not limited to these Examples. In addition, “%” in the compositions of the following Examples and Comparative Examples refers to “mass %”.

In Example, the measured properties are as follows.

TNI: Nematic phase-isotropic liquid phase transition temperature

T→N: Nematic phase transition temperature

Δn: Refractive index anisotropy at 298 K

no:

Δε: Dielectric anisotropy at 298 K

ε⊥:

γ₁: Rotational viscosity at 298 K

Vth: Liquid crystal is sealed in TN cell having a thickness of 6 microns, and voltage at which transmittance changes by 10% under 298 K, crossed-Nichol arranged polarizing plate

VHR: Voltage holding ratio (%) at 333 K under the condition of a frequency of 60 Hz and an applied voltage of 5V

VHR after heat resistance experiment: After a TEG (test element group) for electro-optical property evaluation in which composition samples are sealed was held in a thermostatic bath of 130° C. for 1 hour, measurement was performed under the same conditions as those of the VHR measurement method described above.

Burn-In:

Evaluation of burn-in of the liquid crystal display element was performed such that after a predetermined fixed pattern was displayed within a display area for an arbitrary experimental period of time, the experimental period of time, for which a residual image of the fixed pattern which was displayed uniformly over the entire screen reaches an unacceptable residual image level, was measured.

1) The experimental period of time herein refers to a display time of the fixed pattern, and as this time becomes longer, occurrence of the residual image is more suppressed, which indicates that the performance is excellent.

2) Unacceptable residual image level refers to a level, in which a residual image is observed, so that the element is determined as failed in the pass-fail test for shipment.

### Example

Sample A: 1,000 hours

Sample B: 500 hours

Sample C: 200 hours

Sample D: 100 hours

The performance is A>B>C>D.

Drop Marks:

Evaluation of drop marks of the liquid crystal display device was performed in the following 5 stages, by visually observing drop marks appeared in white when the entire screen was displayed in black.

5: No drop marks (Excellent)

4: There are substantially a few drop marks, which is an acceptable level (Good)

3: There are a few drop marks, which is a border line level of the pass-fail test (Conditional Pass)

2: There are drop marks, which is an unacceptable level (Fail)

1: There are drop marks, which is a very poor level (Poor)

Process Adaptability:

Process adaptability was evaluated such that in the ODF process, when liquid crystals were dropped for every 100 times such as “0 times to 100 times, 101 times to 200 times, 201 times 300 times, . . . ” in an amount of 50 pL for 1 time, mass of the liquid crystals dropped for every 100 times was measured using a constant volume measuring pump, and the dropping number in which a variation of the mass reaches a value determined as inappropriate for the ODF process was measured.

As the dropping number becomes greater, it is possible to drop the liquid crystals stably for a long period of time, which can be said that the process adaptability is high.

### Example

Sample A: 95,000 times

Sample B: 40,000 times

Sample C: 100,000 times

Sample D: 10,000 times

The performance is C>A>B>D.

Storage Stability at Low Temperature:

For the evaluation of the storage stability at low temperature, after preparation of the composition, 0.5 g of the composition was weighed in a 1 mL of sample bottle and stored in a temperature controlled type test bath at −25° C. for 240 hours, the occurrence of precipitates from the composition was visually observed, and the experimental period when the precipitate was observed was measured. It can be said that the longer the experimental period until the precipitation occurs, the better the storage stability at low temperature.

Volatility/Staining Properties to Manufacturing Device:

Evaluation of volatility of the liquid crystal material was performed such that an operation state of a vacuum agitation defoaming mixer was observed using a stroboscope, and foaming of the liquid crystal material was visually observed. Specifically, 0.8 kg of the composition was put into an exclusive container for a vacuum agitation defoaming mixer having a volume of 2.0 L, the vacuum agitation defoaming mixer was operated under a degassed atmosphere of 4 kPa, at a revolution speed of 15S-1, and at a rotation speed of 7.5S-1, and the time until the foaming started was measured.

As the time until the foaming is started becomes longer, the liquid crystal material hardly volatilizes, and the manufacturing device is less stained, which indicates excellent performance.

### Example

Sample A: 200 seconds

Sample B: 45 seconds

Sample C: 60 seconds

Sample D: 15 seconds

The performance is A>C>B>D.

In addition, the following abbreviations are used for describing the compounds in Examples.

(Ring Structure)

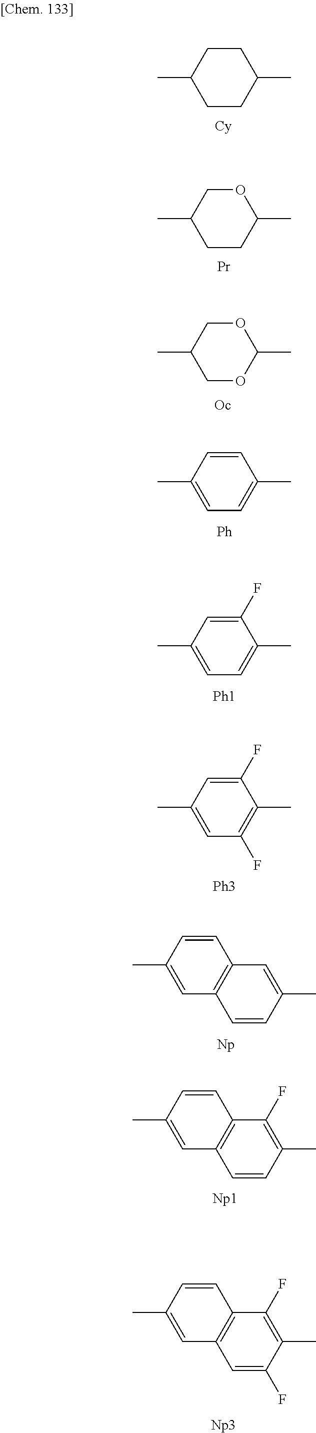

Unless otherwise specified, it represents a trans form.

(Side Chain Structure and Linking Structure)

TABLE 1

| Description in Formula | Substituent and linking group to be represented |
|---|---|
| 1- | CH₃— |
| 2- | C₂H₅— |
| 3- | n-C₃H₇— |
| 4- | n-C₄H₉— |
| 5- | n-C₅H₁₁— |
| V- | CH₂═CH— |
| V2- | CH₂═CH—CH₂—CH₂— |
| 1V2- | CH₃—CH═CH—CH₂—CH₂— |
| -1 | —CH₃ |
| -2 | —C₂H₅— |
| -3 | -n-C₃H₇ |
| -O2 | —OC₂H₅ |
| -V0 | —CH═CH₂ |
| -V1 | —CH═CH—CH₃ |
| -2V | —CH₂—CH₂—CH═CH₂ |
| -F | —F |
| -OCF3 | —OCF₃ |
| — | Single bond |
| -CFFO- | —CF₂O— |
| -O1- | —OCH₂— |

### Examples 1 to 38

A liquid crystal composition of the invention of the present application and a liquid crystal display element using the composition were prepared and their physical property values were measured.

It was found that a composition of Comparative Example 1 which does not contain the compound represented by Formula (i) has a value of γ₁ which is increased as compared with the composition of Example 1. It was found that a composition of Comparative Example 2 which does not contain the compound represented by General Formula (ii) has a value of Δε which is decreased as compared with the composition of Example 1. From the results of the storage stability at low temperature, it was found that the compositions of Comparative Examples 1 and 2 are deteriorated in the storage stability at low temperature as compared with the composition of the present invention.

TABLE 2

| | Comparative | Comparative | | | | |
|---|---|---|---|---|---|---|
| | Example 1 | Example 2 | Example 1 | Example 2 | Example 3 | Example 4 |
| TNI | 83.4 | 87.0 | 84.6 | 86.7 | 85.4 | 86.9 |
| T→N | −5 | −25 | −44 | −40 | −43 | −36 |
| Δn | 0.115 | 0.117 | 0.117 | 0.117 | 0.118 | 0.119 |
| no | 1.490 | 1.490 | 1.488 | 1.489 | 1.490 | 1.490 |
| Δε | 7.1 | 7.3 | 8.1 | 7.4 | 7.3 | 7.7 |
| ε⊥ | 3.6 | 3.5 | 3.6 | 3.5 | 3.4 | 3.6 |
| γ1 | 103 | 95 | 96 | 89 | 85 | 90 |
| Vth | 1.66 | 1.69 | 1.57 | 1.64 | 1.64 | 1.59 |
| 3-Cy-Cy-V0 | | 27 | 27 | 29 | 30 | 29 |
| 3-Cy-Cy-2 | 27 | | | | | |
| V-Cy-Ph—Ph-3 | | | | 4 | 3 | 4 |
| V-Cy-Cy-Ph-1 | | | | | 1 | |
| 4-Cy-Ph—Ph1—Ph-3 | 4 | 4 | 4 | 4 | 4 | 4 |
| 5-Cy-Ph—Ph1—Ph-3 | 4 | 4 | 4 | 4 | 4 | 4 |
| 3-Cy-Ph—Ph1—F | 8 | 8 | 8 | | | |
| 2-Cy-Ph—Ph1—F | 8 | 8 | 8 | | | |
| 3-Cy-Ph—Ph3—F | 12 | 12 | | | | |
| 3-Cy-Ph1—Ph3—F | 15 | 15 | 10 | 10 | | 10 |
| 5-Cy-Ph1—Ph3—F | 10 | 10 | | | | |
| 3-Cy-Cy-Ph1—Ph3—F | 6 | 6 | 6 | 6 | 6 | 6 |
| 5-Cy-Cy-Ph1—Ph3—F | 6 | 6 | 6 | 6 | 4 | 6 |
| 3-Oc-Ph—Ph1—F | | | | | | 10 |
| 3-Pr—Ph—Ph1—F | | | | 10 | 10 | |
| 3-Pr—Ph—Ph3—F | | | 12 | 12 | 14 | 12 |
| 5-Pr—Ph—Ph3—F | | | | | 9 | |
| 3-Pr—Ph1—Ph3—F | | | 15 | 15 | 15 | 15 |
| Storage at low | After 24 hours | After 72 hours | 240 hours | 240 hours | 240 hours | 240 hours |
| temperature | Precipitation | Precipitation | No precipitation | No precipitation | No precipitation | No precipitation |
| (−25° C.) | occurs | occurs | | | | |

TABLE 3

| | Example 5 | Example 6 | Example 7 | Example 8 | Example 9 |
|---|---|---|---|---|---|
| TNI | 80.1 | 92.5 | 86.5 | 78.0 | 80.5 |
| T→N | −38 | −50 | −33 | −46 | −36 |
| Δn | 0.118 | 0.120 | 0.087 | 0.100 | 0.120 |
| no | 1.485 | 1.484 | 1.476 | 1.477 | 1.486 |
| Δε | 8.0 | 7.9 | 5.0 | 8.8 | 8.6 |
| ε⊥ | 3.3 | 3.3 | 2.6 | 3.2 | 3.4 |
| γl | 69 | 79 | 42 | 65 | 72 |
| Vth | 1.87 | 1.94 | 2.28 | 1.71 | 1.78 |
| 3-Cy-Cy-V0 | 25 | 26 | 50 | 35 | 25 |
| 3-Cy-Cy-V1 | 7 | 7 | | 7 | 7 |
| V-Cy-Cy-Ph-1 | 12 | 8 | 12 | 8 | 12 |
| V2-Cy-Cy-Ph-1 | | 4 | 7 | | |
| 1V2-Ph-Ph-1 | 6 | | | | 6 |
| V-Cy-Ph-Ph-3 | | | 4 | | |
| 2-Ph-Ph1-Ph-2V | 7 | 8 | | | 7 |
| 3-Cy-Ph1-Ph-Cy-3 | | | | 4 | |
| 5-Cy-Ph-Ph1-Ph-3 | | 4 | | | |
| 3-Cy-Cy-Ph3-F | 8 | 8 | 8 | 5 | 8 |
| 3-Ph-Ph1-Ph3-CFFO-Ph3-F | 4 | 4 | | 4 | 4 |
| 4-Ph-Ph1-Ph3-CFFO-Ph3-F | 6 | 6 | 7 | 6 | 6 |
| 3-Oc-Ph1-Ph3-F | | | | | 12 |
| 3-Pr-Ph-Ph3-F | 7 | 7 | 12 | 10 | 7 |
| 5-Pr-Ph-Ph3-F | 6 | 6 | | 6 | 6 |
| 3-Pr-Ph1-Ph3-F | 12 | 12 | | 15 | |
| Storage at low | 240 hours | 240 hours | 240 hours | 240 hours | 240 hours |
| temperature | No precipitation | No precipitation | No precipitation | No precipitation | No precipitation |
| (−25° C.) | | | | | |

TABLE 4

| | Example 10 | Example 11 | Example 12 | Example 13 | Example 14 |
|---|---|---|---|---|---|
| TNI | 77.8 | 81.7 | 74.3 | 75.0 | 84.0 |
| T→N | −36 | −45 | −44 | −54 | −31 |
| Δn | 0.118 | 0.126 | 0.098 | 0.107 | 0.110 |
| no | 1.484 | 1.485 | 1.479 | 1.481 | 1.482 |
| Δε | 8.1 | 8.6 | 5.6 | 7.9 | 7.2 |
| ε⊥ | 3.2 | 3.4 | 2.8 | 3.2 | 3.1 |
| γl | 70 | 79 | 45 | 70 | 73 |
| Vth | 1.77 | 1.76 | 2.06 | 1.89 | 2.06 |
| 3-Cy-Cy-V0 | 27 | 30 | 51 | 33 | 27 |
| 3-Cy-Cy-V1 | 5 | 5 | | | 5 |
| V-Cy-Cy-Ph-1 | 12 | 6 | 10 | 11 | 12 |
| V2-Cy-Cy-Ph-1 | 7 | 4 | 6 | 6 | 7 |
| 1V2-Ph-Ph-1 | 6 | | | | |
| V-Cy-Ph-Ph-3 | | | | | 6 |
| 2-Ph-Ph1-Ph-2V | | 6 | 4 | 4 | |
| 5-Cy-Ph-Ph1-Ph-3 | | 4 | | | 5 |
| 3-Ph-Ph3-CFFO-Ph3-F | | | | | 13 |
| 3-Ph-Ph1-Ph3-CFFO-Ph3-F | 4 | 3 | | | |
| 4-Ph-Ph1-Ph3-CFFO-Ph3-F | 6 | 5 | 4 | | |
| 3-Ph-Ph1-Ph3-F | 8 | 10 | 10 | 7 | |
| 3-Oc-Ph-Ph0-F | | | | | 7 |
| 3-Pr-Ph-Ph1-F | | | | 8 | |
| 3-Pr-Ph-Ph3-F | 7 | 9 | 10 | 10 | |
| 5-Pr-Ph-Ph3-F | 6 | 6 | | 6 | 6 |
| 3-Pr-Ph1-Ph3-F | 12 | 12 | 5 | 15 | 12 |
| Storage at low | 240 hours | 240 hours | 240 hours | 240 hours | 240 hours |
| temperature | No precipitation | No precipitation | No precipitation | No precipitation | No precipitation |
| (−25° C.) | | | | | |

TABLE 5

| | Example 15 | Example 16 | Example 17 | Example 18 |
|---|---|---|---|---|
| TNI | 83.6 | 80.2 | 74.6 | 76.1 |
| T→N | −35 | −30 | −35 | −41 |
| Δn | 0.109 | 0.135 | 0.097 | 0.130 |
| no | 1.480 | 1.492 | 1.476 | 1.492 |
| Δε | 6.8 | 7.8 | 6.0 | 6.4 |
| ε⊥ | 3.0 | 3.3 | 2.9 | 3.1 |
| γl | 71 | 84 | 51 | 72 |
| Vth | 2.129 | 1.994 | 2.073 | 2.173 |
| 3-Cy-Cy-V0 | 27 | 24 | 50 | 24 |
| 3-Cy-Cy-V1 | 5 | | | |
| V-Cy-Cy-Ph-1 | 12 | 11 | 6 | 11 |
| V2-Cy-Cy-Ph-1 | 7 | | | 6 |
| 1V2-Ph-Ph-1 | | | | 6 |
| V-Cy-Ph-Ph-3 | 6 | 6 | | 5 |
| 1-Ph-Ph1-Ph-2V | | 4 | | 6 |
| 2-Ph-Ph1-Ph-2V | | 5 | | 7 |
| 3-Ph-Ph1-Ph-2V | | 4 | | |
| 3-Cy-Ph1-Ph-Cy-3 | | | 5 | |
| 5-Cy-Ph-Ph1-Ph-3 | 5 | 4 | 6 | |
| 3-Ph-Ph3-CFFO-Ph3-F | 13 | 15 | 15 | 12 |
| 3-Pr-Ph-Ph1-F | | | 8 | |
| 3-Pr-Ph-Ph3-OCF3 | | 7 | 10 | |
| 3-Pr-Ph-Ph3-F | 7 | 9 | | 13 |
| 5-Pr-Ph-Ph3-F | 6 | 6 | | |
| 3-Pr-Ph1-Ph3-F | 12 | 5 | | 10 |
| Storage at low | 240 hours | 240 hours | 240 hours | 240 hours |
| temperature | No precipitation | No precipitation | No precipitation | No precipitation |
| (−25° C.) | | | | |

TABLE 6

| | Example 19 | Example 20 | Example 21 | Example 22 | Example 23 |
|---|---|---|---|---|---|
| TNI | 81.2 | 91.0 | 81.0 | 75.3 | 82.5 |
| T→N | −40 | −33 | −50 | −38 | −42 |
| Δn | 0.102 | 0.129 | 0.112 | 0.103 | 0.115 |
| no | 1.477 | 1.490 | 1.480 | 1.482 | 1.482 |
| Δε | 8.9 | 9.4 | 11.3 | 6.2 | 12.7 |
| ε⊥ | 3.3 | 3.5 | 3.6 | 2.9 | 3.9 |
| γl | 65 | 84 | 84 | 48 | 89 |
| Vth | 1.60 | 1.66 | 1.49 | 1.94 | 1.32 |
| 3-Cy-Cy-V0 | 40 | 27 | 33 | 45 | 33 |
| 3-Cy-Cy-V1 | 5 | | | | |
| V-Cy-Cy-Ph-1 | 6 | 11 | 4 | 11 | 4 |
| 1V2-Ph-Ph-1 | | | | 6 | |
| V-Cy-Ph-Ph-3 | | 6 | | | |
| 1-Ph-Ph1-Ph-2V | | 4 | | | |
| 2-Ph-Ph1-Ph-2V | | 5 | | 6 | |
| 5-Cy-Ph-Ph1-Ph-3 | 5 | | 6 | | 6 |
| 4-Ph-Ph1-Ph3-CFFO-Ph3-F | 6 | 5 | | | |
| 2-Pr-Ph-Ph3-CFFO-Ph3-F | 5 | 7 | 7 | 5 | 7 |
| 3-Pr-Ph-Ph3-CFFO-Ph3-F | 8 | 8 | 8 | 7 | 8 |
| 3-Oc-Ph-Ph1-F | | | | | 8 |
| 3-Oc-Ph1-Ph3-F | | | | | 8 |
| 3-Pr-Ph-Ph1-F | | | 8 | | |
| 3-Pr-Ph-Ph3-OCF3 | | 7 | 10 | 6 | 10 |
| 3-Pr-Ph-Ph3-F | 7 | 9 | 11 | 8 | 11 |
| 5-Pr-Ph-Ph3-F | 6 | 6 | 5 | 6 | 5 |
| 3-Pr-Ph1-Ph3-F | 12 | 5 | 8 | | |
| Storage at low | 240 hours | 240 hours | 240 hours | 240 hours | 240 hours |
| temperature | No precipitation | No precipitation | No precipitation | No precipitation | No precipitation |
| (−25° C.) | | | | | |

TABLE 7

| | Example 24 | Example 25 | Example 26 | Example 27 | Example 28 |
|---|---|---|---|---|---|
| TNI | 90.7 | 87.1 | 76.3 | 73.7 | 77.0 |
| T→N | −32 | −29 | −53 | −37 | −46 |
| Δn | 0.122 | 0.140 | 0.089 | 0.114 | 0.091 |
| no | 1.482 | 1.492 | 1.476 | 1.484 | 1.477 |
| Δε | 10.1 | 9.3 | 9.3 | 10.9 | 9.9 |
| ε⊥ | 3.6 | 3.4 | 3.5 | 3.6 | 3.6 |
| γl | 89 | 87 | 66 | 66 | 70 |
| Vth | 1.68 | 1.73 | 1.68 | 1.36 | 1.61 |
| 3-Cy-Cy-V0 | 25 | 15 | 32 | 40 | 32 |
| 3-Cy-Cy-V1 | 10 | 10 | 5 | | 5 |
| V-Cy-Cy-Ph-1 | | 11 | 10 | 5 | 10 |
| 5-Ph-Ph-1 | | 5 | | | |
| 1V2-Ph-Ph-1 | | 4 | | | |
| 2-Ph-Ph1-Ph-2V | 5 | 5 | | 4 | |
| 3-Cy-Ph1-Ph-Cy-3 | 5 | 4 | 4 | | 4 |
| 5-Cy-Ph-Ph1-Ph-3 | 5 | | | | |
| 3-Cy-Cy-Ph3-F | 10 | | 9 | | 9 |
| 3-Cy-Cy-CFFO-Ph3-F | | | 10 | 9 | 10 |
| 3-Ph-Ph3-CFFO-Ph3-F | 5 | | 10 | 4 | 10 |
| 3-Ph-Ph1-Ph3-CFFO-Ph3-F | 4 | | | 5 | |
| 4-Ph-Ph1-Ph3-CFFO-Ph3-F | 6 | 5 | | 7 | |
| 2-Pr-Ph-Ph3-CFFO-Ph3-F | | 7 | | | |
| 3-Pr-Ph-Ph3-CFFO-Ph3-F | 7 | 8 | 8 | 8 | 8 |
| 3-Ph-Ph1-Ph3-F | | 11 | | 5 | |
| 3-Oc-Ph1-Ph3-F | | | | | 12 |
| 3-Pr-Ph-Ph3-OCF3 | | 6 | | 5 | |
| 3-Pr-Ph-Ph3-F | 8 | 9 | | 8 | |
| 5-Pr-Ph-Ph3-F | | | | | |
| 3-Pr-Ph1-Ph3-F | 10 | | 12 | | |
| Storage at low | 240 hours | 240 hours | 240 hours | 240 hours | 240 hours |
| temperature | No precipitation | No precipitation | No precipitation | No precipitation | No precipitation |
| (−25° C.) | | | | | |

TABLE 8

| | Example 29 | Example 30 | Example 31 |
|---|---|---|---|
| TNI | 84.1 | 84.3 | 84.4 |
| T→N | −57 | −48 | −52 |
| Δn | 0.118 | 0.111 | 0.120 |
| no | 1.491 | 1.487 | 1.491 |
| Δε | 6.3 | 4.7 | 6.8 |
| ε⊥ | 3.4 | 3.2 | 3.5 |
| γl | 60 | 54 | 63 |
| Vth | 1.87 | 2.08 | 1.78 |
| 3-Cy-Cy-V0 | 29 | 32 | 29 |
| 3-Cy-Cy-V1 | 13 | 11 | 13 |
| 3-Cy-Cy-Ph-1 | 5 | 5 | 5 |
| 3-Cy-Ph-Ph-2 | | 3 | |
| 5-Cy-Ph-Ph-2 | | 3 | |
| 5-Cy-Ph-Ph1-Ph-3 | 3 | 5 | 3 |
| 2-Cy-Cy-Ph-Ph1-F | 3 | | 3 |
| 3-Ph1-Np3-F | 5 | | 5 |
| 3-Cy-Ph1-Np3-F | 11 | 5 | 11 |
| 2-Ph-Ph1-Np3-F | 6 | 4 | 6 |
| 3-Oc-Ph1-Ph3-F | | | 7 |
| 3-Pr-Ph-Ph3-F | 8 | 8 | 8 |
| 5-Pr-Ph-Ph3-F | 10 | 10 | 10 |
| 3-Pr-Ph1-Ph3-F | 7 | 7 | |
| 5-Pr-Ph-Ph3-F | | 7 | |
| Storage at low | 240 hours | 240 hours | 240 hours |
| temperature | No precipitation | No precipitation | No |
| (−25° C.) | | | precipitation |

TABLE 9

| | Example 32 | Example 33 |
|---|---|---|
| TNI | 80.6 | 74.3 |
| T→N | −34 | −46 |
| Δn | 0.103 | 0.112 |
| no | 1.486 | 1.489 |
| Δε | 11.6 | 10.9 |
| ε⊥ | 4.1 | 4.1 |
| γl | 80 | 78 |
| Vth | 1.38 | 1.60 |
| 3-Cy-Cy-V0 | 37 | 34 |
| V-Cy-Cy-Ph-1 | 10 | |
| 3-Cy-Cy-Ph-1 | | 6 |
| 3-Cy-Ph-Ph-2 | 2 | 4 |
| 1-Ph-Ph1-Ph-2V | | 3 |
| 2-Ph-Ph1-Ph-2V | | 5 |
| 3-Oc-Ph1-Ph3-O1-Ph3-F | | 6 |
| 3-Ph3-O1-Oc-Ph1-Ph3-F | 7 | 7 |
| 5-Ph3-O1-Oc-Ph1-Ph3-F | 5 | |
| 3-Ph3-O1-Oc-Ph-Ph3-F | 4 | 4 |
| 2-Cy-Ph-Ph3-O1-Ph3-F | 6 | |
| 3-Cy-Ph-Ph3-O1-Ph3-F | 6 | |
| 4-Cy-Ph-Ph3-O1-Ph3-F | 7 | |
| 3-Pr-Ph-Ph3-OCF3 | | 7 |
| 3-Pr-Ph-Ph3-F | 9 | 10 |
| 5-Pr-Ph-Ph3-F | | 6 |
| 3-Pr-Ph1-Ph3-F | 7 | 8 |
| Storage at low | 240 hours | 240 hours |
| temperature | No precipitation | No precipitation |
| (−25° C.) | | |

TABLE 10

| | Example 34 | Example 35 | Example 36 |
|---|---|---|---|
| TNI | 85.1 | 78.5 | 85.4 |
| T→N | −31 | −38 | −28 |
| Δn | 0.116 | 0.110 | 0.117 |
| no | 1.493 | 1.491 | 1.493 |
| Δε | 3.8 | 4.1 | 3.9 |
| ε⊥ | 3.0 | 3.0 | 3.1 |
| γl | 51 | 52 | 54 |
| Vth | 2.50 | 2.47 | 2.45 |
| 3-Cy-Cy-V0 | 30 | 25 | 30 |
| 3-Cy-Cy-V1 | 10 | 10 | 10 |
| 3-Cy-Ph-O2 | | 6 | |
| 5-Ph-Ph-1 | 11 | 8 | 11 |
| 3-Cy-Cy-Ph-1 | 6 | 7 | 6 |
| 3-Cy-Cy-Ph-3 | | 3 | |
| 3-Cy-Ph-Ph-2 | 3.5 | 6 | 3.5 |
| 5-Cy-Ph-Ph-2 | | 4 | |
| V-Cy-Ph-Ph-3 | 4 | | 4 |
| 4-Cy-Ph-Ph1-Ph-3 | 5 | | 5 |
| 2-Cy-Ph-Ph3-O1-Ph3-F | 6 | | 6 |
| 3-Cy-Ph-Ph3-O1-Ph3-F | 5.5 | 4 | 5.5 |
| 4-Cy-Ph-Ph3-O1-Ph3-F | 7 | 7 | 7 |
| 3-Oc-Ph-Ph3-F | | | 6 |
| 3-Pr-Ph-Ph1-F | 6 | | 6 |
| 3-Pr-Ph-Ph3-OCF3 | | 5 | |
| 3-Pr-Ph-Ph3-F | 6 | 8 | |
| 5-Pr-Ph-Ph3-F | | 7 | |
| Storage at low | 240 hours | 240 hours | 240 hours |
| temperature | No precipitation | No | No |
| (−25° C.) | | precipitation | precipitation |

TABLE 11

| | Example 37 | Example 38 |
|---|---|---|
| TNI | 75.5 | 76.6 |
| T→N | −28 | −39 |
| Δn | 0.118 | 0.097 |
| no | 1.488 | 1.481 |
| Δε | 11.5 | 9.0 |
| ε⊥ | 4.2 | 3.8 |
| γl | 85 | 68 |
| Vth | 1.53 | 1.82 |
| 3-Cy-Cy-V0 | 35 | 37 |
| 3-Cy-Cy-V1 | | 16 |
| 5-Ph-Ph-1 | 2 | |
| V-Cy-Cy-Ph-1 | | 3 |
| 3-Cy-Cy-Ph-1 | 8 | |
| 3-Cy-Ph-Ph-2 | 4 | |
| 4-Cy-Ph-Ph1-Ph-3 | | 4 |
| 5-Cy-Ph-Ph1-Ph-3 | 4 | |
| 3-Ph3-O1-Ph-Np3-F | 10 | |
| 3-Ph-Ph3-CFFO-Ph3-F | 10 | |
| 3-Ph-Ph1-Ph3-CFFO-Ph3-F | | 4 |
| 4-Ph-Ph1-Ph3-CFFO-Ph3-F | 5 | 5 |
| 2-Ph3-O1-Cy-Ph3-Ph3-F | | 5 |
| 3-Ph3-O1-Cy-Ph3-Ph3-F | 5 | 4 |
| 3-Pr-Ph-Ph3-OCF3 | | 7 |
| 3-Pr-Ph-Ph3-F | 8 | 10 |
| 3-Pr-Ph1-Ph3-F | 9 | 5 |
| Storage at low | 240 hours | 240 hours |
| temperature | No precipitation | No precipitation |
| (−25° C.) | | |

Evaluations of the compositions of Examples 1, 5, 10, 24, and 29 are indicated below.

TABLE 12

| | Example 1 | Example 5 | Example 10 |
|---|---|---|---|
| Initial VHR | 99.3 | 99.1 | 99.2 |
| VHR after heating | 98.3 | 98.2 | 98.2 |
| Burn-in | A | A | A |
| Drop marks | 5 | 5 | 5 |
| Process adaptability | C | C | C |
| Solubility at low | D | D | D |
| temperature | | | |
| Volatility/Staining | A | A | A |
| properties to | | | |
| manufacturing device | | | |

TABLE 13

| | Example 24 | Example 29 |
|---|---|---|
| Initial VHR | 99.4 | 99.3 |
| VHR after heating | 98.2 | 98.0 |
| Burn-in | A | A |
| Drop marks | 5 | 5 |
| Process adaptability | C | C |
| Solubility at low | D | D |
| temperature | | |
| Volatility/Staining | A | A |
| properties to | | |
| manufacturing device | | |

1. A composition comprising:
one or more compounds represented by General Formula (i), and
a compound represented by Formula (L-1-2.2): 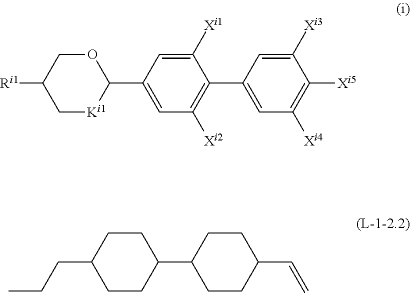
wherein Rⁱ¹ represents an alkyl group having 1 to 8 carbon atoms; and one or more non-adjacent —CH₂—'s in the alkyl group each independently may be substituted with —CH═CH—, —C≡C—, —O—, —CO—, —COO—, or —OCO—,
Kⁱ¹ represents —O— or —CH₂—,
Xⁱ¹ to Xⁱ⁴ each independently represent a hydrogen atom, a fluorine atom, or a chlorine atom, and
Xⁱ⁵ represents a fluorine atom, a trifluoromethyl group, a trifluoromethoxy group, or a chlorine atom.

2. The composition according to claim 1, further comprising:
one or more compounds represented by General Formula (J), 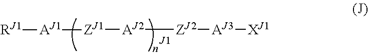
wherein R^{J1} represents an alkyl group having 1 to 8 carbon atoms; and one or more non-adjacent —CH₂—'s in the alkyl group each independently may be substituted with —CH═CH—, —C≡C—, —O—, —CO—, —COO—, or —OCO—,
n^{J1} represents 0, 1, 2, 3, or 4, and
A^{J1}, A^{J2}, and A^{J3} each independently represent a group selected from the group consisting of:
(a) a 1,4-cyclohexylene group (one —CH₂— or two or more non-adjacent —CH—'s existing in this group may be substituted with —O—);
(b) a 1,4-phenylene group (one —CH═ or two or more non-adjacent —CH═'s existing in this group may be substituted with —N═); and
(c) a naphthalene-2,6-diyl group, a 1,2,3,4-tetrahydronaphthalene-2,6-diyl group, or a decahydronaphthalene-2,6-diyl group, in which one —CH═ or two or more non-adjacent —CH═'s existing in a naphthalene-2,6-diyl group or a 1,2,3,4-tetrahydronaphthalene-2,6-diyl group may be substituted with —N═,
provided that a compound represented by General Formula (i) is excluded.

3. The composition according to claim 1, further comprising one or more compounds represented by General Formula (L): 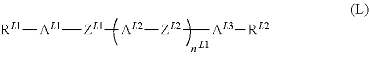
wherein R^{L1} and R^{L2} each independently represent an alkyl group having 1 to 8 carbon atoms; and one or more non-adjacent —CH₂—'s in the alkyl group each independently may be substituted with —CH═CH—, —C≡C—, —O—, —CO—, —COO—, or —OCO—,
n^{L1} represents 0, 1, 2, or 3,
A^{L1}, A^{L2}, and A^{L3} each independently represent a group selected from the group consisting of:
(a) a 1,4-cyclohexylene group (one —CH₂— or two or more non-adjacent —CH₂—'s existing in this group may be substituted with —O—);
(b) a 1,4-phenylene group (one —CH═ or two or more non-adjacent —CH═'s existing in this group may be substituted with —N═);
(c) a naphthalene-2,6-diyl group, a 1,2,3,4-tetrahydronaphthalene-2,6-diyl group, or a decahydronaphthalene-2,6-diyl group (one —CH═ or two or more non-adjacent —CH═'s existing in a naphthalene-2,6-diyl group or a 1,2,3,4-tetrahydronaphthalene-2,6-diyl group may be substituted with —N═); and
the group (a), the group (b), and the group (c) each independently may be substituted with a cyano group, a fluorine atom, or a chlorine atom,
Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—, and
in a case where n^{L1} is 2 or 3 and a plurality of A^{L2}'s exist, the plurality of A^{L2}'s may be the same as or different from each other; and in a case where n^{L1} is 2 or 3 and a plurality of Z^{L2}'s exist, the plurality of Z^{L2}'s may be the same as or different from each other,
provided that compounds represented by General Formulae (i), (ii), and (J) are excluded.

4. A liquid crystal display element using the composition according to claim 1.

5. A TN, ECB, IPS, or FFS type liquid crystal display element using the composition according to claim 1.
